(19) United States
(12) Patent Application Publication
(10) Pub. No.: US 2013/0041781 A1
(43) Pub. Date: Feb. 14, 2013

(54) DIGITAL PERSONAL MARKET AND SHOPPING NETWORK

(71) Applicant: Mary-Stuart G. FREYDBERG, Greenwich, CT (US)

(72) Inventor: Mary-Stuart G. FREYDBERG, Greenwich, CT (US)

(21) Appl. No.: 13/568,626

(22) Filed: Aug. 7, 2012

Related U.S. Application Data
(60) Provisional application No. 61/574,739, filed on Aug. 8, 2011.

(51) Int. Cl. G06Q 30/00

(52) U.S. Cl. 705/27.1

(57) ABSTRACT

A computer system supporting an online personal market for a user includes a user account module configured to allow the user to register and create a user account, a vendor selection module configured to allow the user to add and remove one or more vendors to the online personal market, a social module configured to allow the user to establish social interaction and networking with other users, a shopping module configured to allow the user to shop one or more products or services from the one or more vendors, an account management and utility module configured to allow the user to manage the online personal market, an analytics module configured to collect and analyze actions of the user, and a vendor module configured to allow the one or more vendors to create one or more vendor accounts and access the online personal market.

### RELATED APPLICATION

This application claims priority to U.S. Provisional Patent Application 61/574,739 filed on Aug. 8, 2011, which is incorporated herein in its entirety.

### FIELD OF THE INVENTION

The disclosed subject matter relates to electronic, mobile and digital commerce, and in particular systems and methods for providing web-based and mobile applications for interactive bespoke shopping through buyer's markets and networks, as opposed to traditional seller's markets.

### BACKGROUND

In the past, markets have been created by sellers for consumers. Shoppers physically traveled to an organized market, or a congregation of vendors at a crossroads, such as a village center, a main street, shopping center or mall. The market is organized typically by location and character. Examples of organized markets include a fish market near the water, business attire downtown, grocery centers and strip malls in neighborhoods, and mainstream fashion in suburban malls. Purchasers have the convenience of choice, but there are physical limitations. Shoppers are rarely interested in visiting every vendor within a given market. Therefore, a shopper must physically work her way through vendors and inventory she is not interested in viewing, every time she shops at a particular market. Ideally, one would visit a market that has all the merchants and service providers one wants and none of the ones she does not need.

An alternative shopping method is destination shopping, where shoppers can make a specific visit to pre-determined vendors. In this targeted approach, the shopper avoids unnecessary shops and limits the inventory she sees to the targeted vendor. However, the shopper may need to make multiple stops at various locations in order to obtain what she needs, such as one stop at the home improvement warehouse, another at the pet warehouse and a third at the members-only grocery warehouse. Destination shopping is either restricted by vendor or extremely time consuming as requiring significant travel—from one vendor to another.

To date, regardless of the form, seller's markets are the current shopping paradigm. Merchants present inventory and a marketplace hosts a collection of merchants or service providers. Vendors seek to attract purchasers by creating a destination for shopping and services. The vendors congregate in a convenient location. The format, whether it is a port, a main street, a flea market, a strip center, a mall, or a stand-alone category killer warehouse, is designed to attract targeted purchasers to the market. The attraction is based on location, convenience, social experience and discovery. Commonly known as a mousetrap, the concept is to generate consumer traffic and encourage repeat shopping in the convenient location. It's a seller's market.

Seller's markets have had physical limitations. Inventory management has required the stocking of the most popular items. Slow moving items are expensive to ship and display, particularly as real estate and transportation costs rise. The popular items, brands and stores are repeated from mall to mall or retailer to retailer such that many malls and stores have common or similar tenants and inventory. Many consumers are anxious for differentiation.

Online shopping has expanded shopping options. Online shopping enables a shopper to view an expansive choice and avoid the limitations of physical markets. However, in its present form online shopping still has significant limitations and inconveniences.

Market based online shopping can be overwhelming, confusing and time consuming. Rather than physically working one's way through a land-based market, a shopper must scroll through or drill down through an expansive online market. The shopper must work through extended unwanted material to find the vendors or products of interest. Open online markets can be too extensive or misdirected.

The alternative is destination online shopping. One can go directly to specific vendors one knows and likes, where the search is limited and more interesting to the shopper. The drawback is the single vendor approach. One must recall which vendors one needs for each purchase. Browsing can be limited or extremely time-consuming, depending on the supplier. One may miss alternative vendors that may be of interest. With the human brain able to store and recall quickly only a limited number of options, shoppers are likely to forget, have difficulty recalling or miss options that may be of value to them. Vendor websites lack social components.

Online shopping is currently designed using the same format as physical seller's markets. Stores aggregate inventory, department stores aggregate brands, malls aggregate stores. The seller's seek to aggregate or curate a collection of goods or merchants that will attract the greatest number of users. Sellers determine the inventory and the aggregation.

Online shopping has an advantage over physical stores. Not bound by retail walls, merchants can store slower moving or less popular items in warehouses, a less expensive alternative to retail display. Coupled with just-in-time inventory management and other advances, online retailers have been able to service previously undeserved markets and profit from The Long Tail. Similarly, vendors that specialize in niche markets can host an online store to service a greater number of customers than could be achieved by land-based stores.

An integral part of the seller and buyer exchange is communication, including but not limited to news, advertising, marketing and other forms of promotion and information exchange whether through print, television, direct mail, email, social networks, search engine optimization or otherwise. Sellers seek to attract customers in high volume or highly visible locations and to personally engage customers with direct and targeted appeals. Considerable money and effort is spent for discovery, brand awareness, customer acquisition and customer loyalty.

The arising issue with online markets is the overabundance of information. Excess supply has made the markets inefficient. Search returns become increasingly crowded. The user's preferred return may be obscured from view (not on the current screen) and its distance from view (number of pages back) unknown. If the search is performed again at a later date, the return may be in a different place or on a different page. If the exact address is not known, discovery can be difficult. Much of the information is irrelevant.

As important as a convenient location is for land based operators, prime digital real estate may be equally, if not more so, important. Users must either recall specific information or conduct a search. Recall and search functions favor the largest and most profitable entities that are willing and able either to conduct expensive marketing campaigns or to purchase primary search return placement. Having the dominant entities repeatedly displayed is not always in the best interest of the user. Digital information is growing exponentially, and the effort required recall or find desired information, products or services will likely become increasingly challenging. A typo can lead to undesirable results. The use of mobile devices is increasingly popular; and yet it is still difficult to conduct large searches or find desired information from a myriad of applications. What is needed is an efficient way of filtering a wealth of information to relevant information.

One method of filtering and retaining desired websites is through bookmarking. Although bookmarking techniques have been around for some time, they have not taken hold as a standard, readily used or understood method of solving the problem. Bookmarking is unattractive, limited, typically unorganized, limited in functionality, and not available to share with others.

One method of finding specific products is a search engine, which returns all related information, including information that may be irrelevant to the user. Another means is multiple successive searches among a third party seller's market. Returns are generally provided in narrative form, with an option for images. None is efficient. What is needed is a means for searching or viewing relevant inventory or information.

An alternative method is a price comparison website search by product, which requires repeated searches, which are also limited to only that portion of inventory the vendor chooses to display on the particular website. There is no social component that allows one to share multiple preferred vendors with friends. The aggregated search is typically product oriented for price comparison purposes and may return vendors that do not suit a user. Many purchasers are brand conscious and similarly suspicious of unknown vendors.

Industries have arisen to try to solve the problem of being found in digital space. Search engine optimization, advertising, social marketing efforts, and others all seek to grab consumer attention. To date, these methods have yielded low conversion rates. Sellers seek to make connections with consumers one-on-one via direct mail, loyalty programs, tailored email messages, segmented catalogues, social media and other methods of attracting consumer attention in order to increase brand awareness, customer loyalty and sales. Shopping information is delivered through direct mail, catalogues, magazines, email, blogs, articles, advertisements, etc. The shopping information is most valuable to the consumer and the seller when it is delivered in a timely fashion and a convenient location. The connections are typically made in a buyer's personal space, and may feel intrusive. The form and location of communication can be so unwelcome that a purchaser will construct methods around the problem. Direct mail and catalogues are readily tossed in the trash without review, emails are immediately discarded without being read or forwarded to unused folders. Users create separate email accounts to receive shopping spam. None of the present solutions has proven to be a substitute for a shopping market.

Land-based shopping is social. Friends can go together and vendors, sales staff or strangers can offer suggestions and comments. Malls attempt to capture an audience for an extended time by providing a pleasing and friendly environment, entertainment, new vendor displays, events, arcades and food courts or restaurants. Online shopping to date has not been social.

There is a need to provide efficient, convenient and targeted marketplaces with relevant information. The expanding global marketplace has generated an excess supply of shopping information. What is needed is an efficient global marketplace with a broad array of choices. A market and network designed by and for the buyer solves problems. A market with a buyer as an axis allows for the ease of data collection that may enhance the shopping experience and promote the sale of relevant products and services to the buyer.

What is needed in the art are novel systems and methods to enable and support online shopping that solves the aforementioned problems of the prior art.

### SUMMARY

In accordance with the disclosed subject matter, systems and methods are described for providing digital personal market and shopping network.

Disclosed subject matter includes, in one aspect, a computer system supporting an online personal market for a user, which includes a user account module configured to allow the user to register and create a user account, a vendor selection module configured to allow the user to add and remove one or more vendors to the online personal market, a social module configured to allow the user to establish social interaction and networking with other users, a shopping module configured to allow the user to shop one or more products or services from the one or more vendors, an account management and utility module configured to allow the user to manage the online personal market, an analytics module configured to collect and analyze actions of the user, and a vendor module configured to allow the one or more vendors to create one or more vendor accounts and access the online personal market.

In some embodiments, the computer system further includes a blueprint module configured to provide one or more templates to the user for creating the online personal market.

In some embodiments, the computer system further includes a news and communication module configured to provide news and communications to the user.

In some embodiments, the user account module is further configured to allow the user to create one or more sub-accounts.

In some embodiments, the vendor selection module is further configured to recommend at least a first vendor for the user to add to the online personal market.

In some embodiments, the vendor selection module is further configured to present to the user at least a second vendor from another online personal market of at least one of the other users.

In some embodiments, the social module is further configured to allow the user to share access to the online personal market with the other users.

In some embodiments, the news and communication module is further configured to provide a first filter that filters the news and communications directed to the user.

In some embodiments, the account management and utility module is further configured to allow the user to rank the one or more vendors in the online personal market.

In some embodiments, the account management and utility module is further configured to provide a second filter that filters vendor recommendations directed to the user.

In some embodiments, the analytics module is further configured to generate a unique shopper DNA (SDNA) for the user.

In some embodiments, the vendor module is further configured to provide at least one vendor dashboard for the one or more vendors.

Disclosed subject matter includes, in another aspect, a computer-based method for supporting an online personal market for a user, which includes registering the user and creating an online user account for the user, adding and removing one or more vendors to the online personal market, providing access to online social interaction and networking between other users and the user, providing online shopping access for the user to shop one or more products or services from the one or more vendors, providing the user an online ability to manage the online personal market, collecting and analyzing online actions of the user associated with the online personal market, and creating one or more vendor accounts for the one or more vendors and allowing the one or more vendors to access the online personal market.

In some embodiments, the computer-based method further includes providing one or more templates to the user for creating the online personal market.

In some embodiments, the computer-based method further includes providing news and communications to the user through the online personal market.

In some embodiments, the computer-based method further includes creating one or more sub-accounts for the user.

In some embodiments, the computer-based method further includes recommending through the online personal market at least a first vendor for the user to add to the online personal market.

In some embodiments, the computer-based method further includes presenting to the user at least a second vendor from another online personal market of at least one of the other users.

In some embodiments, the computer-based method further includes sharing access to the online personal market of the user with the other users.

In some embodiments, the computer-based method further includes filtering the news and communications directed to the user.

In some embodiments, the computer-based method further includes providing an interface to the user to allow the user to rank the one or more vendors in the online personal market.

In some embodiments, the computer-based method further includes filtering vendor recommendations directed to the user in the online personal market.

In some embodiments, the computer-based method further includes generating a unique shopper DNA (SDNA) for the user.

In some embodiments, the computer-based method further includes providing at least one vendor dashboard for the one or more vendors.

Disclosed subject matter includes, in yet another aspect, a non-transitory computer readable medium having executable instructions which is operable to, when executed by a computer, cause the computer to register a user and create an online user account for the user in an online personal market, add and remove one or more vendors to the online personal market, provide access to online social interaction and networking between other users and the user, provide online shopping access for the user to shop one or more products or services from the one or more vendors, provide the user an online ability to manage the online personal market, collect and analyze online actions of the user associated with the online personal market, and create one or more vendor accounts for the one or more vendors and allow the one or more vendors to access the online personal market.

A solution is provided for a method for a user to self-select connections with merchants, service providers, digital shopping tools and services in order to design and create a bespoke interactive digital shopping market.

A solution is provided for a method for a user to design and create an interactive buyer bespoke shopping network by connecting one's market with other private and public markets.

A solution is provided for a method for a user to aggregate and consolidate only that shopping news, information and messages relevant to the user on a buyer bespoke shopping network.

A solution is provided for a method for a user to aggregate participating vendors and find prospective vendors while filtering out unwanted vendors for a bespoke shopping destination.

A solution is provided for a method for a user to aggregate participating vendors and find prospective vendors through logos and representative images that do not need translation.

A solution is provided for a method for a user to manage a bespoke shopping market dynamically and with data, tools, features, options relevant to the user.

A solution is provided for a method for a user to aggregate a dynamic and bespoke window shop.

A solution is provided for a method to create a repository of user data, traits, shopping preferences and habits across vendors, within industries and over time.

A solution is provided for a method to create a shopping genome.

In the interest of clarity a user can be an individual, an associated group that has created a common market, or a group of users.

### BRIEF DESCRIPTION OF THE DRAWINGS

The accompanying drawings, which are incorporated into and constitute a part of this specification, illustrate one or more embodiments of the disclosed subject matter, and together with the detailed description, serve to explain the principles and implementations of the invention. In the drawings,

FIG. 1 illustrates a simplified rendering of a buyer's market as compared to a seller's market according to an exemplary model;

FIG. 2 depicts a block diagram illustrating a simplified version of a host modular system for a buyer's bespoke shopping network according to an exemplary embodiment of the disclosed subject matter;

FIG. 3 illustrates a simplified rendering of a user-defined or bespoke shopping network platform according to an exemplary embodiment of the disclosed subject matter;

FIG. 4 illustrates a simplified rendering of a buyer bespoke shopping network utilizing a host platform to access and filter various resources according to an exemplary embodiment of the disclosed subject matter;

FIG. 5 depicts a simplified version of a host platform presenting modules to a user who makes dynamic bespoke selections according to an exemplary embodiment of the disclosed subject matter;

FIG. 6 is a block diagram illustrating exemplary process flow enabling a user to create a bespoke shopping network and a host to execute the buyer bespoke shopping network;

FIG. 6A is a block diagram illustrating exemplary process flow enabling a user to create a bespoke shopping network;

FIG. 6B is a block diagram illustrating exemplary process flow for buyer bespoke selection within a buyer bespoke shopping network;

FIG. 6C is a block diagram illustrating exemplary process flow for use and management of a buyer bespoke shopping network;

FIG. 7 depicts a screen shot illustrating a public home page of the host platform according to an embodiment of the disclosed subject matter.

FIG. 8 depicts a screen shot illustrating an alternative view in list format of a public home page of the host platform according to an exemplary embodiment of the disclosed subject matter;

FIG. 9 is a flow chart depicting the general nature of a blueprint module for a user to create a BBSN according to an exemplary embodiment of the disclosed subject matter;

FIG. 10 shows a list of representative profile data according to one embodiment of the disclosed subject matter;

FIG. 11 indicates the organization and election of a user's elected options according to an exemplary embodiment of the disclosed subject matter;

FIG. 12 depicts a screen shot illustrating a view of a homepage once the user has logged in according to an exemplary embodiment of the disclosed subject matter;

FIG. 13 is a block diagram for a blueprint module enabling a user to design a bespoke shopping network;

FIG. 14 depicts a simplified version of an alternative format for a screen shot of a sample gallery template according to an exemplary embodiment of the disclosed subject matter;

FIG. 15 depicts a simplified version of a screen shot of a sample block template homepage according to an exemplary embodiment of the disclosed subject matter;

FIG. 16 depicts a simplified version of a screen shot of a sample icon template homepage according to an exemplary embodiment of the disclosed subject matter;

FIG. 17 depicts a simplified version of a screen shot of a page designed to enable and facilitate a user's choice of markets for her shopping network according to an exemplary embodiment of the disclosed subject matter;

FIG. 18 shows an exemplary list of sample choices from a word bank for choosing categories for creating shops and centers according to an exemplary embodiment of the disclosed subject matter;

FIG. 19 depicts an exemplary screen shot of a food shop according to an exemplary embodiment of the disclosed subject matter;

FIG. 20 depicts a simplified version of an exemplary service center screen shot according to an exemplary embodiment of the disclosed subject matter;

FIG. 21 depicts a screen shot illustrating a user who has created an account and made social connections according to an exemplary embodiment of the disclosed subject matter;

FIG. 22 depicts a screen shot of a vendor window or page denoting information a user may view upon selecting the vendor according to an exemplary embodiment of the disclosed subject matter;

FIG. 23 depicts a simplified version of an exemplary screen shot of a vendor thesaurus according to an embodiment of the disclosed subject matter;

FIG. 24 depicts a simplified version of an exemplary screen shot of a user's template market selections according to an embodiment of the disclosed subject matter;

FIG. 25 depicts a simplified version of a screen shot of host recommendations for a sports shop according to an exemplary embodiment of the disclosed subject matter;

FIG. 26 depicts a simplified version of an exemplary host auto fill recommendation screen shot according to an exemplary embodiment of the disclosed subject matter;

FIG. 27 is a block diagram illustrating exemplary process flow for the application of user-selected and host filters for adding or restricting vendors as it relates to a user's BBSN;

FIG. 28 depicts an exemplary BBSN button used to link to BBSN from a vendor website or mobile device according to an exemplary embodiment of the disclosed subject matter;

FIG. 29 depicts a screen shot illustrating a view of a social page according to an embodiment of the disclosed subject matter;

FIG. 30 depicts a screen shot illustrating a view of a public profile and a user's bespoke market according to an embodiment of the disclosed subject matter;

FIG. 31 depicts a screen shot illustrating a searchable news page according to an embodiment of the disclosed subject matter;

FIG. 32 depicts a simplified version of an exemplary newsstand screen shot according to an exemplary embodiment of the disclosed subject matter;

FIG. 33 depicts a screen shot of alerts where the user will review messages from or posted by vendors according to an exemplary embodiment of the disclosed subject matter;

FIG. 34 is a flow chart illustrating systems and methods for utilizing various shopping components within a BBSN according to an exemplary embodiment of the disclosed subject matter;

FIG. 35 lists some exemplary customers of a BBSN according to an exemplary embodiment of the disclosed subject matter;

FIG. 36 depicts a screen shot of compose message where the user will be able to compose and send a message according to an exemplary embodiment of the disclosed subject matter;

FIG. 37 depicts a screen shot of sent messages where the user will be able to review, manage or delete sent messages according to an exemplary embodiment of the disclosed subject matter;

FIG. 38 depicts a screen shot of messages where the user will be able to review, reply or delete messages according to any exemplary embodiment of the disclosed subject matter;

FIG. 39 is a block diagram illustrating elements of a host platform according to an exemplary embodiment of the disclosed subject matter;

FIG. 40 depicts a screen shot of a user's bespoke shopping network public profile page according to an exemplary embodiment of the disclosed subject matter;

FIG. 41 depicts a screen shot of a user's bespoke shopping network vendor management page according to an exemplary embodiment of the disclosed subject matter;

FIG. 42 depicts a simplified screen shot of an alternative view of a user's bespoke shopping network vendor management page according to an exemplary embodiment of the disclosed subject matter;

FIG. 43 depicts a screen shot of a user dashboard according to an embodiment of the disclosed subject matter;

FIG. 44 depicts a simplified version of an exemplary screen shot for money options and tools according to an embodiment of the disclosed subject matter;

FIG. 45 illustrates the simplified and general process of matching vendor and user data to make recommendations according to an exemplary embodiment of the disclosed subject matter;

FIG. 46 depicts a screen shot of a user filter for specified vendor news and messages according to an exemplary embodiment of the disclosed subject matter;

FIG. 47 a block diagram illustrating a collection of user data across vendors and over time while utilizing a BBSN;

FIG. 48 illustrates exemplary shopping traits a host may choose to collect according to an exemplary embodiment of the disclosed subject matter;

FIG. 49 depicts a general process for matching user data with vendor data and ranking the results for distribution to the user in the form of recommendations according to an exemplary embodiment of the disclosed subject matter;

FIG. 50 depicts a screen shot illustrating a vendor's dashboard according to an embodiment of the disclosed subject matter;

FIG. 51 depicts a screen shot illustrating a vendor's message board according to an embodiment of the disclosed subject matter;

FIG. 52 depicts a screen shot illustrating a vendor's comments according to an embodiment of the disclosed subject matter;

FIG. 53 depicts a screen shot illustrating a vendor's posts according to an embodiment of the disclosed subject matter;

FIG. 54 depicts a screen shot illustrating a vendor's advertising import according to an embodiment of the disclosed subject matter;

FIG. 55 depicts a screen shot illustrating a vendor's terms and conditions and vendor's option to accept, according to an embodiment of the disclosed subject matter;

FIG. 56 depicts a screen shot illustrating a vendor's ability to view various analytic reports according to an embodiment of the disclosed subject matter;

FIG. 57 is a block diagram illustrating a building module through which a user designs a BBSN according to an exemplary embodiment of the disclosed subject matter;

FIG. 58 is a process flow chart illustrating various means of searching, finding and making social connections on a BBSN according to an exemplary embodiment of the disclosed subject matter;

FIG. 59 is a process flow chart illustrating aggregating relevant news and communication, redistributing same, and providing for user bespoke selection and according to exemplary embodiments of the disclosed subject matter.

### DETAILED DESCRIPTION

In exemplary embodiments of the disclosed subject matter, systems and methods can be provided to create, manage and support a web-based interactive buyer bespoke shopping network. In what follows, such exemplary systems and methods will be sometimes described with reference to Buyer Bespoke Shopping Network (BBSN.) It is noted that all of the features, elements, systems and methods described hereinbelow are exemplary in nature, and so intended, and not limiting, regardless of whether they are described as being exemplary or not. Those of ordinary skill in the art will realize that the following detailed description of the disclosed subject matter is illustrative only and is not intended to be in any way limiting. Other embodiments of the disclosed subject matter will readily suggest themselves to such skilled persons having the benefit of this disclosure.

In the interest of clarity, not all of the routine features of the implementations described herein and shown are described or fully described. Not all components of systems and methods herein must be enabled in order for other components to function. It will be appreciated that there may be varying orders of priority or emphasis, depending on business goals or constraints or a person's knowledge base, and consequently, options or undertakings for implementation may vary from one developer to another.

The interface of embodiments of the disclosed subject matter of systems and methods is inherently flexible, dynamic and inclusive as it constructs an application through which a user can aggregate a bespoke shopping network from a multitude of resources. In accordance with the disclosed subject matter, the components, process steps and/or data structures may be implemented using various types of operating systems or devices or third party services to perform select components or features of the process and method herein described. A BBSN platform and/or certain systems and methods therein can be delivered via the internet to computers, tablets, phones, mobile and other future browsing, shopping or purchasing devices.

The systems and methods of embodiments of the disclosed subject matter create a buyer bespoke shopping platform, which in turn generates component parts and capabilities that give rise to derivative functionalities, products and services. A BBSN platform can be presented free to users who register or create an account. Upgrades may incur a fee. In exemplary embodiments of the disclosed subject matter a BBSN platform host earns revenue through sales commissions, subscription services, advertising, analytics and/or data mining.

Structures of the systems and methods can include but are not limited to (i) a buyer's market, (ii) an aggregation of shopping related resources, (iii) a modular and dynamic interface, (iv) bespoke selection, (v) user clickstream across vendors and over time, and (vi) social connections and networks.

The disclosed subject matter generally relates to a buyer's market. Most shopping venues employ many (buyers) to one (seller's market) construct. A Buyer Bespoken Shopping Network (BBSN) in some embodiments employs the reverse construct of many (sellers) to one (buyer's market).

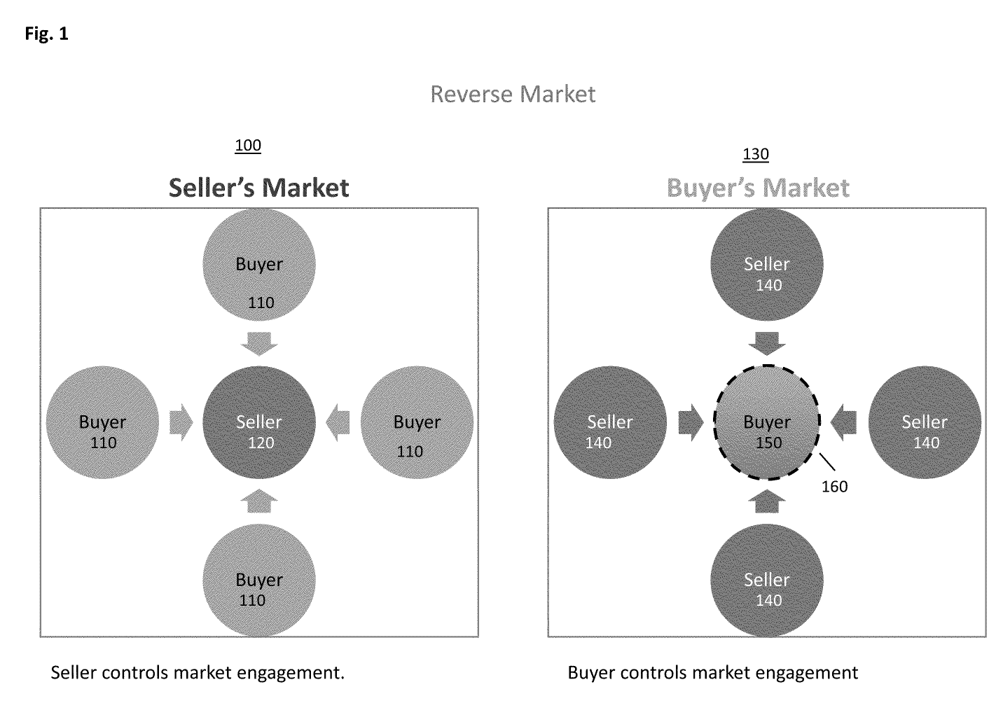

FIG. 1 is a simplified diagram illustrating a difference between a seller's market 100 and a buyer's market 130. In a seller's market, customers, shoppers, browsers and buyers (each, a “Buyer”) 110 flock to a seller, an individual vendor or a market of aggregated vendors 120 (each a “Seller”). Sellers seek to keep market engagement open in order to attract as many Buyers as possible. In a buyer's market 130 one or more Sellers 140 flock to each Buyer 150. and each Buyer might seek to limit 160 market engagements to Sellers that are relevant to the Buyer.

In some embodiments, a BBSN provides systems and methods for a user to create a bespoke shopping center. With self-selected vendors and tools, a BBSN improves efficiency and relevancy.

In exemplary embodiments of the disclosed subject matter a BBSN is a user's bespoke online shopping mall; a restricted access mall to call her own. The online platform available to the user is analogous to a real estate owner who leases space to selected retailers. Similar to how real estate owners build and provide vanilla or unfinished space for retailers to fit-out according their needs, in exemplary embodiments of the disclosed subject matter a host provides vanilla or form online markets for the user to fit-out or organize according to her needs. A user can “advertise” for vendors (by making interests known). Unconstrained by physical limitations or accompanying leases, a BBSN platform adds the advantage of a user being able to expand or amend her online tenancy at any time. A vendor can become an online tenant in numerous BBSNs.

In exemplary embodiments of the disclosed subject matter a BBSN serves as a shopping facilitator. A platform host makes educated recommendations; a user enjoys easy recall and access to preferred vendors. A BBSN is like a personal address book and contact list of preferred shopping venues and inventory. A BBSN encourages loyalty and strengthens the shopper-vendor relationship.

In exemplary embodiments of the disclosed subject matter a BBSN is a boutique market designed by and for a user. The systems and methods provide a dynamic online digital shopping application that enables a user to define and create a bespoke, privately controlled, shopping homepage or digital market that can be accessed through computers, mobile devices, tablets and other digital devices. Using the bespoke modules provided by the host, the buyer controls the size, content and direction of the vendors, inventory, customers and services in her BBSN. A user can access self-selected vendors, shopping venues, services and shopping tools in one convenient location. The inventory, advertising and messages of such vendors can be aggregated and searched. As a self-selected repository of data and link systems, the content is relevant, efficient and convenient to the individual buyer. Through a product module, a BBSN allows a user to select her inventory by vendor and thereby stock her boutique with products and services that are most likely to make the most sales to her. She is her own best customer. She knows best how to capture her own disposable income. She, or her group, can conduct reverse auctions by posting product or service needs and having sellers seek to fill those requests.

In some embodiments, A BBSN provides systems and methods for a social shopping interface and the creation of a shopping network. Friends often share similar interest and tastes and can benefit from each other's shopping recommendations. A BBSN enables a user to share her mall with friends, have friends help her shop online, share preferences, co-browse, choose privacy settings, have a dialogue with her vendors, be a trend setter, be an online “It Girl” or create mini-malls for sharing with a group or particular club. In exemplary embodiments of the disclosed subject matter a user can create a shopping network, and the network can keep her informed.

In exemplary embodiments of the disclosed subject matter buyers will connect through buyers markets and create a shopping network, whether online, through mobile applications, via cloud services or alternative solutions. As buyers connect with one another through friend or follower requests and as they share information through their BBSN, buyers may build increasingly efficient and intelligent marketplaces.

In some embodiments, a BBSN provides systems and methods for shopping communication that is relevant and useful to the user. In exemplary embodiments of the disclosed subject matter, a host platform might house one or more means of communication including primary, secondary or third party communications vehicles such as, RSS, email, messaging, social, news alerts or other communication accounts that enable vendors, specialists and consumers to send and receive news, information and messages regarding specials, sales, new inventory, coupons, reminders, updates or codes and other shopping or vendor related topics. Whether public, targeted or private messages there are several advantages to having BBSN serve as an axis of communication for shopping information: various types of shopping communication are aggregated and organized; it is located where a user browses and buys; vendor messages are convenient and effective; a user keeps her private email focused on personal or business matters and her shopping emails on her BBSN; a BBSN eliminates an annoying level of vendor emails in one's personal email account; vendor emails might be filtered, with only preferred vendor messages passing through to the user; a user might isolate and separate vendor emails from personal emails; communications from the same vendor might be aggregated together; a user might be more likely to share her BBSN email with other shopping-related bloggers, magazines, stylists, etc.

In some embodiments, a BBSN provides systems and methods for bespoke selection and universal application of shopping tools (loyalty programs, method of payments, shopping lists, purchase history, and the like), market features (size, selection, organization), recommender system, privacy, communications (news, messages), social connections (friends, guests, followers), data collection, management and services (concierge, delivery, wrapping and shipping, gift cards, and the like), related services (games, entertainment) and then access and use such tools as part of her BBSN.

In some embodiments, a BBSN provides systems and methods for a vendor channel to customers. A BBSN is a window to a vendor's shop, emails, coupons, catalogues, social outreach and news. While on a BBSN, a user is by definition, interested in shopping and therefore probably more prone to notice, read and act upon an advertisement, news release, coupon or other form of news and communication. A BBSN host aggregates shopping news and communications, filters the results, and redistributes relevant news and communication to users at browse and buy time. Marketing and advertising materials can be targeted. For example, vendors can pay to market to (i) a customer who invites them to be mall members, (ii) a customer who invites their competitor to be a mall member, (iii) a subset of customers, based on purchases, browsing, competitors, etc., (iv) customer guests, (v) a user who has not rejected them as a vendor, (vi) a user who has indicated a key word in the word bank, (vii) visitors, (ix) a user who has had a recent change in personal information, such as a change of address, (x) users of a certain age, in a certain location or (xi) other personal or group characteristic.

In exemplary embodiments of the disclosed subject matter, a BBSN allows for an efficient hub of social shopping information. Social media experts must try to gather customer intelligence across multiple mediums. The open ended social construct with multiple channels is complex, costly and difficult to measure. Companies will hire public relations firms to manage social media efforts. A BBSN funnels media from multiple channels to one channel direct to user. A single channel to individual users and can provide a measurable return on investment as the host platform utilizes a permitted clickstream database to record and measure user shopping interest, behavior and actions.

In some embodiments, a BBSN provides systems and methods for collecting customer intelligence. The types of data that can be discovered include but are not limited to where a customer chooses to browse, where she chooses to shop, how many vendors she tends to frequent, if she has strong preferences and brand loyalty, if she is subject to advertising, how much friends influence her, how often she shops a week, when she is likely to shop, etc. The system provides for a shopping only clickstream database on a single network as opposed to attempts to find customers on various sites and through various channels or pursuing a customer search on their personal device. The data mine can also be used for strategic business purposes. A vendor can learn about its business relative to its competitors and the industry as a whole. The data mine is deep and unique to a BBSN, and therefore the analytical options predicated on that data would be unique to a BBSN as well.

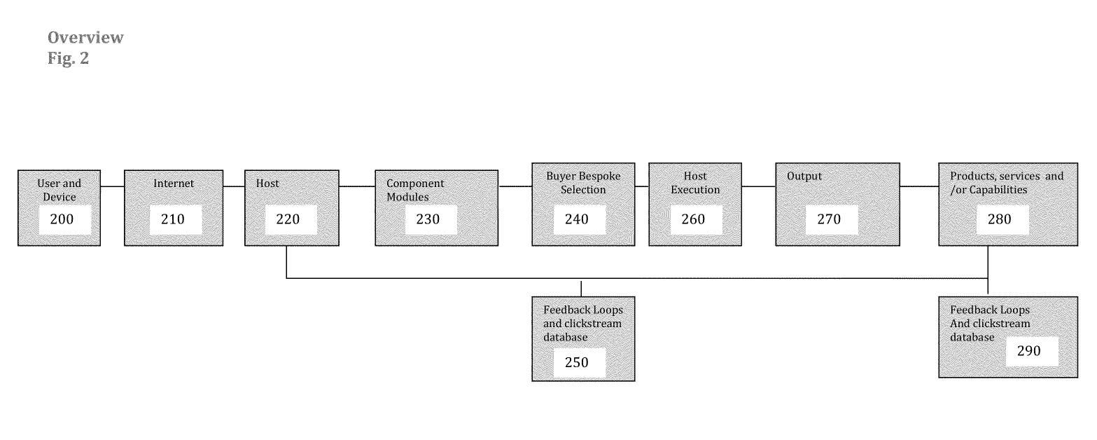

In some embodiments, the disclosed subject matter, shown in FIG. 2, allows a user (or associated users) with a digital device 200, such as a computer, laptop, tablet, mobile or other device that can connect to the internet 210 to access a web server and host platform 220 with systems and methods for creating a buyer bespoke shopping network (BBSN). The host has various levels of access to databases and systems of the user, host, vendors and third parties and presents modules 230 to the user in order to aid and facilitate a buyer's bespoke selection 240 of relevant shopping data, links, information, connections and utilities. Those decisions are fed back to the host 250 for execution and future use. The host creates the bespoke network as requested by the user 260. Each user network is different and reflects the unique decisions made by the user. Each network has a unique data set and unique products or component parts 270. The use and operations of the products, components and network are recorded and retained. Components and various bits of information from various components enable the host to design and create unique derivative products and services 280. As the user navigates and takes action, a clickstream database 290 provides feedback to the host along with data for future use and reference.

In the exemplary models described herein, the systems and processes are structured as modules and components, such that an element can be (i) enabled or not, in accordance with the business goals of the host and the user device or (ii) elected or not in accordance with the preference of the user. For example, a baseline model would include a buyer's market. One might layer upon that a social network, or not. A user might choose to have more than one market, or not, within the user BBSN. As described herein, the system and process emphasizes the ability of the user to make elections that best serve the user.

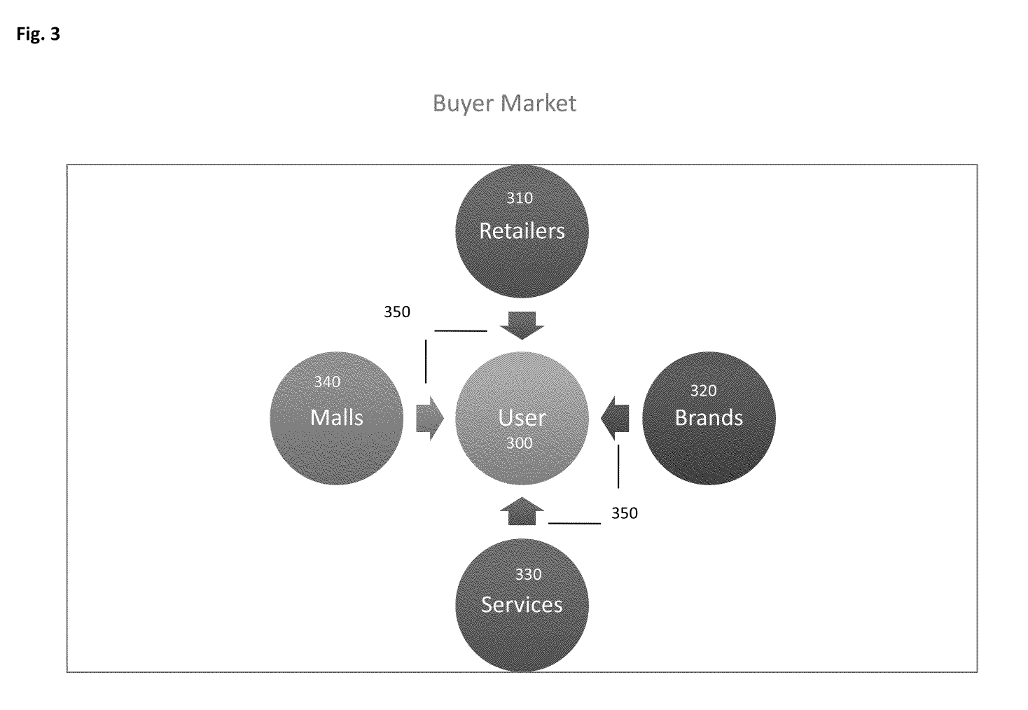

FIG. 3 illustrates a simplified overview of a buyer's market according to an exemplary embodiment of the disclosed subject matter. The systems and methods are designed with the user 300 as the central shopping destination. The system enables and facilitates links to vendors, including but not limited to retailers 310, brands 320, services 330, malls 340 and other groups of vendors, merchants, service providers, curators, non-profits, shopping utilities, and social connections. The systems and methods allow the user to choose the components and features relevant and valuable to the user. The systems and methods may include various links 350 or forms of connecting with vendors, including but not limited to external links, scraping and linking, embedding entire website, dynamically embedded components, API and other options.

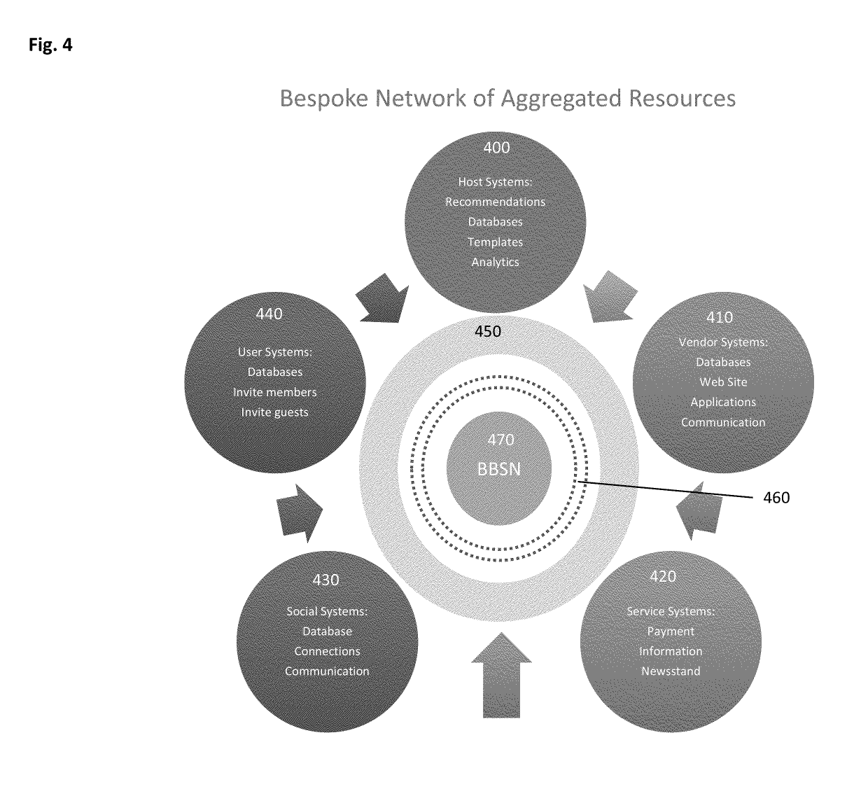

A host platform can access numerous resources, aggregate databases and create modular shopping systems and methods for the design, creation, execution, interaction and use of a BBSN. FIG. 4 illustrates a simplified overview of a BBSN according to an exemplary embodiment of the disclosed subject matter including but not limited to the host systems and databases 400, vendors systems and related databases 410, service systems and related databases 420, social systems and related databases 430, and user systems and related databases 440 along with the host aggregation of such related material from one or more sources 450, and a user bespoke selection 460 to winnow the aggregated methods and systems to that which is relevant to the user for the design and creation of a BBSN 470. For illustrative purposes and to be more fully described herein in part, a host platform 400 might provide templates and recommendations for creating a bespoke market; one or more vendors might link its website to the mall or provide data within a BBSN browser or platform, including products, advertisements and forms of communication with the user; service systems 420 may include payment systems (such a PayPal, Visa, etc), purchase history, wish lists (such as wishlist.com), newsstands, magazines, free shipping (such as ShopRunner), videos, coupon services or other forms of shopping information; social databases 430 and connections might utilize API to import and include family, friends, followers, followees, guests or the public and each connection may have one-way or two-way access within the network through private, semi-private or public right of way whether from pre-existing third party social accounts (such as Facebook or Twitter) or newly created; and users may make various decisions within the system and methods designed to serve the user's goals.

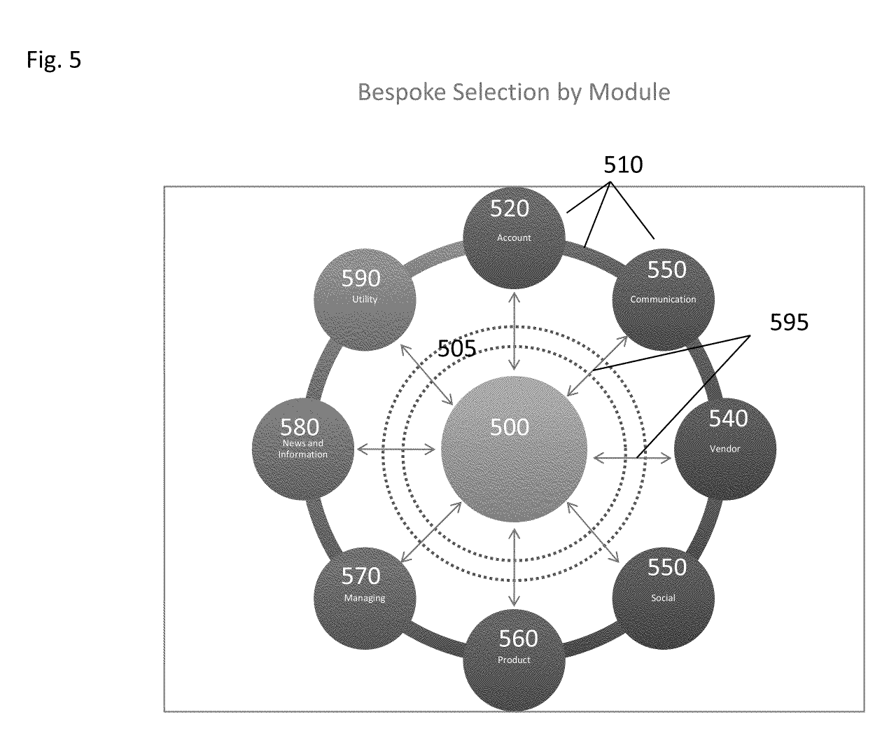

In some embodiments, a host aggregates shopping data, components and systems from various sources and presents various modules to a user, in accordance with the host business goals and the user account level. A user makes various bespoke selections by module, allowing only certain data or components to pass through the buffer to the user network. The user chooses from among a vast array or databases, tools, features, services and connections for inclusion within her BBSN. Each time she visits her BBSN, she will enjoy easy viewing of and access to her prior selections, with updated news and information. Certain modules might be presented to a user free of charge and additional modules might be presented to a paying or subscription user. By way of example, FIG. 5 illustrates exemplary modules 510 a host may present to a user 500. Representative modules might include, account 520, communications 530, vendor selection 540, social 550, product 560, network management 570, news and information 580, utility 590, including but not limited to forms of payment, budgeting, credits, payment history, and allowances. Utilizing the modules and the bespoke ringfence or gatekeeper feature 505 of the systems and methods, a user will select, filter or winnow the aggregated information, components and system modules to that which is relevant to the user. The selection and filtering process allows for a temporary buffer, filter or ringfence 505 that the user can alter and change at will. As a user makes selections and decisions within various modules, the host executes the order 595.

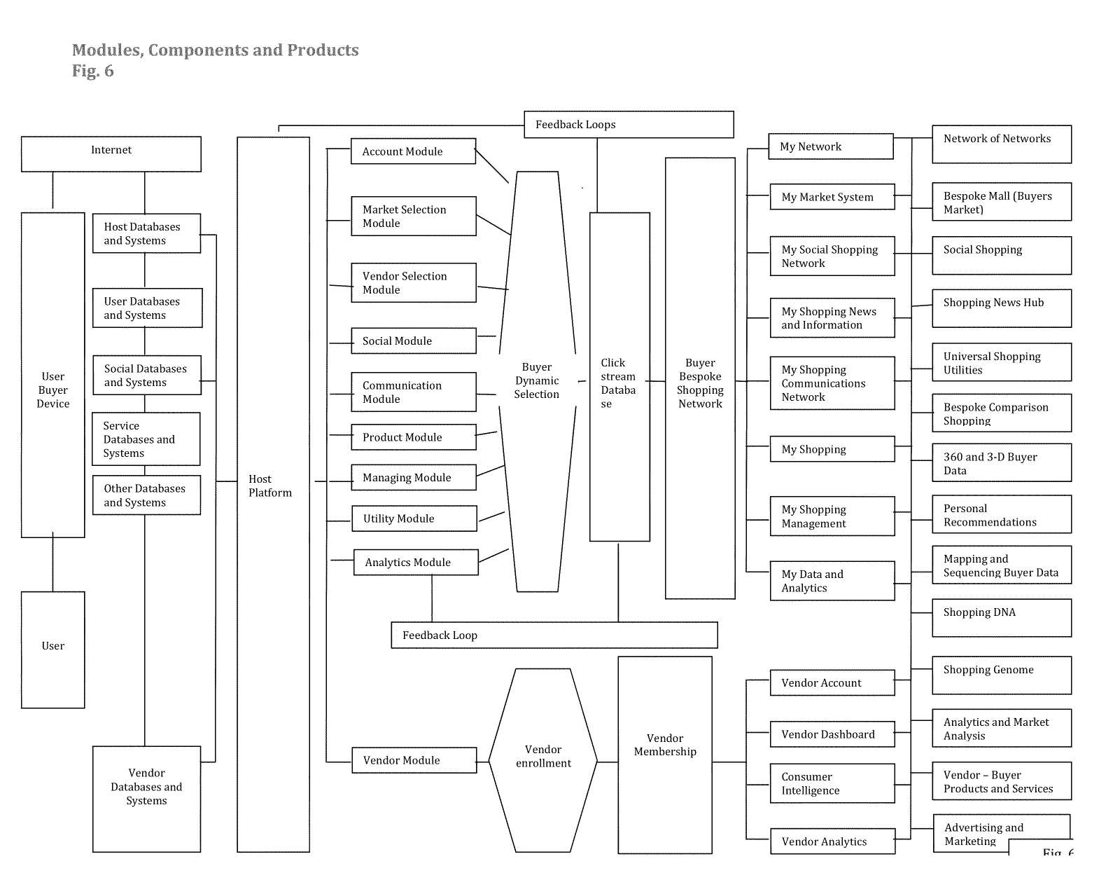

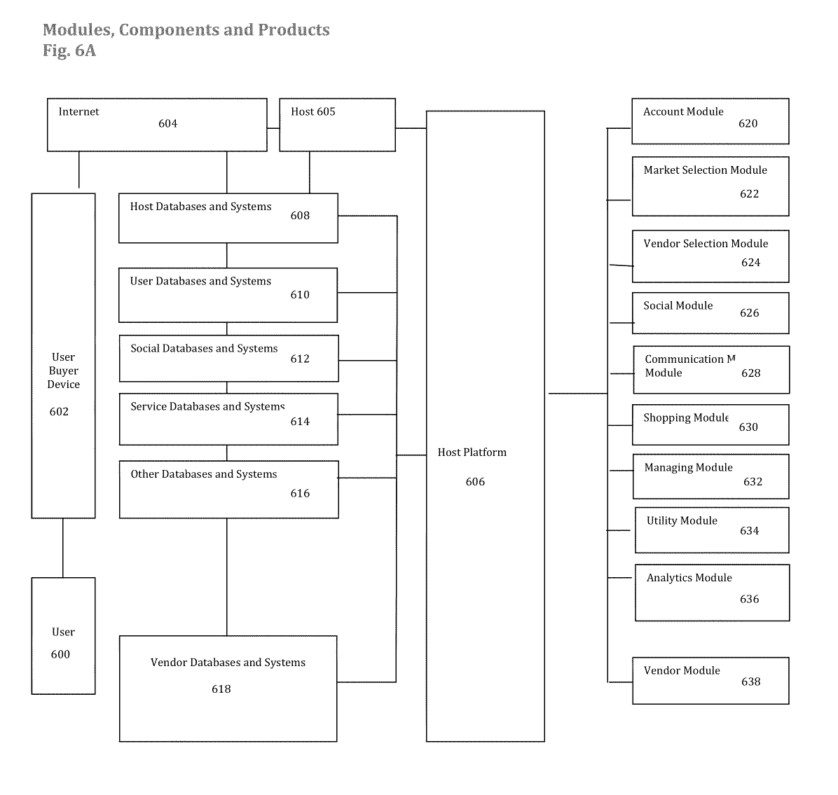

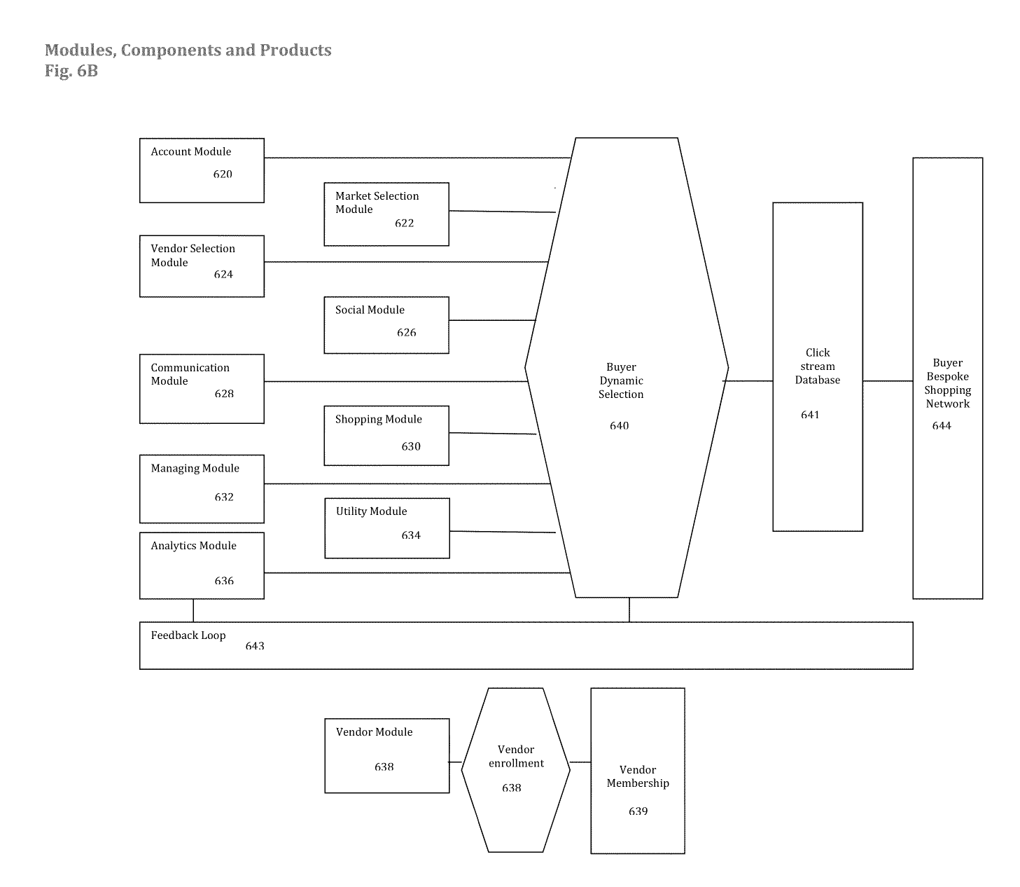

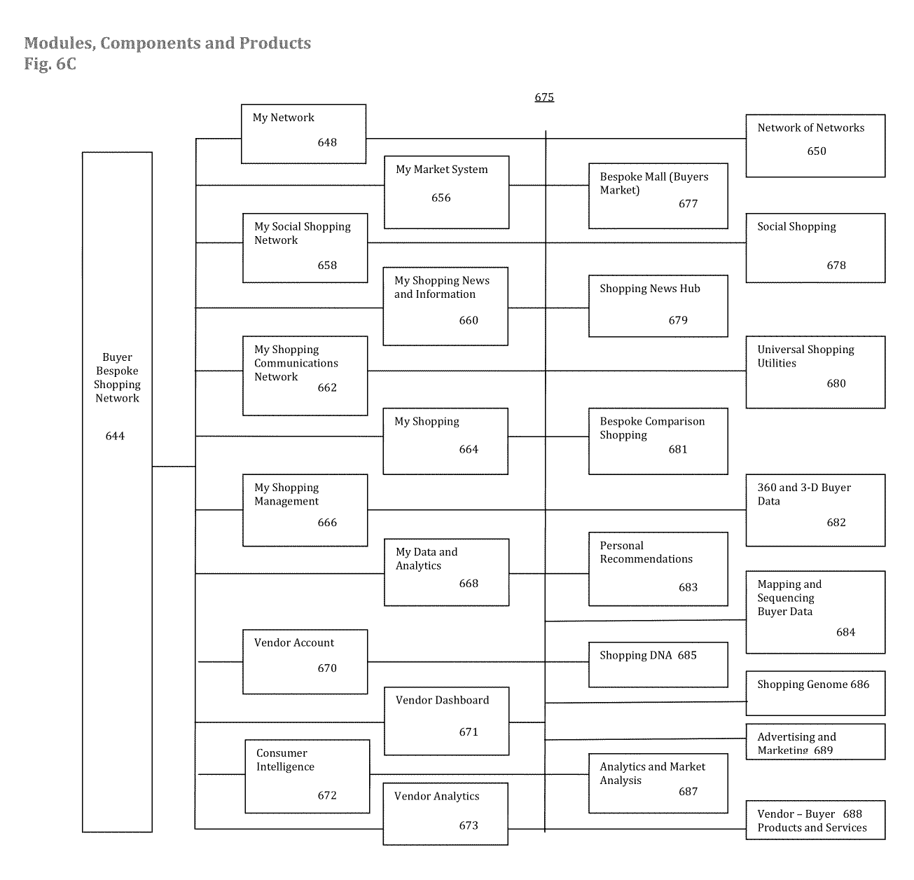

FIG. 6 is a flow diagram illustrating a simplified version of the systems and methods of a BBSN as well as its inputs, components, output and derivative capabilities, products and services, according to some embodiments. FIG. 6 is divided and displayed as FIGS. 6A, 6B, and 6C for ease of use of the reader. A user 600, through the use of a digital device 602, such as a computer, tablet, smart phone, mobile or other device, connects to the internet 604 and a host platform 606 for creating, using, managing and displaying a BBSN. The host accesses (i) its databases and systems 608, (ii) user sources, databases and systems as allowed by the user 610, (iii) social resources 612, (iv) service resources 614, (v) other resources, databases and systems for browsing, shopping, purchasing, shipping and other shopping related activities 616, and (iv) vendor databases and system 618. The host platform houses the relevant data and tools for creating a BBSN through modular systems and methods.

Depending on its business goals a host presents various modules to a registered user for the design, construction, use and enjoyment of a BBSN. Each module may or may not access one or more databases and systems available on the host platform. An account module 620 may allow a user to create an account and select from among various levels of account access and service. A market selection module 622 may present the user with various options to create one or more markets or sub-markets in one or more formats. A vendor selection module 624 may present one or more options for finding, selecting and adding vendors to a user network. A utility module 634 may present various options for a user to dynamically edit, manage or adopt or elect services, features or options for managing and maintaining a bespoke network. A managing module 632 may allow a user to manage her account and components within her BBSN. A social module 626 may present one or more options for finding, selecting and connecting with friends, family, acquaintances or shopping experts. A communication module 628 may present one or more options for communicating with vendors or social connections or making public comments, rankings or ratings. A shopping module 630 may present one or more options for searching, comparing, selecting, purchasing, noting, highlighting or commenting on selected or filtered products. An analytics module 636 may present the host with various options for collecting, sharing and analyzing user and vendor data. A vendor module 638 may present vendors options for enrollment, account creation, and membership level.

A user accesses modules and makes selections among databases, websites, tools, features, options and the like. As the user makes bespoke selections 640, a clickstream database 641 will capture the user's movements and generate a feedback loop 642 to the host for (i) execution of the BBSN 644, (ii) feedback to the host, and (iii) input to the analytics module 636. The host will create a buyer shopping network for the user in accordance with the user's bespoke selections.

The buyer bespoke shopping network for each user is a unique reflection of the host platform, modules and user selections. Some users may elect to keep their shopping network 644 private, some may elect a semi-private network and some may elect a public network. As semi-private and public networks are connected through social networks, a network of networks evolves 650.

Each buyer bespoke shopping network produces various outputs. Output may include a network 648, a market system or mall 656, a social shopping network 658, aggregation of shopping information and news 660, shopping communication network 662, shopping lists and history and comparisons and the like 664, shopping management options, features, tools 666, user databases and analytics 668, vendor account 670, vendor dashboard 671, consumer intelligence (across vendors, categories and industries over time) 672, and vendor analytics 673 as more fully described hereinbelow.

The component outputs and the interactive and iterative exchanges among them 675 give rise to unique products and capabilities including but not limited to a network of buyer bespoke shopping networks 650, bespoke malls and markets 677, social shopping on buyer markets and public markets 678, aggregation of shopping news and information 679, universal shopping utilities across vendors and over time 680, bespoke shopping comparisons 681, direct and indirect data collection and analysis of buyer data 682, personal recommendations based on buyer input and data 683, mapping and sequencing of buyer data 684, shopping DNA 685, discovery of user traits and habits across vendors, within industries and over time or shopping genome 686, analytics and market analysis 687, vendor buyer products and services on a shopping network where the buyer chooses to browse and buy 688, advertising and marketing 689 and the like, as to be more fully described herein. Shopper DNA, as more fully described hereinbelow, is a uniform code that identifies an individual's (or group's) shopping traits. Shopping traits may include factual data, direct data, indirect data, derived data, historic data and predictive data that is relevant to shopping and purchasing. Traits may or may not include one or more of the following: gender, age, income, wealth, address, preferences, purchase history, habits, group association and many others. Shopper DNA might be used by vendors to better target a customer and present relevant information. Shopper DNA might be used by customers to better find or request desired vendors, products, and services.

### Host Platform Modules

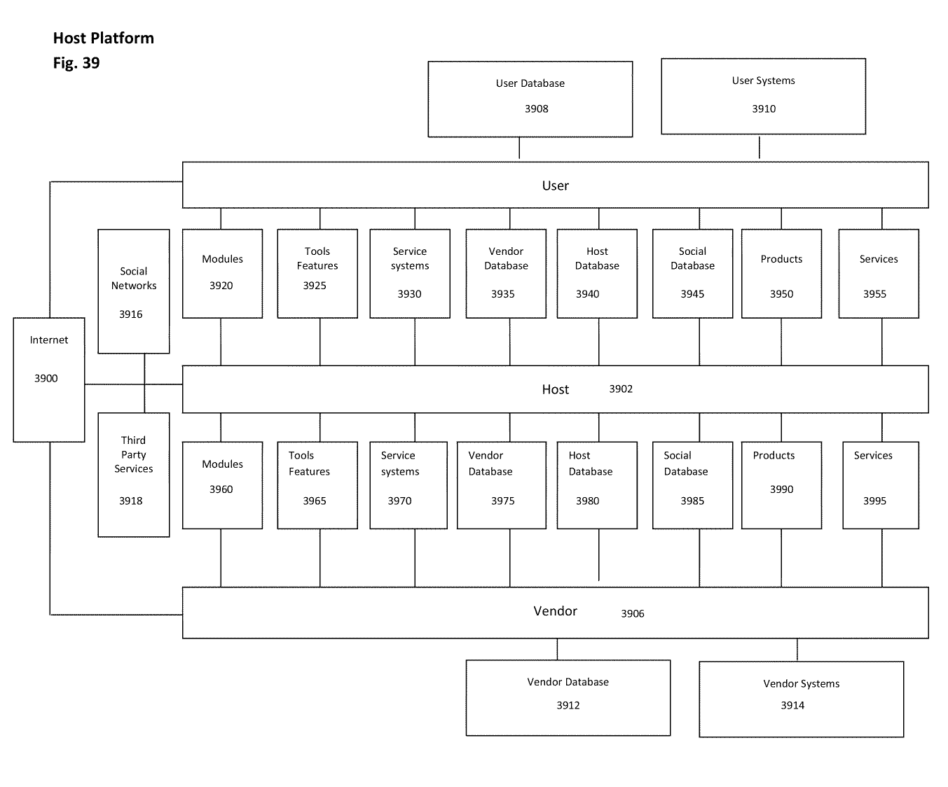

A host will provide a BBSN platform and accompanying modules in accordance with its business goals. FIG. 39 is a block diagram illustrating an embodiment of elements of a host platform. Resources for and inputs to the platform include databases and systems of (i) the host 3902, (ii) users 3904 (as allowed), (iii) social networks 3916, (iv) third party services 3918 and (iv) vendors 3906. Some modules, as more fully described herein, may be available to all account holders free of charge and some modules may be available for a fee or based on prior actions or credits. A user will access the modules 3920 to blueprint a buyer bespoke shopping market that the host system will execute. The host system contains tools 3925 relevant to the disclosed subject matter and presents them to the user via the host platform. The types of tools, options and features 3925 the host offers the user may vary and grow in accordance with the business plan and goals of the host provider. Common tools might include a search engine, such as Google, that enables the user to search the internet, an account logon through a third party or an import contacts feature, such as Facebook. Other tools, options, functions, features and the like are more fully described in the Utility Module.

In one embodiment of the system, a host vendor database 3935 and 3975 contains vendors from various countries who sell products or services. Herein, vendors is a broad term intended to be inclusive of merchants, retailers, wholesalers, brands, service providers and non-profit organizations etc., with a digital presence, and with or without a land-based presence. Vendors may be in the form of online only merchants, single product or multiproduct merchants, retailers, boutique stores, department stores, brands, service providers, collective, group buying, wholesalers, warehouses and others. The host database of vendors may be dynamic and include all vendors searchable via the internet or subsets thereof, as determined by the host of the disclosed subject matter. Vendors in large urban centers or on famous shopping streets or large shopping markets are likely to be included in the host database of vendors. The host may provide access to smaller vendors or allow a user to add or recommend vendors. As users add vendors to their network, the information can then be fed back to the host platform for consideration for inclusion in its database. Using such a feedback loop, the host database can have an ever-expanding universe and continually develop into a more valuable resource. It is noted that while a host platform may or may not endorse, guaranty or restrict vendors, the host may retain the right to choose which vendors are listed, provided, or stored in its database. Alternatively, the host vendor database may be offered as a tool and may or may not restrict a user's ability to add vendors to her BBSN. The look and feel of the database might also evolve and include conventional contact card information, hyperlinks, icons, advertising and animation. Formats can either be consistent or vary.

The host may categorize and organize vendors in various descriptive or factual categories, such as women, men, children, home, department store, boutique or other searchable or organized form. The host vendor database may include host-defined categories, vendor-defined categories, search-defined or a combination thereof. Categories may be facilitated through the use of an auto suggest plug-in such as that found through code.drewwilson.com. Similarly, the labels assigned to each vendor may be either those assigned by the host, the vendor or both. Such selection may be assigned at the time the vendor is enrolled in the host system and may be updated by the relevant party. Options might include alphabetical listing, city, state or zip code searches, largest retailers, preferred vendors, inventory, etc. Hosts may choose to create sub-categories in order to facilitate search options.

A host database 3940 and 3980 may include a vendor database, social database, geographic database and others. Databases may be distinct for ease of use; formatted or organized in order to provide a host database for the user and a separate host database for the vendor. Alternatively, databases may be combined, integrated or cross-pollinated or in such other format as the host may determine. Each database is dynamic and iterative as data is added and refined. A host database may include data derived from the use of the host system, including but not limited to user data 668 682, mapping and sequencing data 684, shopping DNA 682, shopping genome 686, market analytics 687, recommendations 683, filters and others.

In an exemplary model of the disclosed subject matter, the host can offer sort, query and search within its databases and with the aid of the internet or service providers and through tools such as drop down menus or navigation bars. A user can search for a vendor as one would through a search engine by looking for key words. The return might be refined based on personal filters. Queries or filters might include common shopping categories such as apparel, women, men, young adults, accessories, automotive, books/music/video, computer/electronics, flowers/gifts, food/drug, health/beauty, home improvement, home furnishings, jewelry, mass merchant, office, specialty/non-apparel, sporting goods and toy/hobbies among other categories and subcategories.

The host database and systems may also include a social database 3945 and 3985 of users and people who have a digital shopping presence, whether through a BBSN, shopping service, blog, publications, or other shopping venue. People who are likely to be included would be stylists, fashion advisors, columnists, consumer advocates, celebrities and others. Users are primary sources of information and data relevant to a BBSN. Accordingly, a host may encourage a user to provide or share relevant data. A host might provide a user with profile and opinion forms as a means of collecting user intelligence and improving service to the user. In exemplary embodiments of the disclosed subject matter, the host might make vendor recommendations for the user based on her responses. The user may fully or partially complete profile, interests and preferences forms that may be included in the social database with privacy controls. In one embodiment, the forms may contain multiple choice selections, word banks, checklists or other formats. Vendors may elect to use or coordinate with a face, public figure, spokesperson or celebrity for endorsements and through the social database. Social databases may be combined or offer restricted access to users or vendors. Certain spokespeople, bloggers or others may advertise or solicit offers to endorse through the vendor social database 3985 while appearing in the user social database for personal and professional choices.

A host may utilize its databases and systems to provide services. Services might include recommendations for vendors, services, people or products; an ability to collect, aggregate or organize shopping materials; access to third party databases or services and other services that may be consistent or a value add to the host business. In one embodiment, a host may dynamically compare, match and house data from multiple databases. A host database may organize and categorize its database of vendors so that it might be compared with its database of users. A host might use key words such as those commonly used to organize shopping malls, shopping lists, shopping services, shopping departments and shopping venues or those that identify lifestyle interests, use, product, service and others. The host might match the key words from its database of vendors with those selected by the user. Matches might be exact, directly connected, indirectly connected, subsets or expansions, as the host may determine and as understood by those skilled in the art.

By running database queries to match user selections with its database a host may make recommendations to the user. Such recommendations may utilize a proprietary formula or an e-commerce recommendation system designed by those skilled in the art. A user may accept, reject or remain silent as to the recommendations through an iterative process. A host may observe and note user choices and such feedback may or may not trigger additional, amended or revised recommendations from the host through a dynamic feedback loop within the system. By choosing to add a vendor, a user will import or add such vendor to his or her bespoke mall. A feedback loop may directly or indirectly relay to a vendor a user's positive, negative or silent actions. Data, comparison of data and feedback will all serve to expand and improve databases. Feedback to vendors may be used to improve their business, marketing or customer relations among other uses.

Social networks, databases and systems may facilitate user adoption and engagement. A host may allow access to or utilize APIs for the integration and importation of data.

The host databases and systems 608 may also access and use third party resources. The platform for the present system is shopping-centric and supportive of browsing, shopping, purchasing and donating. Data inconsistent with such purposes may not be sought or retained unless they attract or add value to the user or host business. Related services may include food, games, entertainment, special events, giveaways, contests, community service, shows, kiosks, and other efforts or activities to increase traffic. Related data might include audio or other visual representation, re-distribution or commentary on a vendor or any of its products or services. The host database may include those that market, advertise, distribute or otherwise aid in the sale of products and services, including but not limited to magazines, blogs, content media, product information or recall or regulatory institutions, associations and the like.

The platform may include vendor databases and systems 618. The host may choose to approve vendors before they are actually admitted to the network. In one embodiment, a host vendor database may include all vendors, whether approved or not, while a user vendor database might include only the approved vendors. The host may choose to categorize vendors as registered, listed, waitlisted, suspended, expelled, open or otherwise. The host may collect and retain information from vendor databases and systems. The host may choose to import text and/or graphics identifying the chosen vendor. Data might include, URL address; data within its website including inventory and service related facts, descriptions, figures, pricing, photos or video; systems and data as they vary by device or application; and data relating to the vendor found elsewhere on the internet. The database and its structure or organization may change in accordance with the dynamic growth of the system resources. Access to the vendor databases and systems facilitates presentation and query of inventory. The host database will be able to cross-reference and compare by vendor and across vendors as well as within or across vendor databases.

Depending on the business goals of those implementing the disclosed subject matter, a home page or host page or other page, modal window, view or screen may be public, semi-public or private and therefore certain actions or services systems 3930 may be enabled or restricted. The description of the invention will include various types of access. In this instance, the description will include a public home page for illustrative purposes. Whether the host page is public or private, the systems and methods described herein remain unique to the disclosed subject matter. In the interest of clarity, the present description may note options and describe one such option without need to describe all options that would necessarily be self-evident to those possessing the ordinary skill and art relating to such choice.

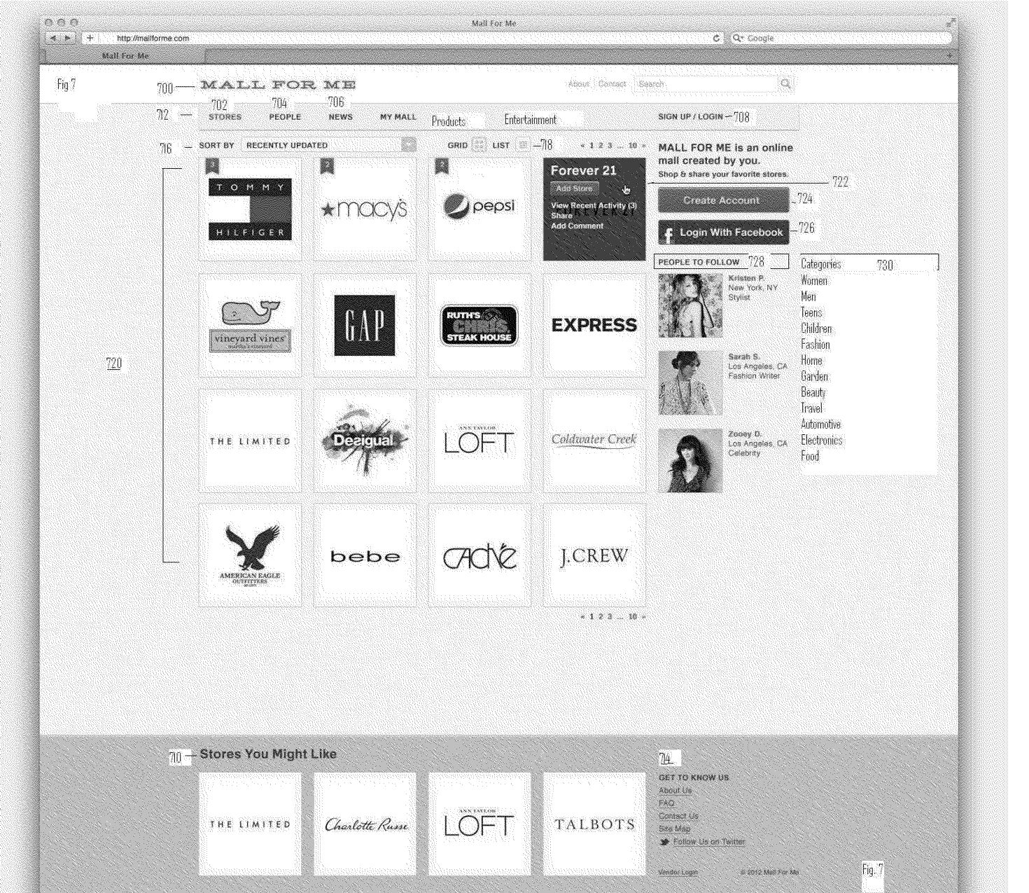

FIG. 7 depicts a screen shot illustrating one exemplary embodiment of a home page. A host 700 may provide public access to a homepage. A visitor can access a vendor database 702, a people database 704, a news database 706, account creation options 708 and generic recommendations 710 via homepage on the internet. Others might include product databases, entertainment hubs or other public elements. Public malls might allow a user to “touch and feel” the experience of a buyer's market. A user may relate to a particular persona and import or adopt all or a portion of the vendors from that persona mall into their own. A host may provide a navigation system 712, customary information 714, sorting options 716 and different views 718. A host page might allow a user to view public features, register and begin creating a buyer's bespoke shopping network. A home page might include representative features or logos of each vendor 720, hyperlinks to such vendor 722, and options to create an account 724, login through other social networks 726, viewing panes, links to other people who have malls 728 and query options. Navigation or actions might include hovering, modal windows, click and drag, geo location, or other techniques as commonly used by those skilled in the art and in accordance with the device being used.

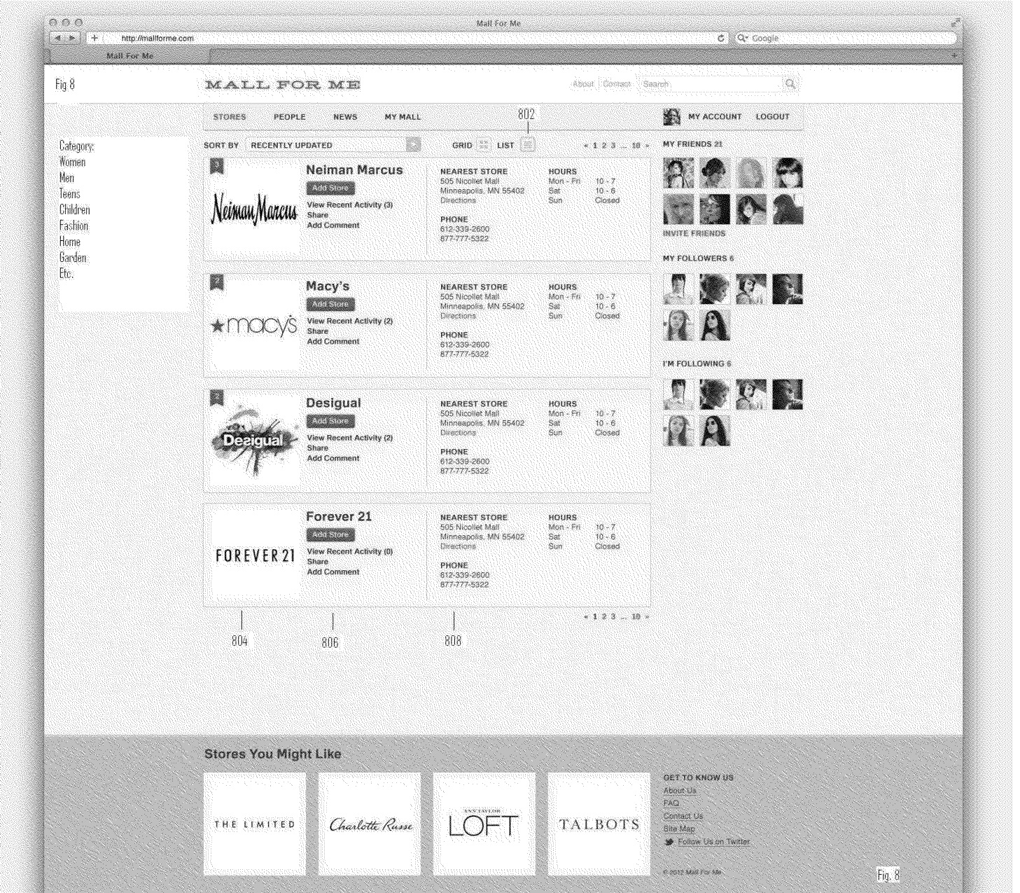

The host or home page is dynamic and interactive. The data presented changes as a result of the user having selected one view or another and through the passage of time as vendors, products, or social connections are updated. Sorting options might include recently updated, most popular, highest rated, or recently added among others. FIG. 8 depicts an exemplary screen shot of a list view 802 of a home page, inclusive of alternative forms of information including, in this exemplary model, logos, images or videos 804; action blocks 806 for adding vendors, sharing, commenting or viewing recent activity; and vendor information 808 among other features more fully described herein.

A host platform is designed to grow, change and evolve along with the user and vendor demand and usage. A host platform may choose to serve consumers, retailers or wholesalers as users and the products and services on the host platform in accordance with the users. A host may offer various products and services, and those products and services are likely to expand in service of and in respect of a buyer's market. In one embodiment, host products for users 3950 might include analytics, vendor or friend recommendations, premium level accounts, data, news hubs, purchasing reports and others. Host products for vendors 3990, in one such embodiment, might include analytics, marketing or target audience recommendations, data, news feeds, sales reports and others. Host services for users 3955, in one embodiment, might include but not be limited to wish lists, universal shopping carts, credit cards, tokens, points, gift suggestions, comparison shopping, product or service search, news or coupon clipping services, product suggestions, reorder and order management, purchasing systems and others. Host services for vendors 3995 might include among others, custom analytics, marketing strategy, advertising systems, and audience targeting. In some cases services may be packaged into products and products might be enhanced with services, and some services may evolve into products, as determined in accordance with the business goals of the host. In some instances, services and products may interact with user databases 3908 and systems 3910 and vendor databases 3912 and systems 3914.

### User Account Module

A user may request access and a host may grant full or partial access to a host platform through an account module and acceptance system. A host will provide one or more options for a user to register and create an account. In some cases registration and account creation may be combined. The user account system is an iterative process in which a user requests access, a host supplies a form for required data, a user chooses to supply the information or not, and if so supplied, the host will either grant the user access or enable the requested functionality, as appropriate. The enabled actions within a module may be dictated by the user device. Some components of the account module may be required (such as registration and account creation) and some may be optional (such as profile or interest components), depending on the business goals of the host or elections made by the user. Some module components may be required upfront, others as the user chooses to enhance or upgrade the experience. The host may also offer options based on a user's willingness to allow the collection of clickstream data on user as it relates to the platform. The modular system allows a host to keep certain components of the account module herein or move them to another module, such as utility or management, as user preferences dictate or business goals evolve.

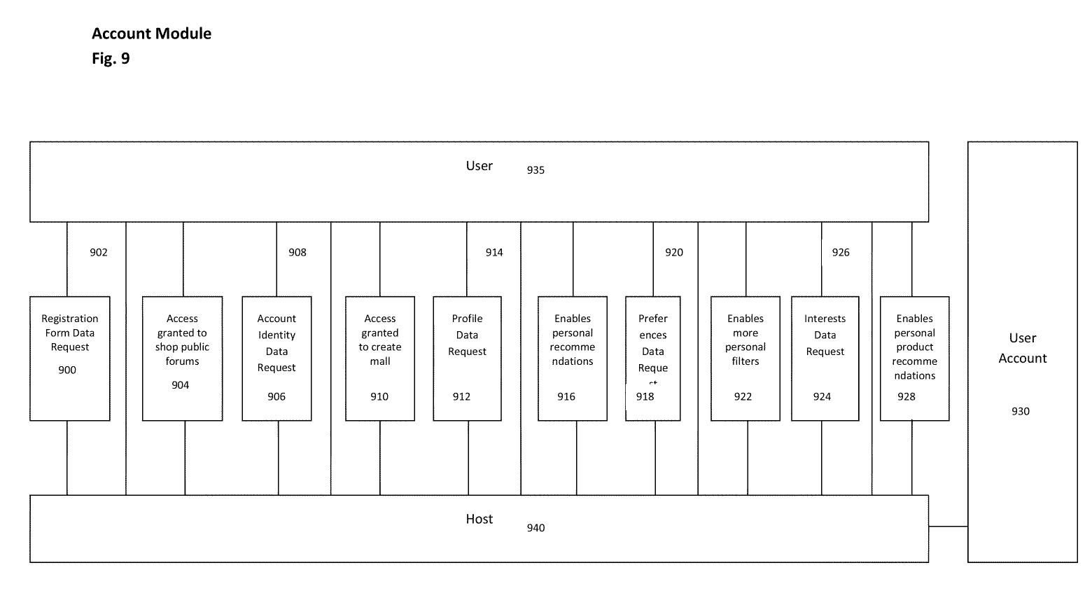

In one embodiment of the disclosed subject matter FIG. 9 is a block diagram illustrating representative modular components of a user account module. As a user seeks to use the website, a host may deliver to the user, through a simple modal window or other mechanism, a registration form 900 requiring information such as name and email address. The user may choose supply the requested data 902. Upon receiving the required data, the host may grant the user access to use the public portions of the site 904. The user who is registered but has not created an account may be restricted from certain modules, features or actions. In an embodiment of the disclosed subject matter, a user attempting to use restricted features would be invited to create a mall in order to access the relevant feature.

If the now registered user chooses to create an account, then the host will present the user an account identify module 906. The account identity module may present one or more options for creating an account. In one embodiment, the host may allow a user to create an account through a pre-existing social account, like Facebook. The user will grant the host access to data previously supplied and available through the selected social account. A host may also allow a user to create an account directly through the host.

A create account data request might include preferred mall name (with default to person's name supplied in the registration or prior step), address, email, birth year, free shipping account if any, preferred payment method and account number, preferred account type under the disclosed subject matter (with the host determining the type and degree of various levels from free to subscription services), privacy settings and other related data. A user may supply personal data as requested by the host 908. Upon receiving the data and verifying the account, the host may grant the user the option to create a buyer bespoke shopping network 910. A host may provide a user with various types of accounts, including a free account, a pay as you go account or a subscription service or custom account level that can be changed at any time. A user may also request sub-accounts for family members.

The user account module may be dynamic after the initial access is granted. For example, a host may prompt a user to fill in additional forms in order to enable or improve features and functions. For example, a host may provide the user with a profile data request 912, a user may supply the required data 914, and upon confirmation of receipt the host may enable a personal recommendations system, specials and coupons for vendors 916. Similarly, a host may request preferences data 918, and upon receipt 920 enable personal filters 922. In another example, a host may supply a form for interests 924, a user may fully or partially supply data 926 and the host may enable personal product recommendations 928 based on the user data supplied. The collective information and access granted to a particular user constitutes the User Account 930. A user account is personalized, and can be managed as more fully described herein.

A user may be incentivized to share information with friends, family or others who might be making purchasing decisions on the user's behalf.

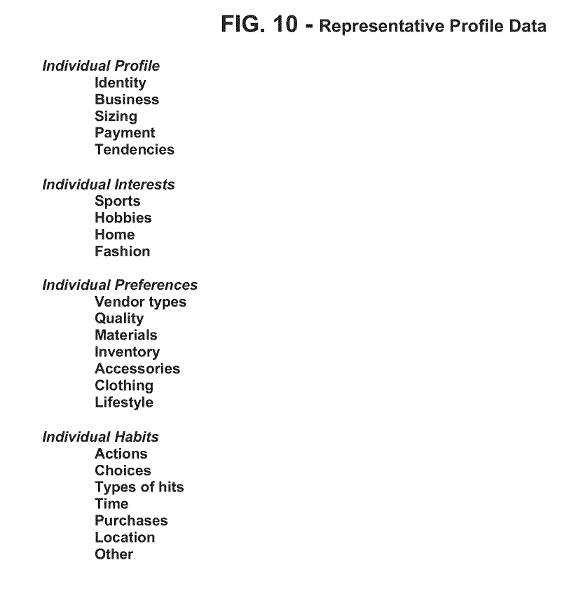

In one embodiment of the invention, the host may request a variety of information, including but not limited to identity, business profile, sizing information, payment methods, interests, preferences, and lifestyle, throughout the account creation module or any component thereof. FIG. 10 shows a list of representative profile data according to one embodiment of the disclosed subject matter. Data requests may be interactive, distinct or iterative. A distinct question can determine a single fact, like a preference for tailored clothing or the color black. Iterative questions might follow through a line of questioning based on prior answers. There might be pop up questions based on answers to certain items. For example, an interest in travel might be followed by a series of questions, such as seeking the type of travel. A host might choose to utilize GIS systems and data. For example, a user might be asked to click on a map of his favorite places to travel. Where appropriate, the user might have an option to see an explanation as to why the user should share the information, for example in the form of a Why do we need this? window.

The host for a buyer bespoke shopping network might mine data about individuals and vendors. Data mining results can be collected on an account-by-account basis. Data mining can be direct (user supplied) or indirect (clickstream) and as allowed and determined through privacy settings.

In one exemplary embodiment a host may collect individual profile data relating to identity (gender, birthday, address, shipping address, marital status, level of schooling, eye color, homeowner, renter, number of children, etc.), an individual's business or work (business, business address, international, national, regional, local, government, private sector, education, management, executive, CEO, business attire formal, business attire uniform, business attire rugged, business attire informal, military, student, homemaker, etc.), personal sizing or measurements (height, weight, dress size, pant size, shoe size, women, petite, tall, regular, misses, measurements, etc.), payment (credit card information, purchasing power, etc.), shopping tendencies (primary purchaser, brand conscious, national vendors, local vendors, popular, innovative, unique, loyal to brand, comparison shopper, etc.) and other profile data.

In one exemplary embodiment a host might also collect data regarding the buyer's interests. Interests might include sports (golf, tennis, hunting, baseball, football, soccer, cricket, volleyball, water polo, lawn bowling, scuba diving, sailing, canoeing, kayaking, snorkeling, skiing, snow boarding, badminton, racing, water skiing, horseback riding, archery, rock climbing, sky diving, mountaineering, hiking, running, track and field, lacrosse, field hockey, ice hockey, rugby, and others.), hobbies (stamps, coins, rare books, maps, crafts, needlepoint, sewing, pottery, jewelry making, auto, AV, gaming, collectibles, and others.), home goods and furnishings (furniture, soft goods, kitchen, bath, yard, garden, improvement, renovation, bedroom, living room, family room, den, basement, garage, attic, carpet, window treatments, wall hangings, children's room, nursery, guest cottage, pool, playground, closet organizer, shelving, bedding, and others), fashion (ladies, men, children, traditional, tailored, funky, edgy, rap, business, executive, teen, pre-teen, youth, infant, accessories, hats, belts, socks, shoes, and others) among other interests.

In another exemplary embodiment a host might also collect data regarding individual or group preferences including but not limited to industry (auto, fashion, education, food, real estate, construction, commercial, finance and others), types of vendors (discount, luxury, department, warehouse, club, supplier, to the trade, category-killer, specialty, boutique, national, local, and others), quality (luxury, quality, value, discount, consumer reports rated, one-star, two-star, three-star, four-star, five-star, executive, and others), materials (steel, copper, fiber optic, pine, plastic, cotton, non-iron, linen, wool, Egyptian cotton, cashmere, fine-gauge, twill, jean, chino, durable, wash and wear, dry cleaning, flannel, and others), inventory (bulk, unique, new, innovative, specialized, engineered, branded, generic, and others), accessories (shoes, scarves, ties, belts, jewelry, cosmetics, perfume, purses, pins, hats, and others), clothing (female, male, children, dresses, skirts, trousers, dress shirts, lady suits, men suits, nightgowns, pajamas, jeans, sweaters, sweater vests, turtlenecks, long underwear, and other categories), lifestyle (organic, low-carbon impact, executive, mother, single mother, divorced, leisure, retired, active, nutritious, hearty, outdoorsman, sporty, luxury, first-class, quality, student, tailored, trendy, groomed, high fashion, and others) among other preferences.

In addition to the aforementioned data, a host might also collect data regarding buyer habits, including but not limited to actions (hits, frequency, duration, purchases, browse no buy, browse and buy, browse duration for each, vendors browsed, frequency of browsing at particular vendors, any point of feedback, and others), choices (vendor selection, vendor rejection, ranking of vendors, reinstated vendors, upgraded vendors, downgraded vendors, searched vendors, guests, tool choice, node choice, comments, number of vendors, vendor category, and others), types of hits (ads, bulletin boards, vendors, news, tools, and others), time (time of day, week, frequency, peaks, duration of visits, and others), purchases (annual spent, peak spending, habitual spending, frequency of spending, and others), location (such as where an individual is when she shops, where she is in relation to her favorites, and other geo location data).

In one exemplary embodiment a host might collect an additional variety of data and such data collection may grow and change over time. Other data might include guests or friends, number of accounts, change of primary data, searches, use of tools by tool, and any other shopping related or site specific data.

A teen corner, senior center, chamber of commerce or other group might have questions directed at the target audience. There might be word banks, games, video, polling, fill in the blanks or a number of other means for acquiring or discerning information. Questions might discern how brand conscious they are, whether they are physically active, influenced by celebrities, etc. There might be surprise questions encouraging repeat reviews. How fickle are they? Are certain names cropping up more frequently in the open questions?

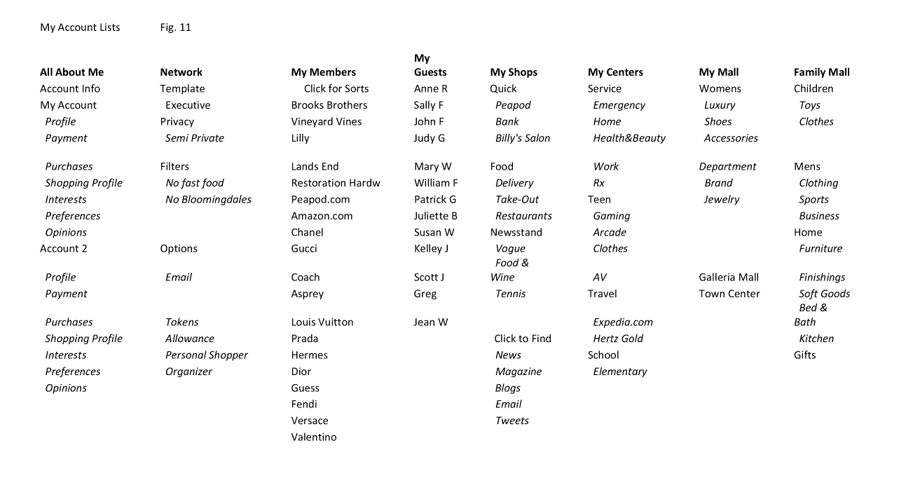

The host may present account information and make it available to the user for updating or changing at any time. FIG. 11 depicts one version of such an embodiment. In the represented instance, a host may provide a word bank of options to choose or select if they apply. One might also change the view to show all choices or only selected choices.

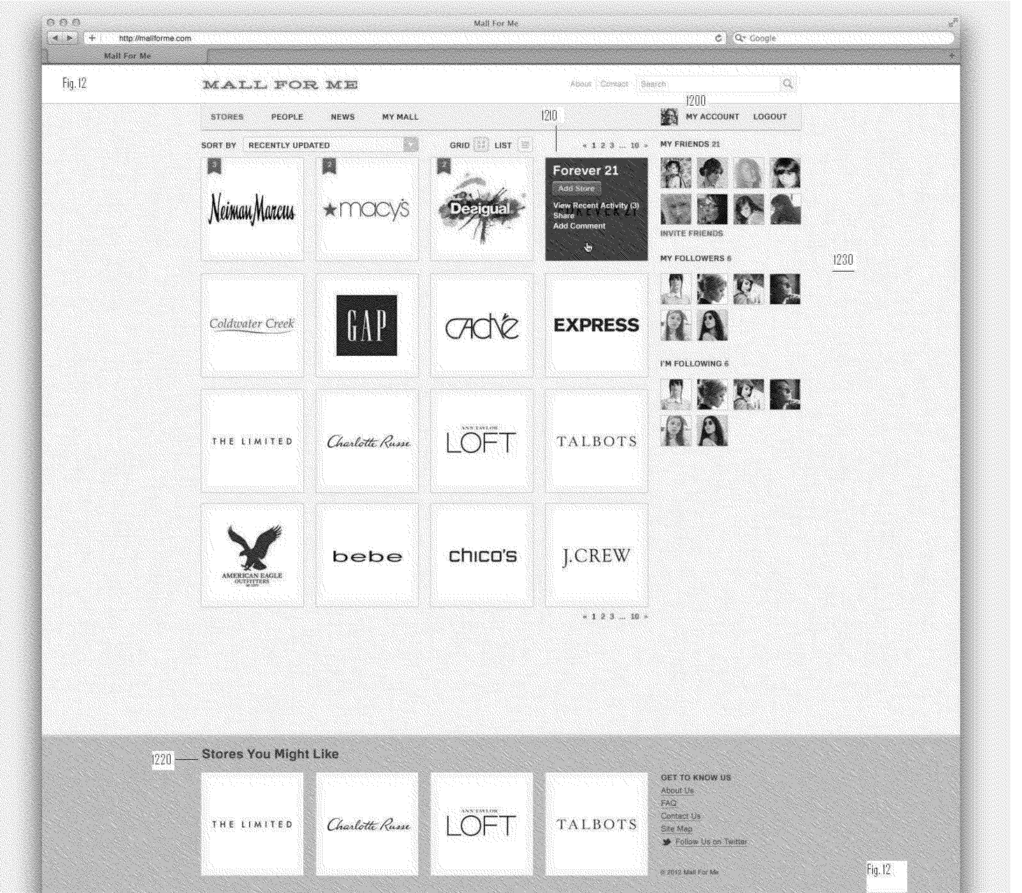

After a user has created an account through the account module, and the user is logged on, the user will have access to more modules and functionalities. For example, a logged on user may access the vendor selection module, communication module and social module. As shown in FIG. 12, a logged on user 1200 can now access options 1210 to add the store, view recent activity, share or add a comment. The account holder also has access to personalized stores you might like 1220 and bespoke social connections 1230, such as those imported upon creating an account through a social network.

### Blueprint Module

Once a user account is created, the host may provide a user with various options for designing a bespoke buyer shopping network through a blueprint module. In one embodiment, a user makes various selections from components within the module, including but not limited to templates, markets, style and other elections, and then the host executes the user elections. In each instance, the template accommodates multiple functions and markets. Each component within the module may operate independently from the other. A host may offer one or more formats and one or more markets per user. The number of component parts and options available to the user are dependent upon the business goals of the host. Not all options need be offered as determined by business decisions. In each case, a host may limit options until such time the business can support more options. Certain components may have default modes; some may allow selection only for those paying an additional fee. A host may allow the user to make changes at any time. Selections might be made in a sequential order or as needed. The user's choices may be implemented as they are selected. The options each user has may be affected by a prior choice. Whether completed step by step or in the aggregate, as preferred by those skilled in the art, the host platform would implement the user's choices to create a template, format and organization for the bespoke mall or hub. The user choices will be noted for implementation purposes and the feedback from the user to the host may be used for execution as well as for business research, development and related services. The key construct is a system and method that enables the user to select certain formats, views or organization related to the user's available services, needs and shopping preferences.

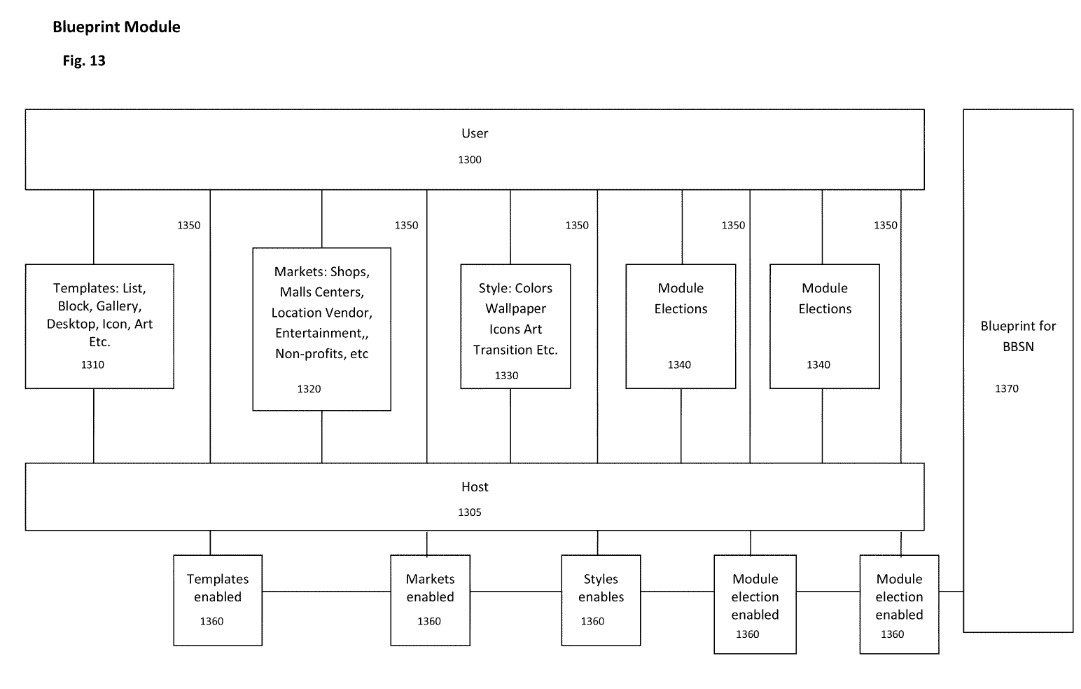

FIG. 13 is a flow chart of an exemplary blueprint module illustrating a series of component parts and an iterative process of presentation, review, selection and execution. In this exemplary model, a host 1305 offers a user 1300 template components 1310, market components 1320, style components 1330 and other elective components 1340. The user will make elections 1350 for preferred options, formats, features, styles etc. within each component. The host will then execute 1360 as directed by the user. The aggregate execution of such user elections will generate a blueprint for the buyer bespoke shopping network 1370. The presentation, selection, feedback and execution loop continues in a similar fashion for each component, in an iterative fashion. In this embodiment, the host presents the user with market options, including shops, entertainment centers, non-profits, physical malls, location organization and others. Through the style component, the host provides creative or stylistic options for various types of wallpaper, icons, art and animated transitions. Ranking options might include different languages, symbols, icons or systems in accordance with the user's preferred style or as best viewed on the user's device. Hosts may use proprietary models or other models as commonly used by those skilled in the art. In this embodiment, the host contemplates offering future components or choices to the user as business allows.

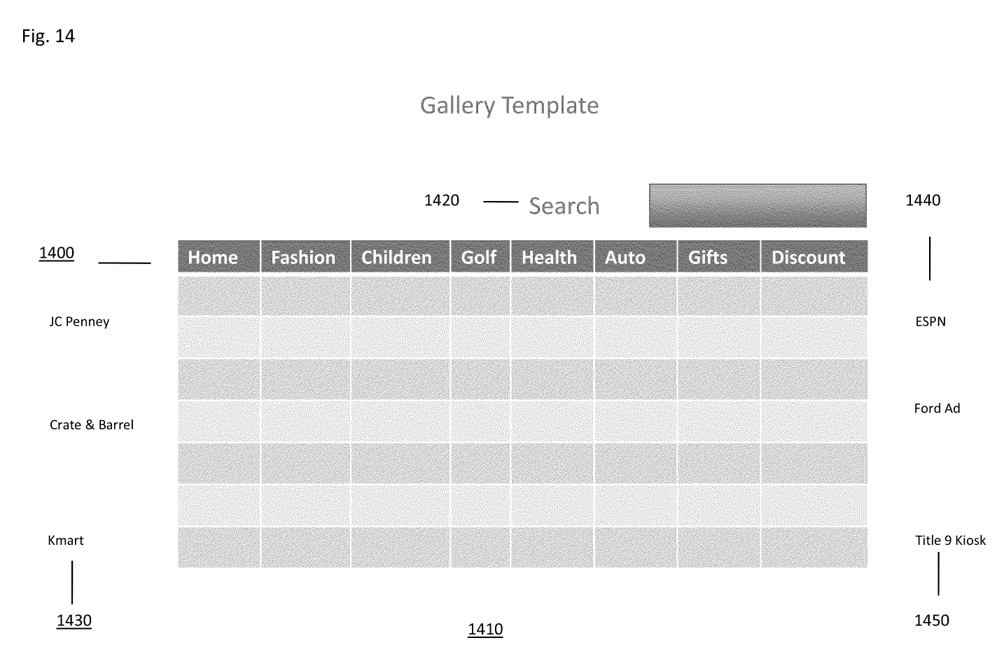

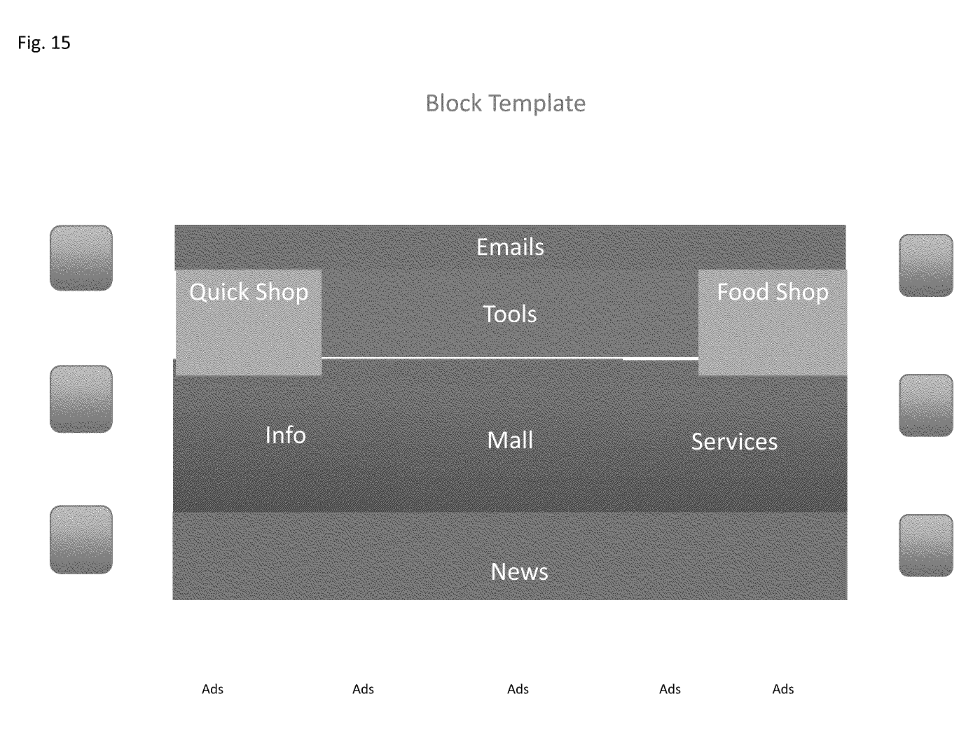

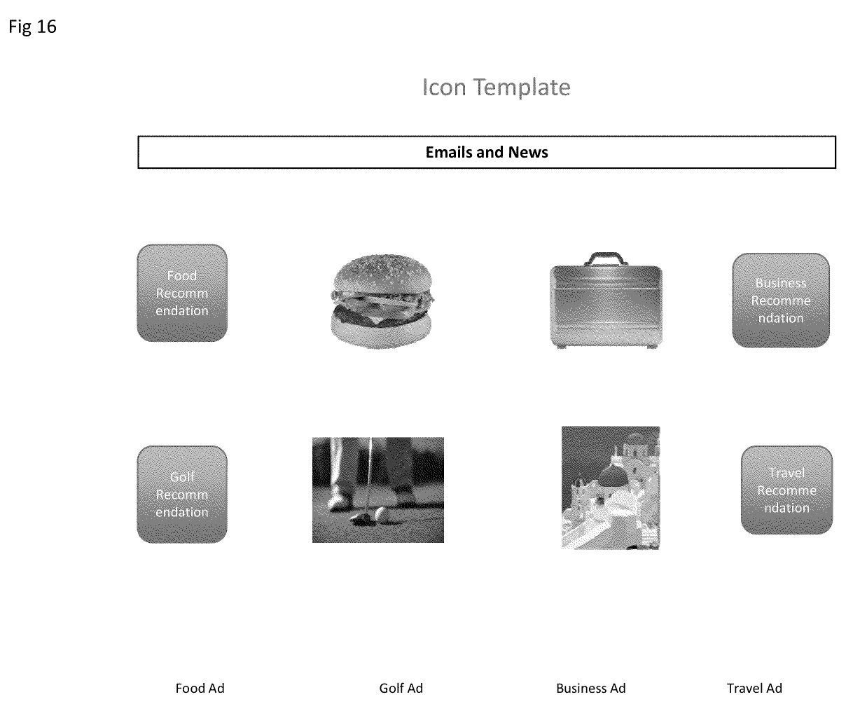

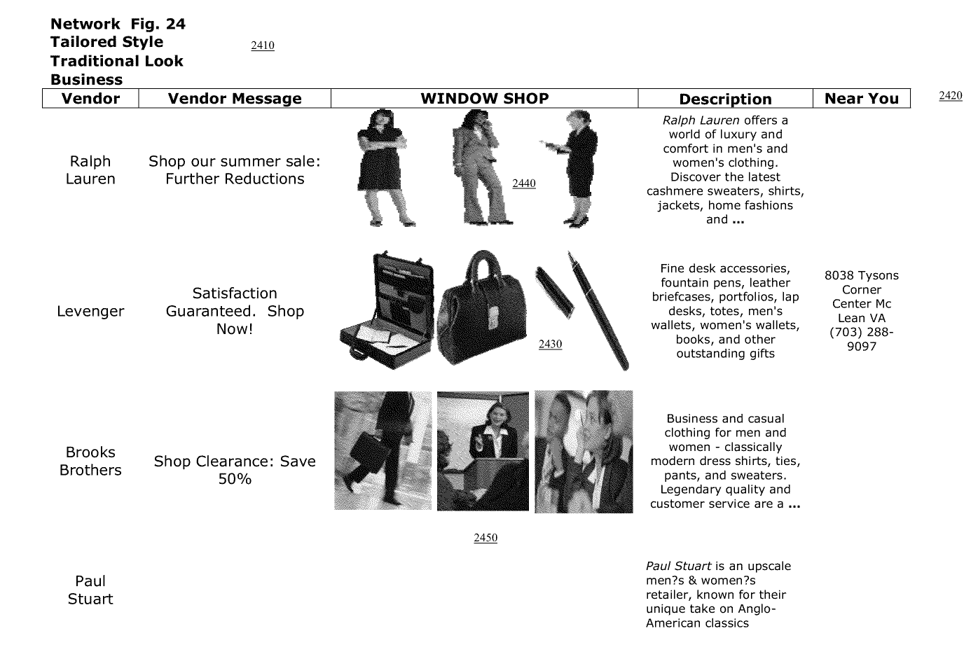

As a matter of convenience, templates may have pre-packaged formats, with limited options. A user might toggle through various markets on her BBSN. By way of example for template options, FIG. 14 illustrates an exemplary screen shot of a gallery template organization. The figure shows markets 1400 at the top of each column and open cells 1410 for filling in vendors, merchants, brands, products, services, videos or other related field, link or content. All choices could be set to a default mode, enabling the user to move directly to vendor selection. Vendor selection could be made through a search function 1420, add function, recommendations, or other means as more fully described herein. In exemplary embodiments of the disclosed subject matter host recommendations for new vendors 1430 are coordinated with the user markets, and any advertisements or links to content 1440 may or may not relate specifically to each user market. In some cases, space may be used to suggest other vendors or to exhibit kiosks for new vendors, products or services 1450. FIG. 15 depicts a simplified version of a screen shot of an exemplary model of a block template, and FIG. 16 depicts a simplified screen shot of a mall using an icon template. FIG. 24 depicts a simplified representation of an alternative vendor view, showcasing a list view organization, filtered data 2410, selected information columns 2420, and products 2430 or other visual 2440, audio or video elements 2450. It is noted that actual details and functions are not shown in these figures, but are understood to those skilled in the art and may vary in accordance with business decisions. A wheel template may allow a user to scroll through markets quickly on an iPod, while also providing a template for a tablet format. A physical mall template may give the look and feel of a mall.

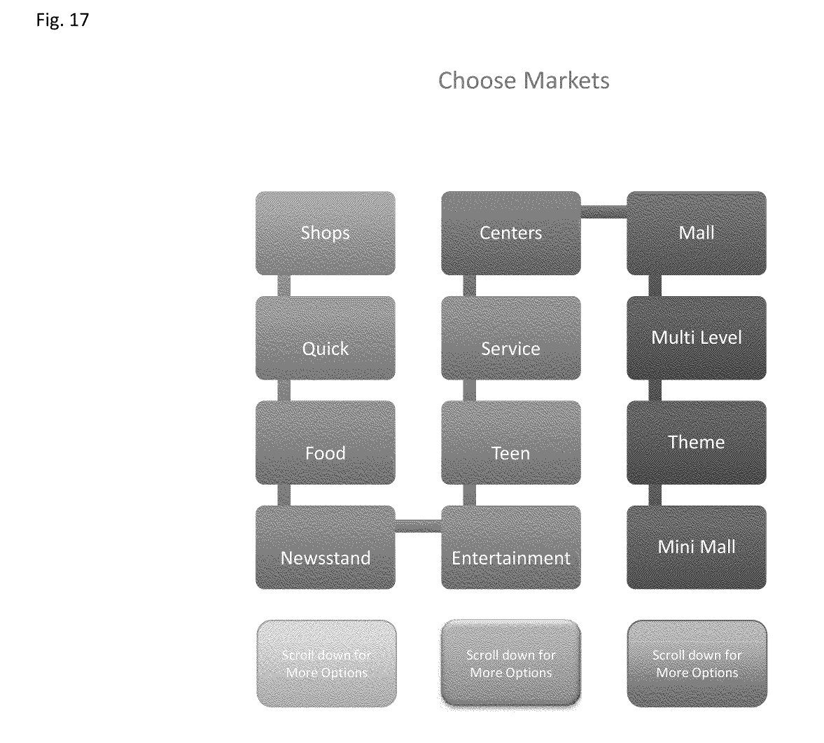

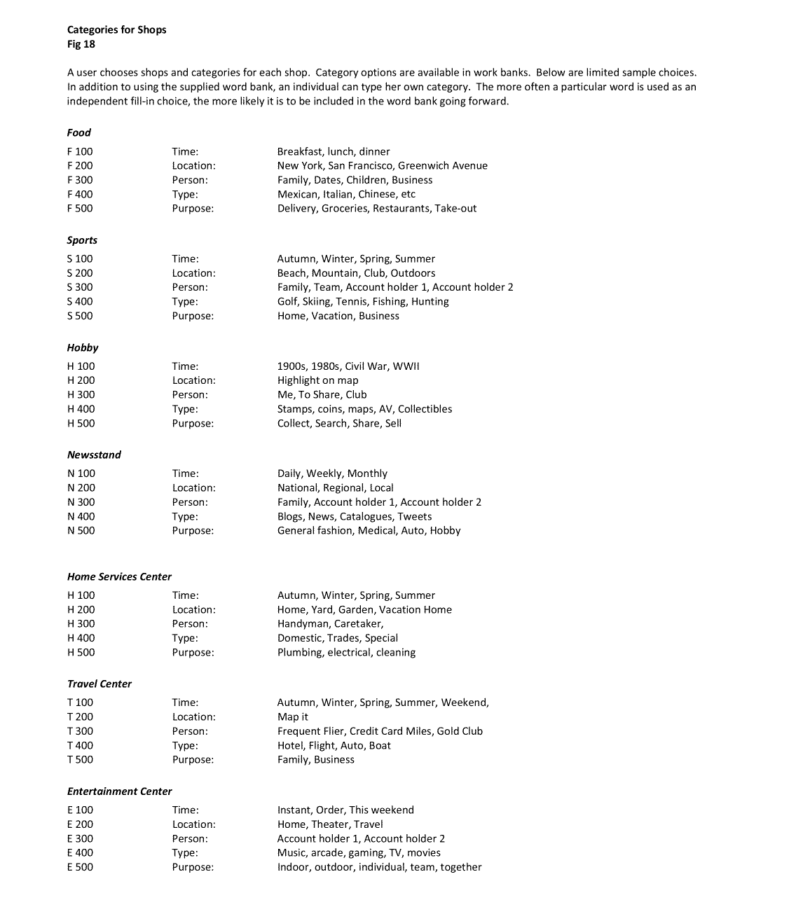

In another component of the blueprint module, a user may have one or markets and one or more submarkets or a market system 656. The number of markets is limited by the host and expanded under certain conditions, such as a user account upgrade. For example, a mall might have sub-markets such as fashion, home, guest, children and sports. By way of example, FIG. 17 depicts a simplified screen shot of organizational or market options in one embodiment of the disclosed subject matter. Organization options might be by use or type, market or sub-market. A user may elect to create convenience store formats for quick access on a user's BBSN homepage or other specialty markets, such as shops, quick shops, food shops, newsstand, service centers, teen center, entertainment, travel, health and beauty, mini-mall and others. Options might be either restricted to a word bank or open to customization. Convenience stores might have the three or more stores the user uses most. The choice of vendors is up to the user creating it. The user might also choose to include a link to subscriptions to related magazine or a notes page of items to consider. FIG. 18 presents a limited scope representation of one exemplary organization methodology a host may employ for presenting users with market strategies. The codes indicate an alpha representation for the market type and a numeric code for the category, with systems designed to facilitate organization.

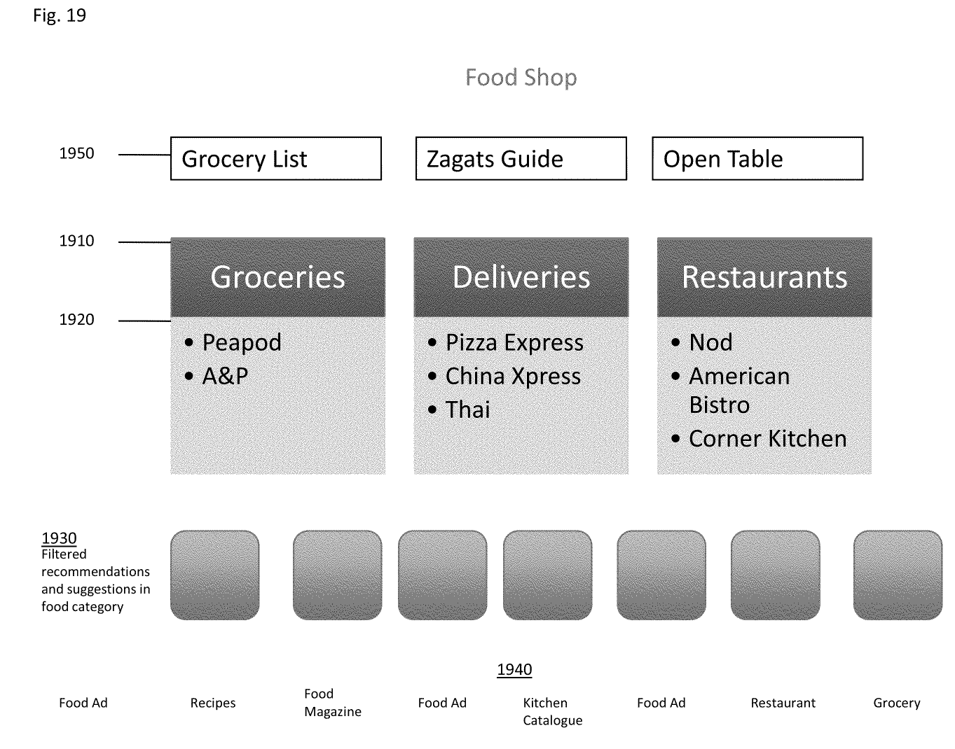

A host might also offer proxies for convenience stores, quick shops, service centers, physical malls, outlet malls, shopping networks, fashion centers, specialized categories, food courts, and entertainment centers. Markets may be defined and implemented as a simple data entry to identify the chosen market label and then a search or sort function in database software (such as Access or similar program). By way of an exemplary model, and without limitation, a user might create a Food Shop. FIG. 19 depicts a simplified screen shot of a food shop designed with three markets 1910 for quick and easy access to frequently used food vendors 1920 along with filtered recommendations 1930, advertisements, recipes, magazines, catalogues, restaurant and grocery links 1940, list functions and other useful related links, such as reviews and reservation services 1950. A user might choose the markets from a drop down menu or a word bank and then select the vendors. As an integral part of choosing her vendors a user might also choose among display options and functions, such as lists and links to other useful resources.

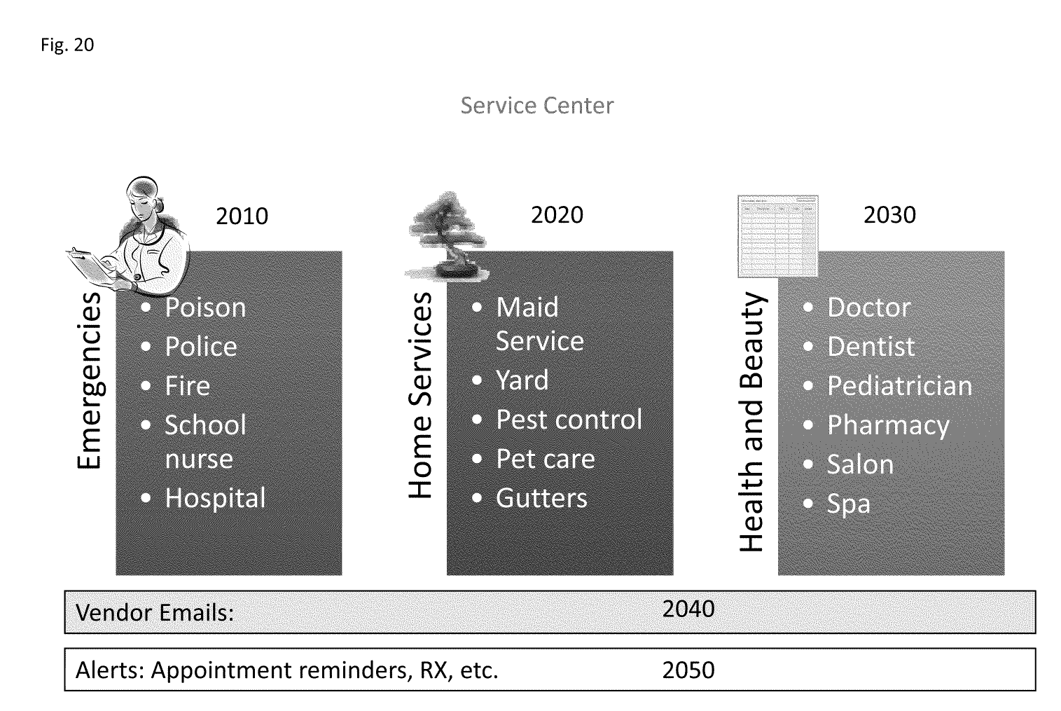

FIG. 20 depicts a simplified screen shot of a service center, organized by the user in this exemplary embodiment by emergency information 2010, home services 2020 and health and beauty 2030. The user may grant babysitters access to the emergency and home services sections while also obtaining personal access while away from home. Links could include contact information, allergy alerts, medicines, directions and other pertinent information. Depending on the business goals of the host or the selection of the user, a service center might also present related emails or messages 2040 and appointment reminders 2050. Applicable videos or tools might also be available. In another example, a home center might have a database of links to the services a user uses to care for her home, such as cleaning, yard care, snow removal, tree service, pool service or handyman.

In one exemplary embodiment, teen centers can house a number of elements in a single location designed for teenagers. From a public teen center on a host platform, a user might make a bespoke selection therefrom that the user finds appropriate for family members. Teen centers might feature a teenager user's favorite online pages, such as teen celebrity news, teen questionnaires to share with friends, teen games, teen advertisements, teen fashion advice, teen sports equipment, etc. A BBSN might have games and links to favorite gaming places. Parents can monitor children through an allowance, account tracking and tokens. Teens might create their own center to share with friends.

In an entertainment center, users can play and test games in the same space that they buy new games. Arcades and entertainment centers can feature outlets to popular games, whether free, purchased or subscribed. The format and access evolve with the fast-changing gaming industry. Preferred options might include partnerships or affiliations with gaming companies. Associations might choose to post or make available games that promote their industry and vendors may choose a similar strategy to promote their brand or products or services.

Travel Centers might be a hub of travel information and purchasing opportunities. A user might include travel service sites, such as Expedia, as well as her frequent flier mileage rewards page. A user might also want to include a link to her online subscription to Travel and Leisure or a contact card for her travel concierge. She might also want to organize her travel center by country or vacation. She might keep notes on what she would like to do while traveling as well as track what she did and where she ate. A user might also include a link to a photo shop where she can download and purchase photographs.

### Vendor Selection Module

A user who has created an account can choose to add vendors to his or her BBSN. The user's aggregation of vendors is like a personal address book of digital real estate and contact information. It utilizes multiple resources and narrows the field of points of contact from unlimited to a relevant subset. The system for implementing such choice may vary according to the user preferences and the various systems or options provided by the host. The aggregation of user selections for vendors and social connections is a bespoke network 648.

In a simplified version of the embodiment, a user selects a vendor, and the host creates a hyperlink from the user to the vendor. A user may add the selected vendor to the BBSN through drag and drop, action buttons or other common features used by those skilled in the art. Such step can be repeated as many times as the user so chooses within the constraints of the platform or account level A user may also choose to subsequently delete one or more such choices at any time. A host may also choose to embed the vendor website in accordance with terms and conditions of the vendor agreement.

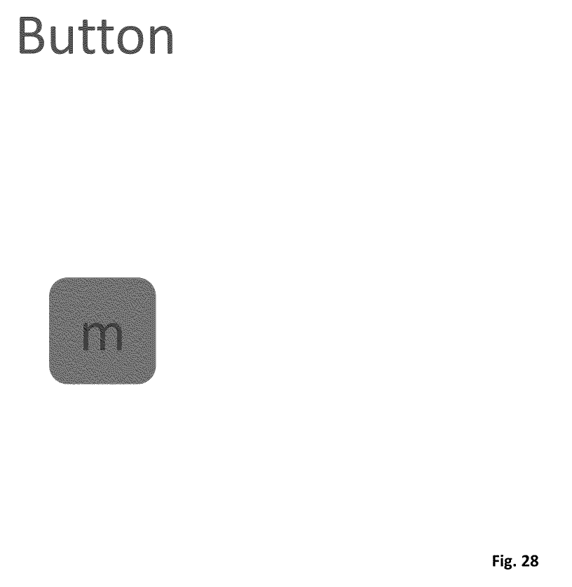

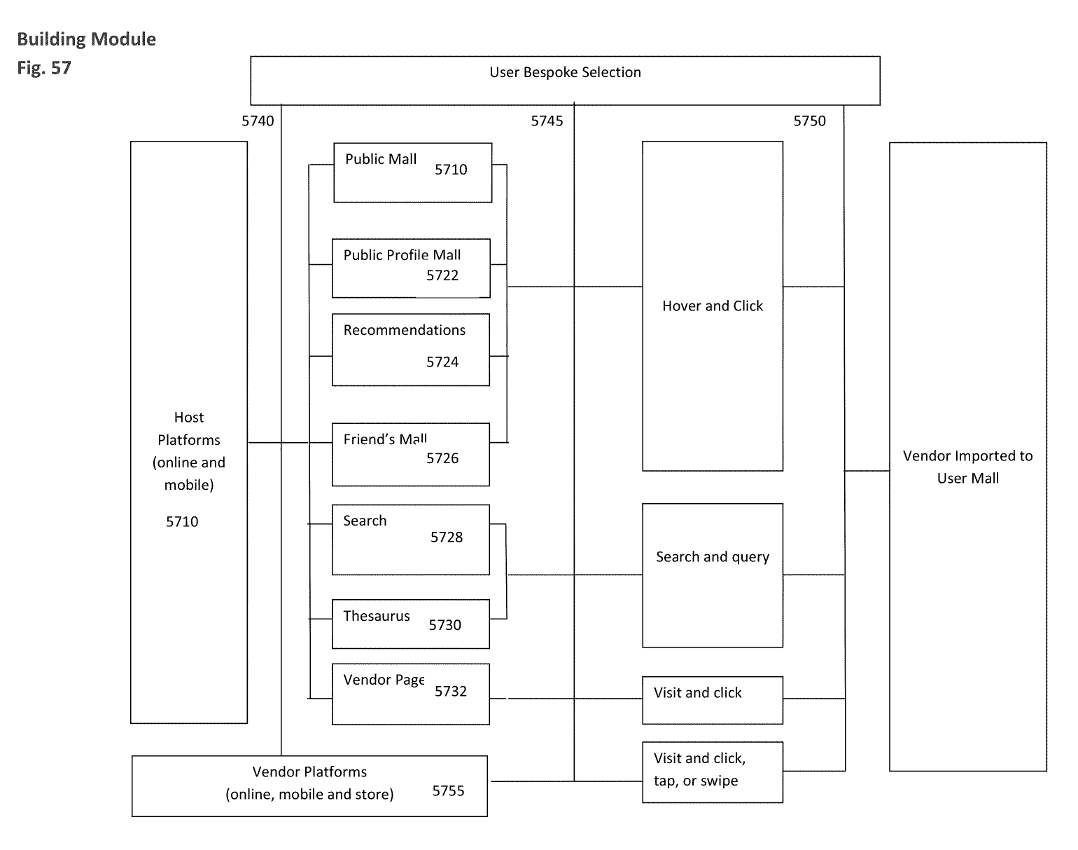

A host will provide one or more components for adding vendors. FIG. 57 is a block diagram illustrating a host platform 5710 that provides multiple options for accessing vendors for inclusion in a BBSN, including but not limited to public malls 5720, public profile malls 5722, recommendations 5724, friend's malls 5726, search 5728, thesaurus 5730 and a vendor page 5732. A user may choose to browse one or more options from the components presented 5740. Within each component, a user can exercise bespoke selection from among the vendors 5745. Depending on the platform, component and the user device, the user will conduct the appropriate action 5750 as determined by those skilled in the art, including but not limited to hover and click or double tap, and search and query. A host may also present a component that allows vendors to present options 5755 for a user to add them to the user's mall, including a host BBSN button, as noted in FIG. 28, or similar feature that allows a user to add a vendor while within the vendor website, utilizing the vendor mobile application or visiting the store.

A host platform mobile application provides for a host app button that drills down to market and vendor apps. Search includes internet search engines, app stores, and geo-location. Within a store a QR code or similar identifying code enables a user to add a vendor directly to her mall while in the store. Similarly, a user can feed a product QR code, product information or image to her BBSN product, image or wish list utilities, as directed and applicable.

A primary means of adding vendors may be through vendor databases the host makes available to the public, registered users or account holders. Databases may have sort, search, view and query options. The host may also provide public malls or persona malls. A user may visit one of these or a third party mall. In each instance, a user can use an add store function to import one or more vendors to her mall.

A search component might allow a user to search for vendors within the host database or through a search engine, such as Google. In one example, the host may have a database query function in which a user could search her mall either by certain variables, qualities or features, such as product category, location, target audience or a combination of variables. In one example, a host might provide a query of its database by zip code, area code, current location, city, name, place or similar search. More sophisticated mapping systems, map me options, GIS on mobile devices, radius searches and other common location searches might also be employed by those skilled in the art or by partnering with entities that provide such services.

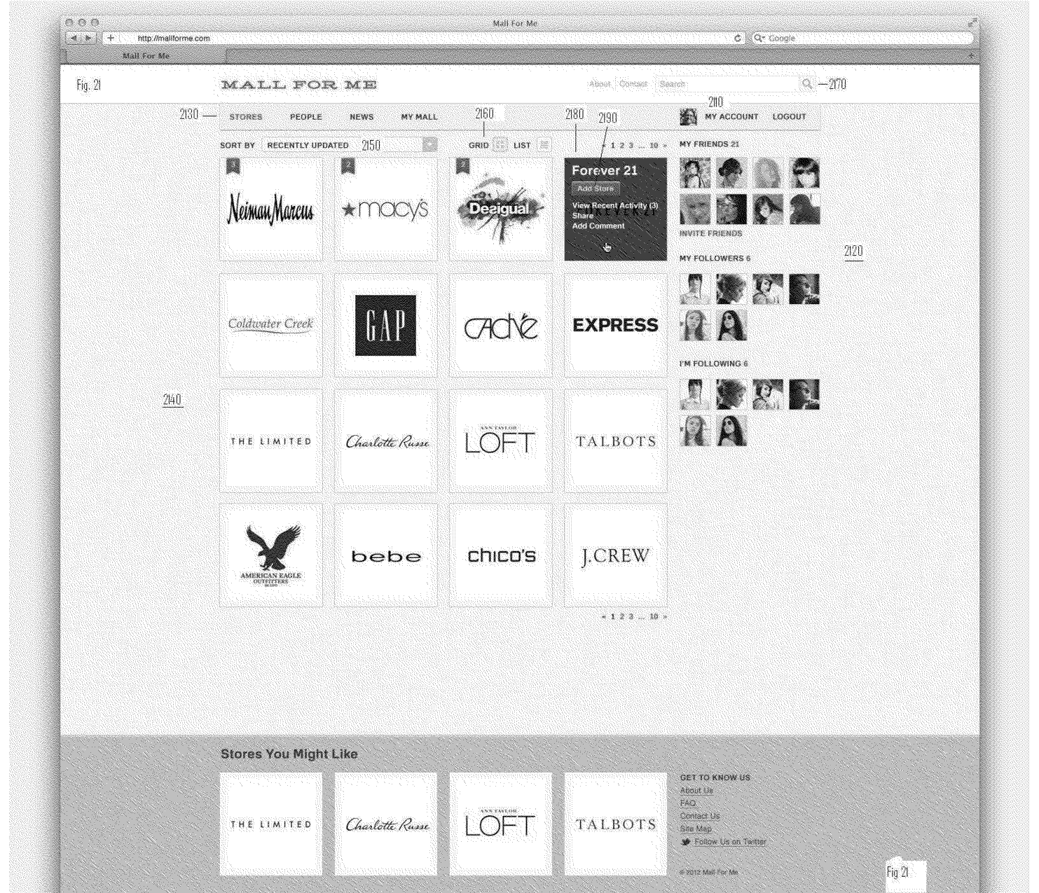

In one embodiment of the disclosed subject matter, FIG. 21 depicts a user who has logged on 2110, personal account links to selected people 2120, a view of a public market 2130 views and links to stores and brands 2140, sorted by recently updated 2150, displayed in a grid format 2160 and housing typical headers and footers, including a search function 2170. In this exemplary embodiment, a logged on user can add a vendor to their bespoke shopping market simply by clicking on the action button “Add Store” 2190.

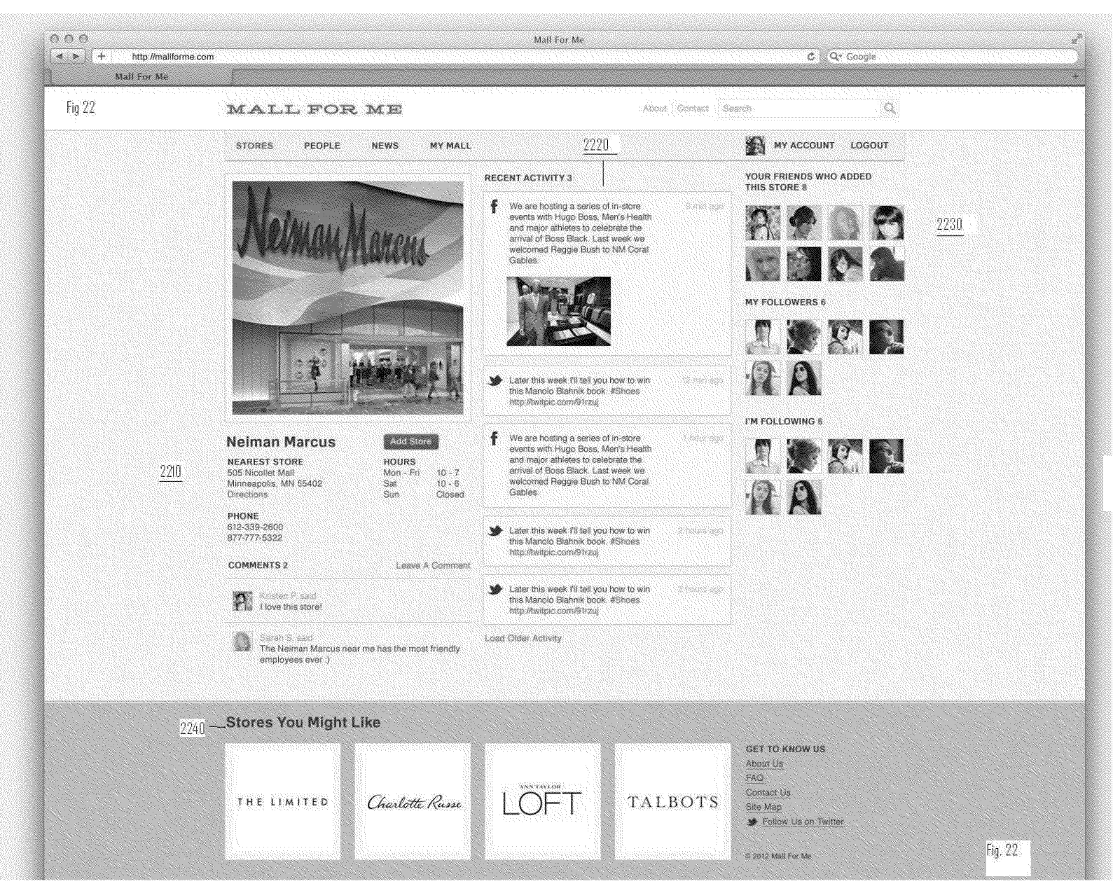

As an alternative approach, the user can choose a list view to see additional details about the store or visit the vendor website prior to adding the store. FIG. 22 depicts a screen shot of one embodiment of a vendor list view. Information on a vendor page might include vendor location, hours, contact information 2210, recent public social media messages 2220, description, others who have added the vendor to their mall 2230, similar vendors 2240 and other data as determined of interest or utility in making a selection or learning about the vendor and its current activities, sales, events, services or products.

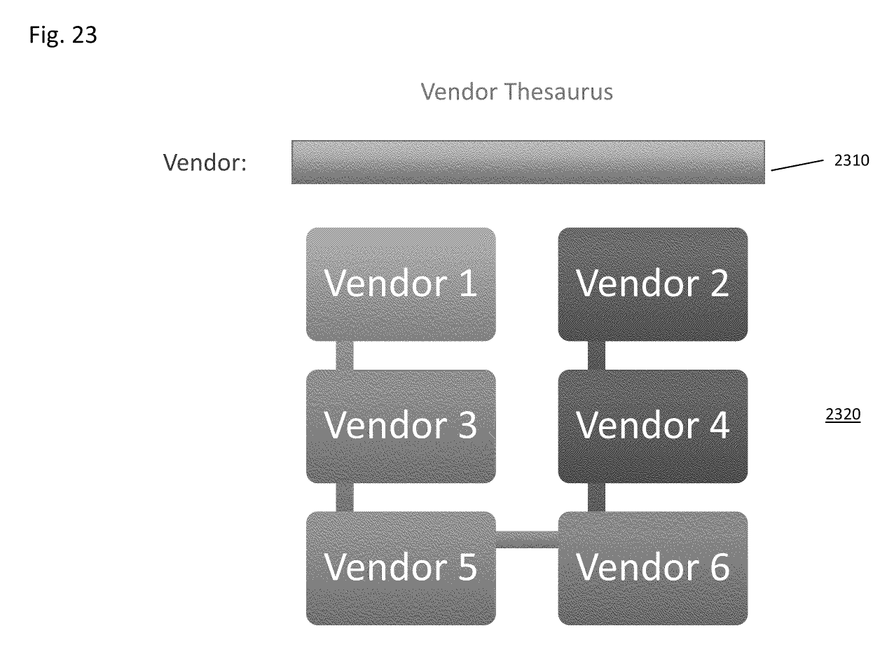

In another component, the host might provide a vendor thesaurus. In one embodiment of the disclosed subject matter, FIG. 23 depicts a simplified screenshot of an exemplary thesaurus. A user might identify one particular vendor or category 2310 and use the thesaurus to find similar vendors 2320.

Through another component, a host recommends vendors or automatically backfills vendors based on data about the user and exercising a database query searching for matches and ranking returns by sort requests as commonly done by those skilled in the art of software databases. Cells within the viewed screen are populated in order with more available upon request. The host may utilize the profile data from other modules, such as account module, market selection module or other user data package in order to make vendor recommendations. A user may choose to accept all recommendations or selectively choose among the host recommendations. For example, a host may provide a quick fill module, including but not limited to a profile quick fill module, a market quick fill module or other lifestyle quick fill options. The quick fill modules provide the user with numerous recommendations to quickly fill or add vendors to a bespoke shopping network. In each case, the host makes recommendations based on user input and executes the user requests. Quick fill options may or may not be used in conjunction with other methods of creating, changing or maintaining a bespoke shopping network.

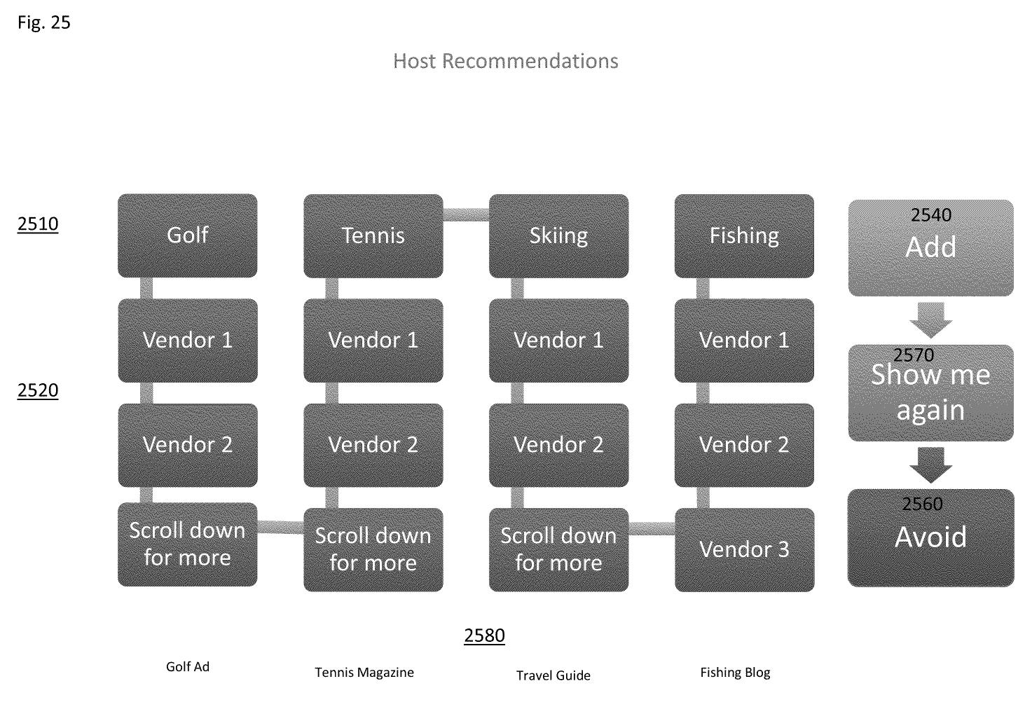

A host may also offer a recommendations component for adding vendors to a BBSN based on data about the user. FIG. 25 depicts a simplified screen shot of host recommendations based on category filters, according to some embodiments. In an embodiment of an inclusive example, a user may select various sports 2510. Once selected, the host provides relevant choices 2520, sorted by filter or unsorted, as determined by business decisions and as commonly displayed by those skilled in the art. The user might add 2540 such recommended vendors, retain data for future reference 2570 or avoid the vendor 2560. The host may present advertisements or related links alongside the recommendations 2580. The host may allow the user to answer additional questions to better focus the recommendations. It is noted that actual details, such as example emails, news lines or vendors are not shown in this figure, but are understood to those skilled in the art and may vary in accordance with business decisions.

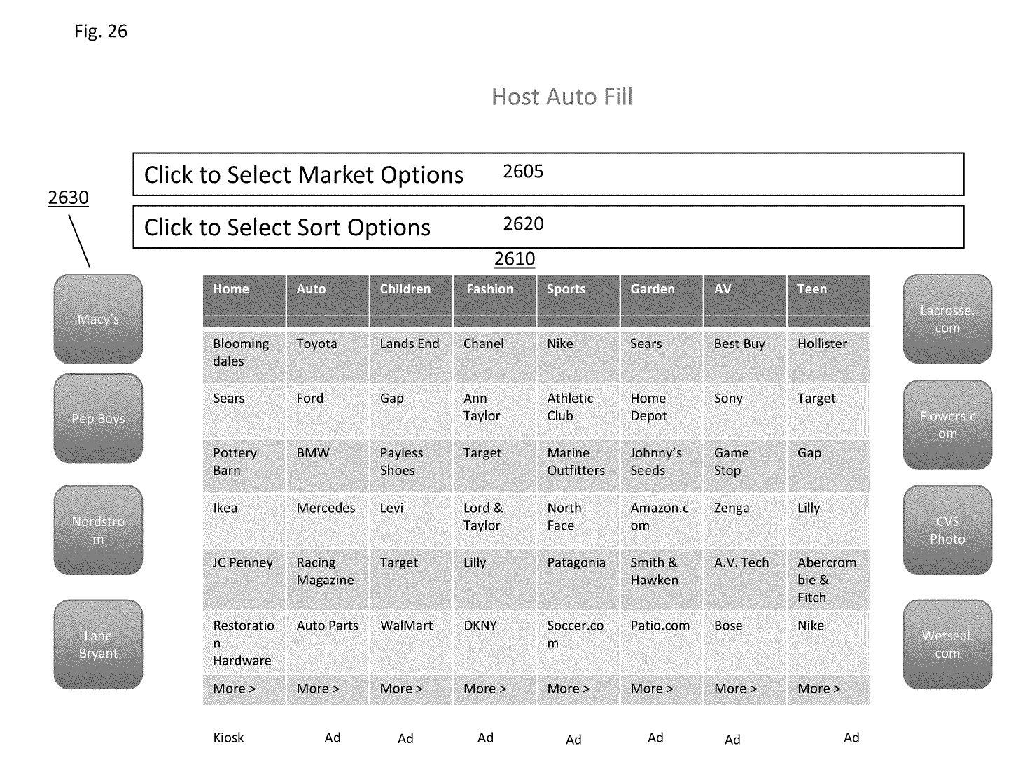

A user may elect an auto fill component for adding vendors to a BBSN. FIG. 26 depicts a simplified screen shot of host auto fill. In this exemplary model of the market quick fill option, the user has selected eight desired markets 2610 through the market creation module and most popular sort 2620. The host has filled in the markets with list of vendors. Those skilled in the art would simply query the host database for the selected fields and backfill the data based on tag, categories, location, most popular or other filter into the user mall with the most popular vendors for each category and present related links for vendors, products or catalogues 2630.

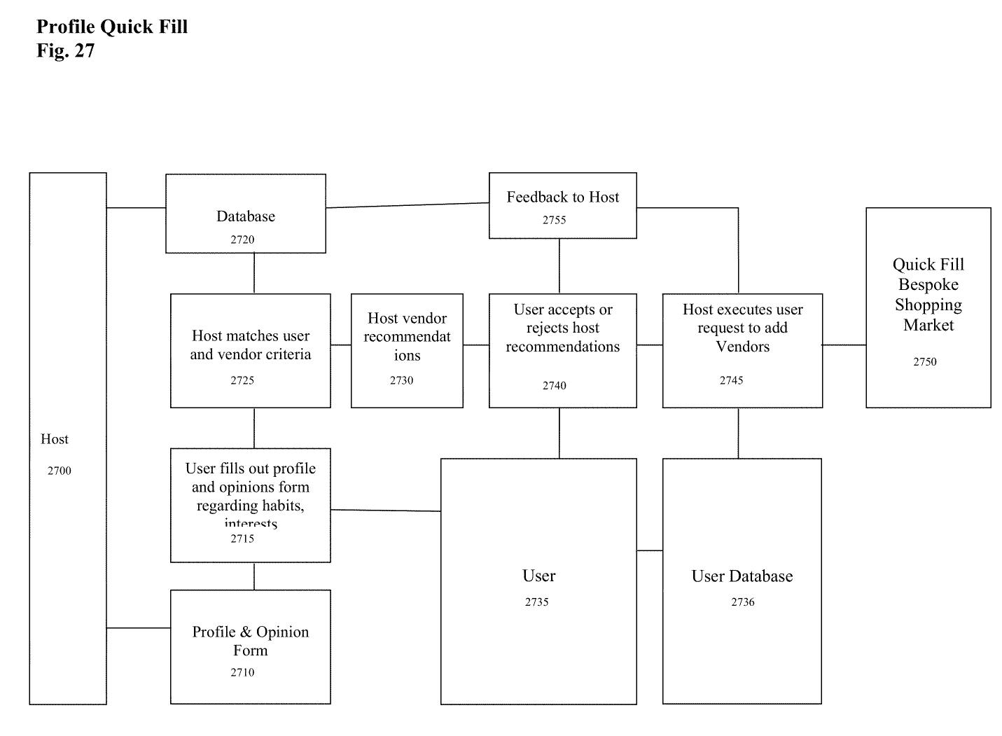

In one exemplary model of a profile fill process, FIG. 27 identifies a simplified flow chart identifying a host 2700 and profile form 2710 that a user 2715 fills out. The host refers to its database of vendors and their accompanying tags 2720 and matches the tags with the user profile data 2725. Matches may or may not be filtered and then any filtered matches are recommended to the user 2730. The user 2735 either accepts or rejects 2740 the recommendations. Upon the user's acceptance of the recommendation, the host executes the request 2745 and adds the acceptable vendors to the buyer bespoke shopping network 2750. User elections are recorded in a feedback loop to the host database 2755. A user may also select vendors through alternative components. By way of example, the request and the format of the request might differ in accordance with the business goals of the host and as creatively organized and presented by those skilled in the art. Data requests might be factual and may be subject to change or amendment at any time. Data requests may be dynamic, such that the answer to a prior question may limit or expand succeeding questions. The scope might vary depending on level of service or service requests, and accordingly might be best presented in aggregate as part of a user account or profile or as they may arise in accordance with user selections. For example, and without limitation, a user may be asked for credit card information initially, as part of a subscription service, whenever that request may occur or service may be provided.

The host may communicate with systems outside the host platform in order to facilitate the addition of vendors to a bespoke shopping network. A BBSN host may allow vendors to showcase a BBSN host symbol on their website, mobile application or other online or mobile utilities. In one embodiment, a vendor may include a button on their website or mobile screen so that a user can click on the button in order to add the vendor to her mall remotely. Alternatively, a user may use a mobile device to add a vendor to her mall with a QR Code or similar system while shopping at a store. A user might click, drag and drop, pin or otherwise add a vendor through the vendor website, mobile application, advertisement or other vendor-sponsored link. FIG. 28 depicts one embodiment of a simplified example of a button that might be displayed on a vendor website or at a store counter. By clicking on or selecting the button on a website or by waving a mobile device in front of the button and related wireless system, a user might be able to add the vendor to her personal bespoke mall.

A user might add vendors or amend vendors and products through her mobile or other digital device. In one embodiment, a user can swipe her mobile device in front of a scanner to add the vendor to her mall. Alternatively, a user might enable her credit card to add a store or products to her mall each time she uses her credit card.

### Social Module

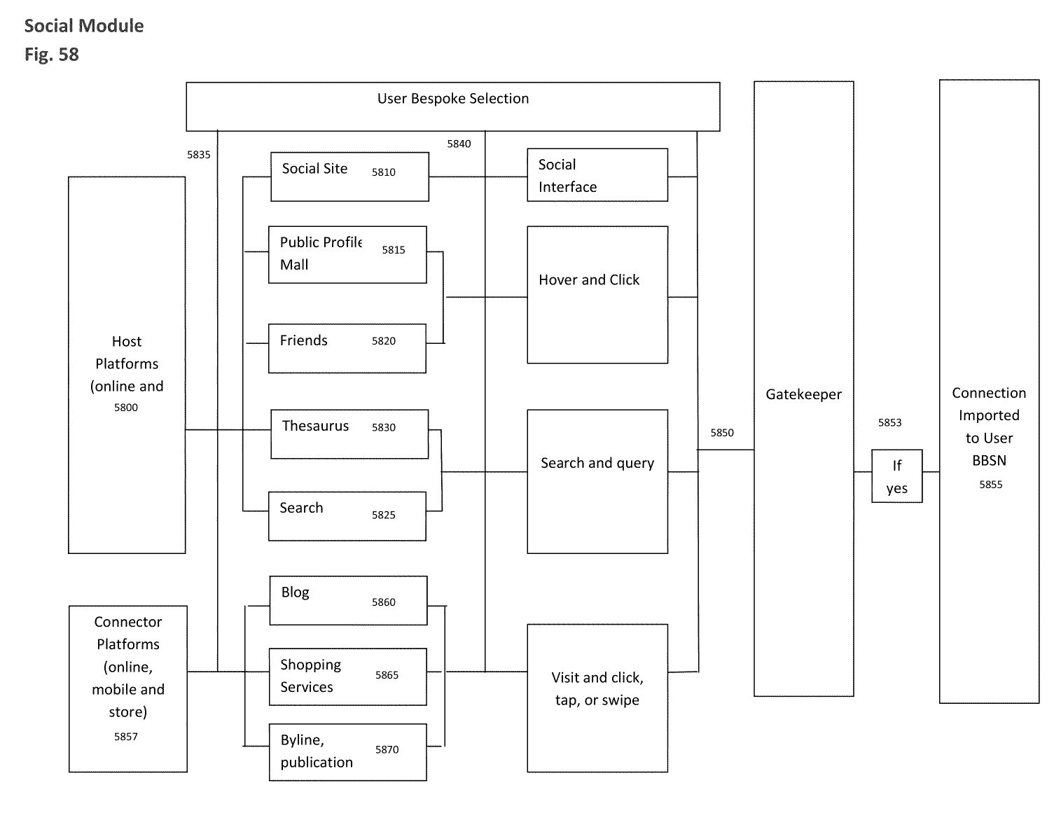

Next described are systems and methods that support social interaction and networking or a social shopping network 658. The nexus of the social system is the user. The user may be an individual, a family, an association, a club, an affinity group, a stylist, a vendor, buyer's club, a retailer and other forms of shopping related groups or networks. A user can allow certain friends or guests to join her BBSN. Similarly, a user may request access to another BBSN. The connection request may or may not be granted with or without restrictions. Connections may be one-way, in the form of a follower construct, or two-way, in the form of mutual friends. Through the dynamic relationship gate or gatekeeper function a user determines the degree to which a relationship forms. Some may be fully open while others retain certain forms of privacy. If the connection is made, then it is added to the user network. FIG. 58 is a block diagram illustrating a host platform 5800 that present various options to a user for making social connections on her BBSN, including but not limited to access through social sites 5810, a public profile on the BBSN 5815, friends of friends 5820, search 5825, thesaurus (for public persona or services) 5830 and others. A user will select one or more options for making social connections 5835 and then within that component make bespoke selections 5840 for sending invitations to connect. The means of making such connection will vary according to the business goals of the host, the component and the user device. A user will elect to connect through the applicable action 5845 and the invitation will be sent to the gatekeeper 5850 or dynamic relationship gate. Open or public figures will default to accepted invitation and the connections will be made and the host will execute the connection. Private connections will be verified and accepted by the receiving party. Upon acceptance 5853, the host may execute the connection 5855 in accordance with the terms of the established relationship, whether friend, follower or followee. Bluetooth connections may be automatically connected. Other devices may have appropriate rules of engagement or default modes. A host may also offer third party components for connections 5857. For example, a host may allow a public figure, or someone in the shopping or related business, including but not limited to bloggers 5860, shopping service provider (such as stylists) 5865, and authors or editors of publications 5870, to present a social connection button on their website or app to facilitate a connection on the BBSN. Each user will have a unique social network and networks may be connected to networks, creating a vast universe of BBSN social connections, as is commonly understood in digital social networking.

A BBSN enables a user to share her mall with friends, have friends help her shop online, share preferences, choose privacy settings, have a dialogue with her vendors, be a trend setter, be an online “It Girl” or create mini-malls for sharing with a group or particular club. In exemplary embodiments of the disclosed subject matter a user can create a shopping network, and the network can keep her informed.

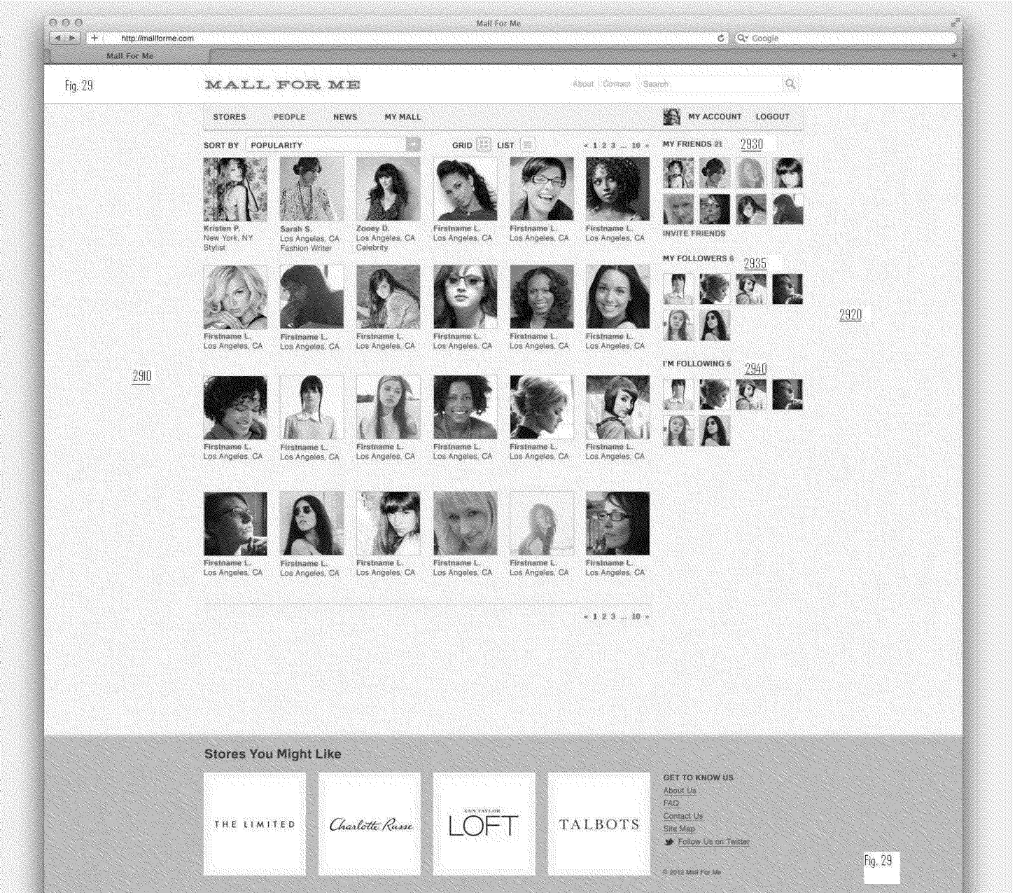

FIG. 29 depicts a screen shot of an exemplary model of public 2910 and personal 2920 social connections on a buyer bespoke shopping network. The public network might include stylists, fashion editors, bloggers, celebrities and others. Personal connections might include private connections, like friends and family 2930, and favorite connections like followers 2935 and followees 2940, affiliated networks, associations and others.

A user may opt to create connections or a social network by inviting personal contacts to view and shop on his or her market or by connecting through the host platform with markets created by others. A user is his or her own gatekeeper; she can make requests and either accept or reject requests of her. She can decide which pieces of her shopping network her guests can visit and enjoy. The user can send an invitation to her guest with a guest password, so that her guest can enjoy shopping in her BBSN. The user network is the connected landscape of his choices to share or block connections with other people or markets. Two way connections are commonly referred to as “friends”, and one way connections are commonly referred to as “following” or “followers”.

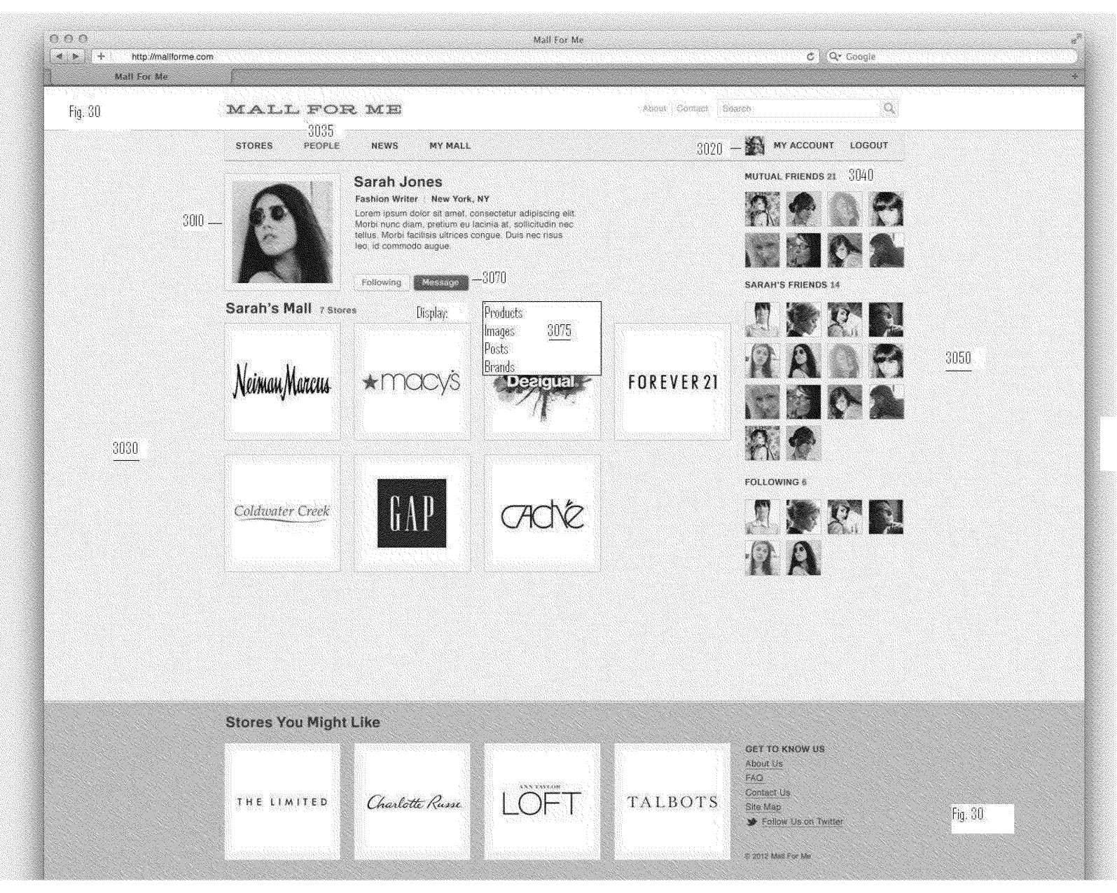

FIG. 30 depicts an exemplary screen shot in an exemplary model of a public profile BBSN. A fashion writer 3010 might allow a user 3020 to view her mall 3030. The user might be granted access through a public point 3935 or as a follower or through some other relationship. The user might see relationships she has in common with the fashion writer 3040. The fashion writer may strategically disclose the number and identity of those who follow her 3050 in order to increase her visibility and marketability. The fashion writer might allow users to communicate with her 3070 as a means of building her business. The user could see various options the fashion writer has on her mall including but not limited to brands, products, images, posts, and other shopping related categories 3075. A user can visit the stores in the fashion writer's mall and make purchases. A fashion writer or other public figure might allow guests to drill down in order to view purchases or recommendations.

Vendors use social media to promote business through the highly influential network of a consumer's friends. In exemplary embodiments of the disclosed subject matter a vendor might ask to become a member of user shopping networks. In exemplary embodiments of the disclosed subject matter vendors can include a host BBSN button icon on an associated site or advertisement. By then clicking on the host BBSN icon, a user can add the vendor to her mall. An exemplary format for a host BBSN button is provided in FIG. 28.

The platform, construct and social nature of a BBSN, is adaptable for individuals, associations or businesses. For example, a sailing club might want to create their own sailing shopping mall or club. Members might invite preferred vendors where the sailing club members will shop. In return, they might hope to receive preferred coupons or specials. A retail association or chamber of commerce might want to collect its membership in a mall in order to promote it. Members might allow open guest access. Alternatively, for example, a real estate agent may create a shopping network to help his clients. The real estate agents shopping network might have home service providers, moving companies, local government agencies, recommended home improvement companies and other recommendations. He might grant guest passes to his malls. A small retailer might want to make her shop more readily available. She might advertise through kiosk space or create a mall that features her products, or videos or other shopping links, windows or the like. Finally, for example, an affinity group such as alumni of a certain university, or members of a particular credit union, or religious groups, or branches of a political party, e.g., young Republicans, Democrats For Change, Star Trek Fan Club, etc., might want to offer to its members merchandise that promotes loyalty or expresses group values.

In exemplary embodiments of the disclosed subject matter a host platform might offer email, chat or other communications tools to facilitate communication between users and their members. A user might offer feedback when she adds, deletes, upgrades or downgrades the ranking of a vendor. She might choose other times she wants to provide feedback. For example, she may want to explain to a vendor that she downgraded its ranking because, for example, it rarely has plain white shirts, or it refused her attempt to return a pair of pants, or it often makes errors in on-line orders.

### News and Communication Module

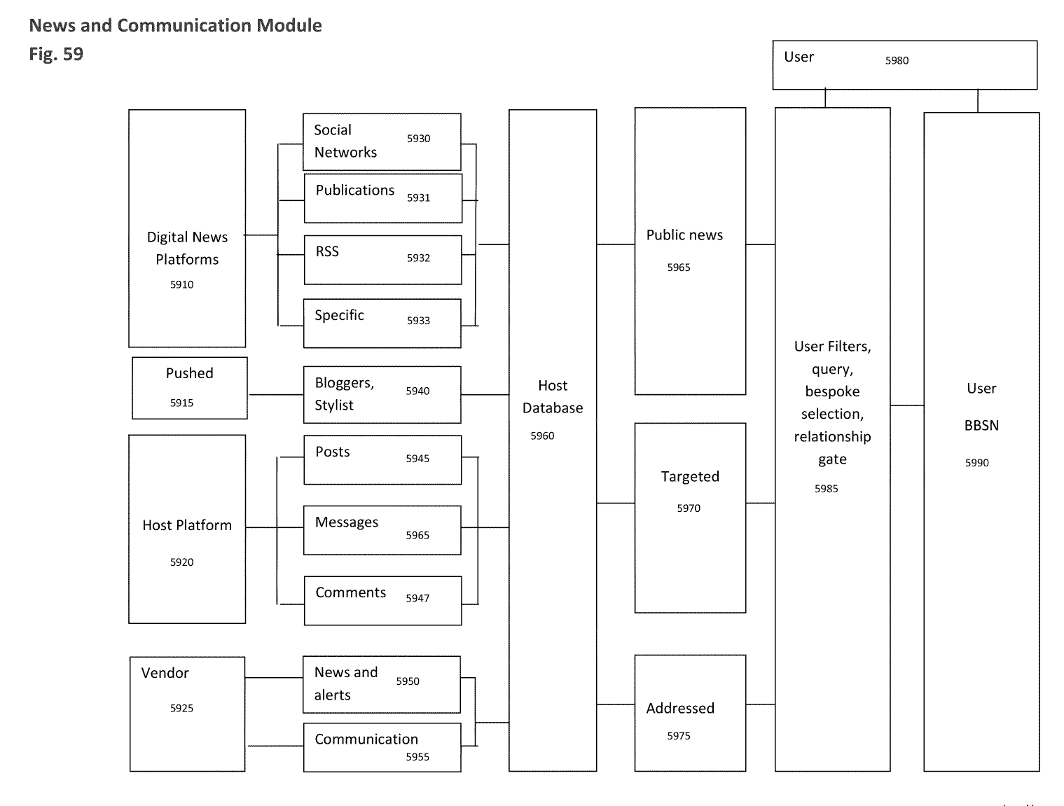

Next described are systems and methods of the News and Communication Module which allow a user to collect all the shopping news, information and communication that is relevant to her in her BBSN 660, 662. FIG. 59 is an exemplary block diagram that illustrates news and communications from various resources including digital news platforms 5910, general shopping and related publications 5915, internally generated information 5920 and vendor supplied news and communication 5925. A host will search, crawl and pull relevant information from digital news platforms, including social networks 5930, publications 5931, RSS feeds 5932 and specifically identified sources 5933. A host may pull social web pages or comments in accordance with the terms and conditions of vendor agreements; publications, including catalogues and magazine subscriptions; RSS feeds from relevant sources; and others. A host may accept relevant information from third parties who push material to the host, including but not limited to bloggers, stylists and other shopping or service related professional 5940 seeking a presence. A host may provide an internally provided communication system, including comments 5947, alerts, instant messaging 5946, commenting 5947 and the like. Vendors may supply feed news 5950, alerts, and forms of communication 5955, including but not limited to messages delivered through email, social networks, direct mail and the like. The host may aggregate all such aforementioned data into its database 5960 and redistribute news, information and communications. Generally, news may be posted to a public news page 5965, pushed material will be redirected to targeted audiences 5970 and specifically addressed news and communication 5975 may be directed accordingly. The host may retain the right not to redistribute information. A user 5980 may review public news and perform various actions 5985, including views, sorts and queries of same. A user may choose to create shopping news hub 679 on her BBSN 5990 where she might receive targeted and directed news and information. News and communication directed to a user may be organized, accepted or deleted as is commonly the case. A user may also initiate messages, comments and the like on the host platform 5920 as more fully described herein.

News and communication may include general public news, such as publically advertised sales or new store openings; semi-private sales, such as those advertised to select customers; targeted consumer notices, such as new inventory arrival; and personal alerts, such as shipping information. News is intended as a broad term that includes a variety of long, medium or short-term information delivered in various formats over various periods of time. New might include coupons or notices that are distributed through common news distribution sources. The News Page on a host BBSN may include original or redistributed news and alerts to those a vendor might send customers via direct mail, email, catalogue, advertising and the like. Communication may be more direct and personal, with personally identified messaging between vendor, friend, user and other participates within the host BBSN platform.

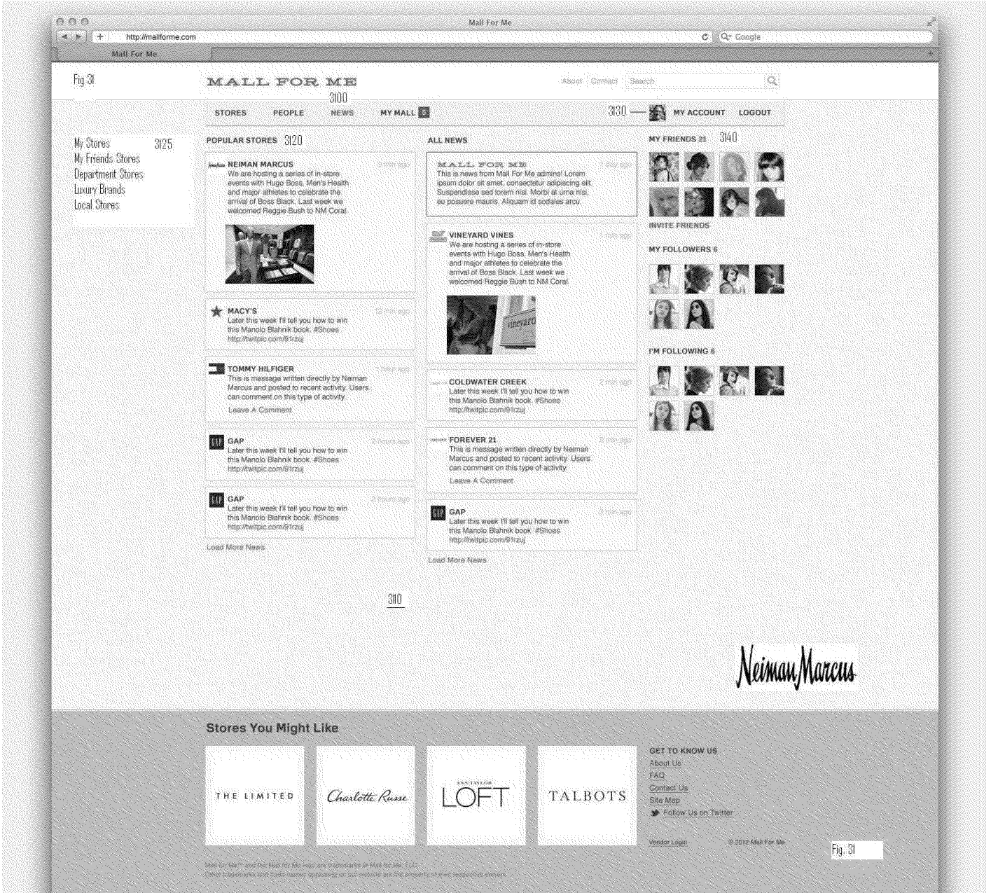

The host may aggregate such information in a database that can be presented in a real time feed. In an exemplary embodiment of the disclosed subject matter, FIG. 31 depicts a public news page 3100 of recent direct or indirect news feeds 3110. The current view is filtered for Popular Stores 3120. Other filters 3125 might include My Stores (the vendors within a user's 3130 BBSN), My Markets (the vendors within a user's BBSN specific market) 656, My Friends Stores (an aggregation of vendors found in her friends' 3140 BBSNs), My Network (My Stores and My Friends Stores) 648, department stores, luxury brands, local stores (as indicated by the GIS system on a mobile device or otherwise) or other related filters or sorts 3130. The news page may be public or restricted to registered users or account holders. Certain functionality (such as filtering options) may be available only to account holders who have logged on or to premium account holders, in accordance with the business goals of the host provider.

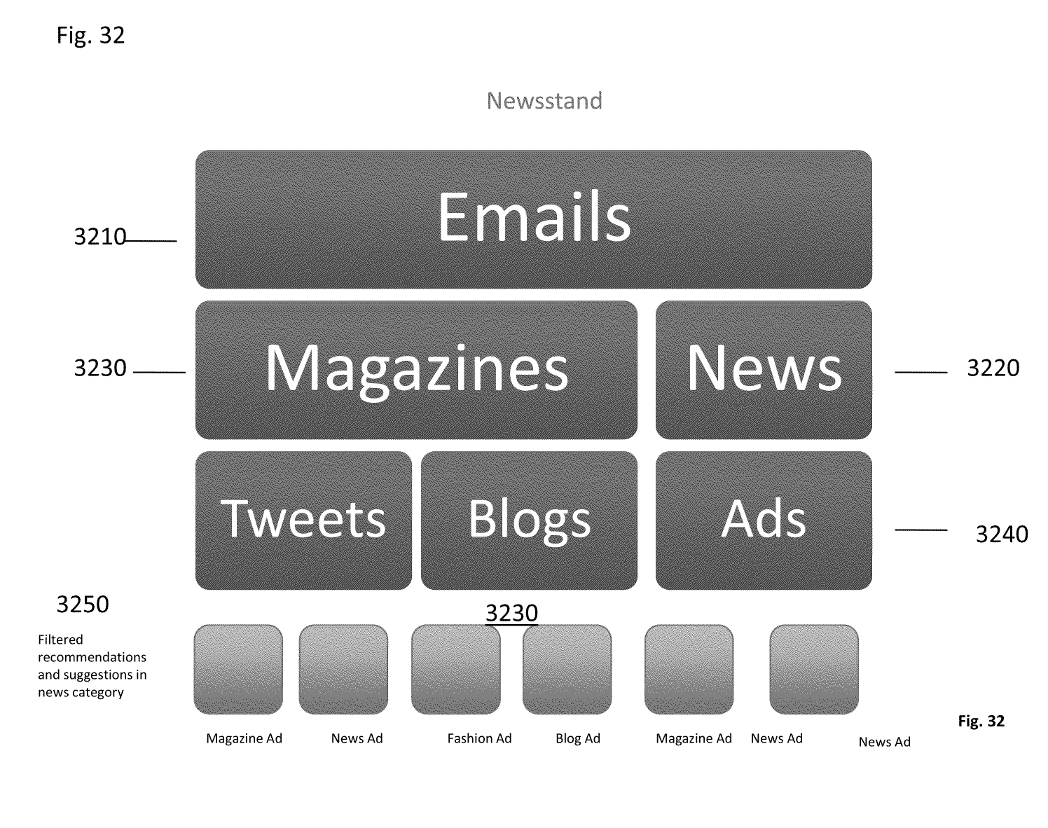

As an alternative, a host may offer a newsstand for various forms of shopping related material. A host may choose to organize news and communication by technical difficulty and to maximize agility and speed of response by device. A user might choose to have her favorite blogs, magazines, subscriptions or celebrity tweets directed to her BBSN where she can organize and aggregate various message formats from various relevant sources. A user might also choose to have certain vendors blocked. In one embodiment of the disclosed subject matter, FIG. 32 depicts a simplified screen shot of a BBSN newsstand of information from a multitude of vendors pre-sorted and organized by format. Emails 3210 are aggregated for a quick read, news alerts 3220 can include videos; magazines or catalogues 3230 can be flipped through; and blogs 3230 can be aggregated for longer reads 3240. Advertisements or other blocks of news can be delivered in a variety of formats and be passive, active or interactive, with or without rich images or multi-media formats. Also depicted are current advertisements, marketing, recommendations or content links 3250 that may be of interest to the user.

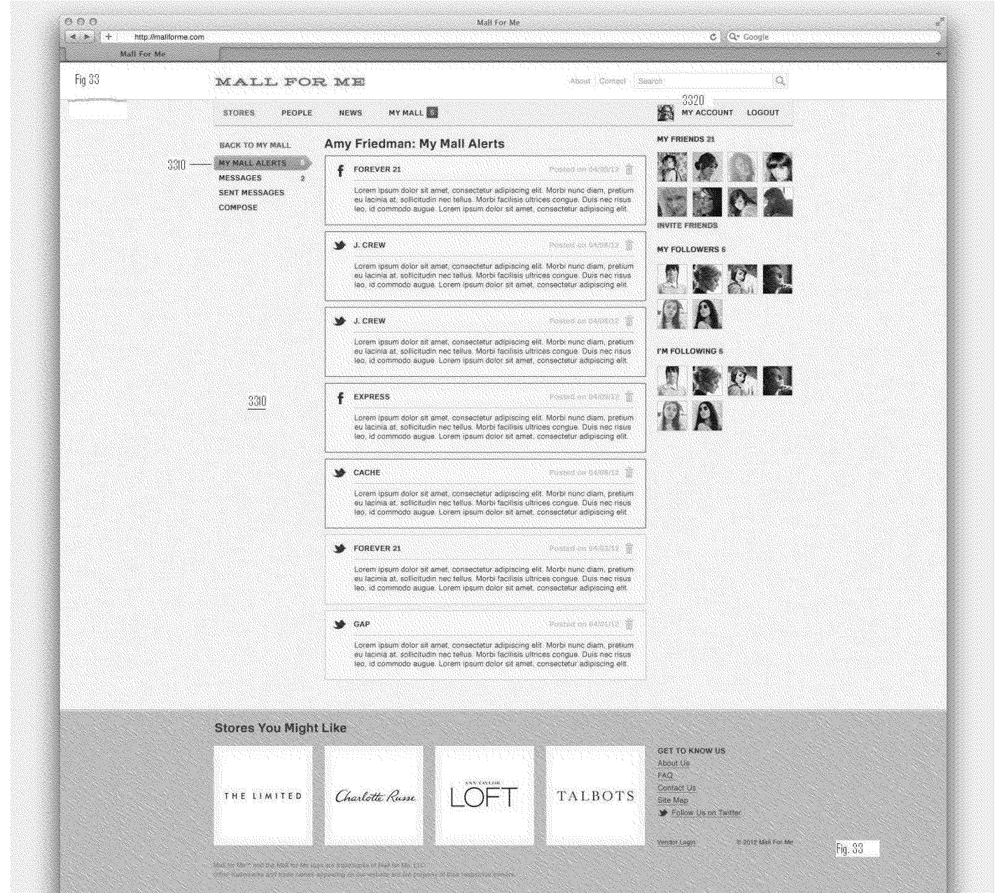

In an alternative embodiment, a host may offer personal filters in order to aggregate personal news and communication. The host can filter the aggregated news by vendors the user has chosen to be a part of her BBSN so that the personal news feed contains alerts relevant to the user. In one embodiment, FIG. 33 depicts a screen shot of My Alerts 3310 for a logged in user 3320. BBSN news can be shared with connections and a user can visit a friend's newsstand.

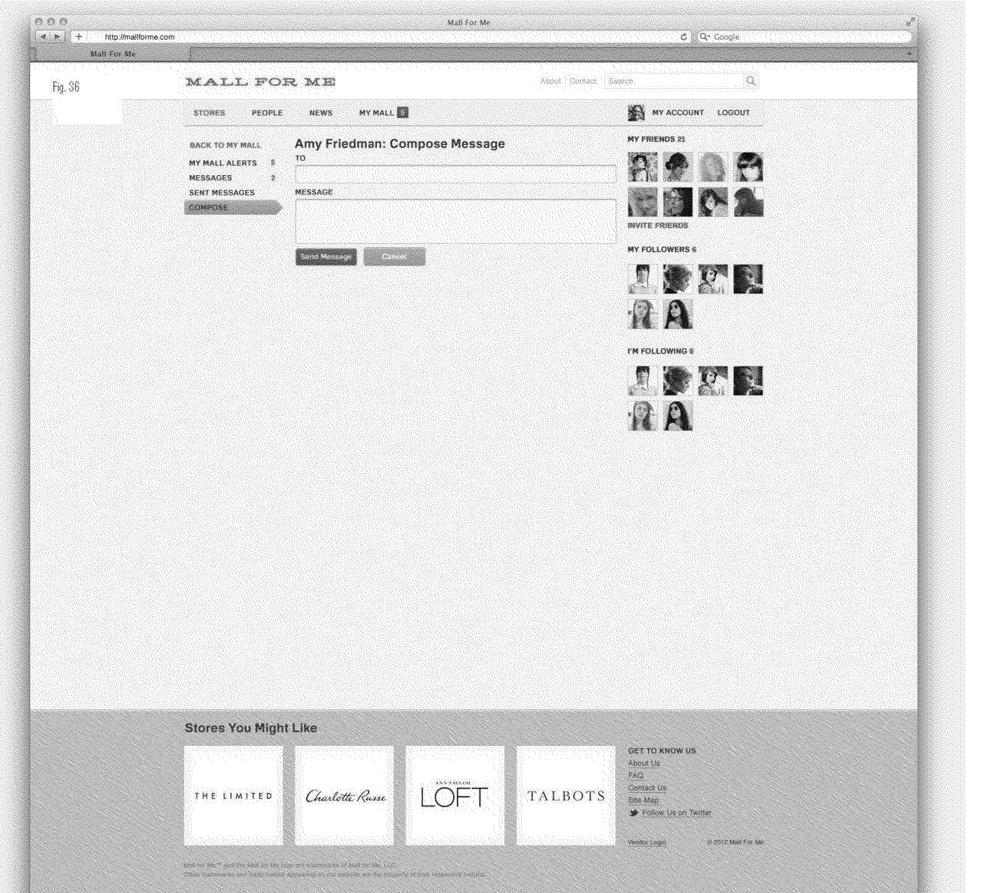

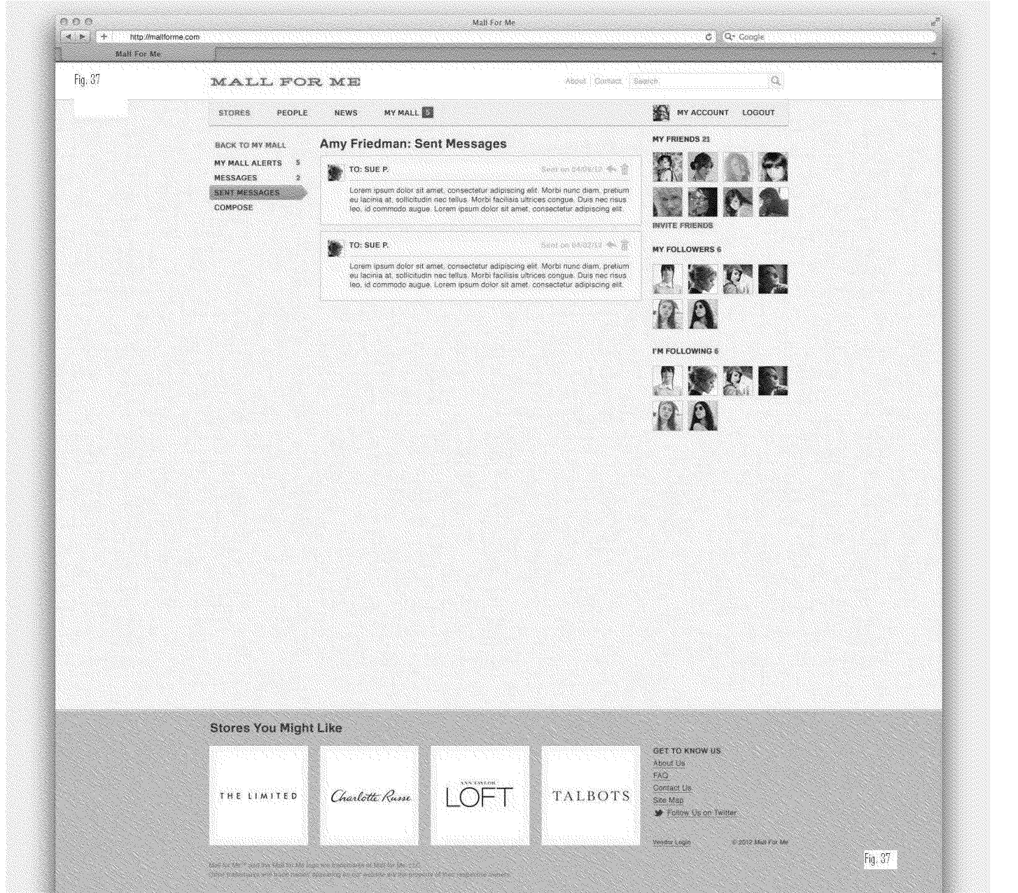

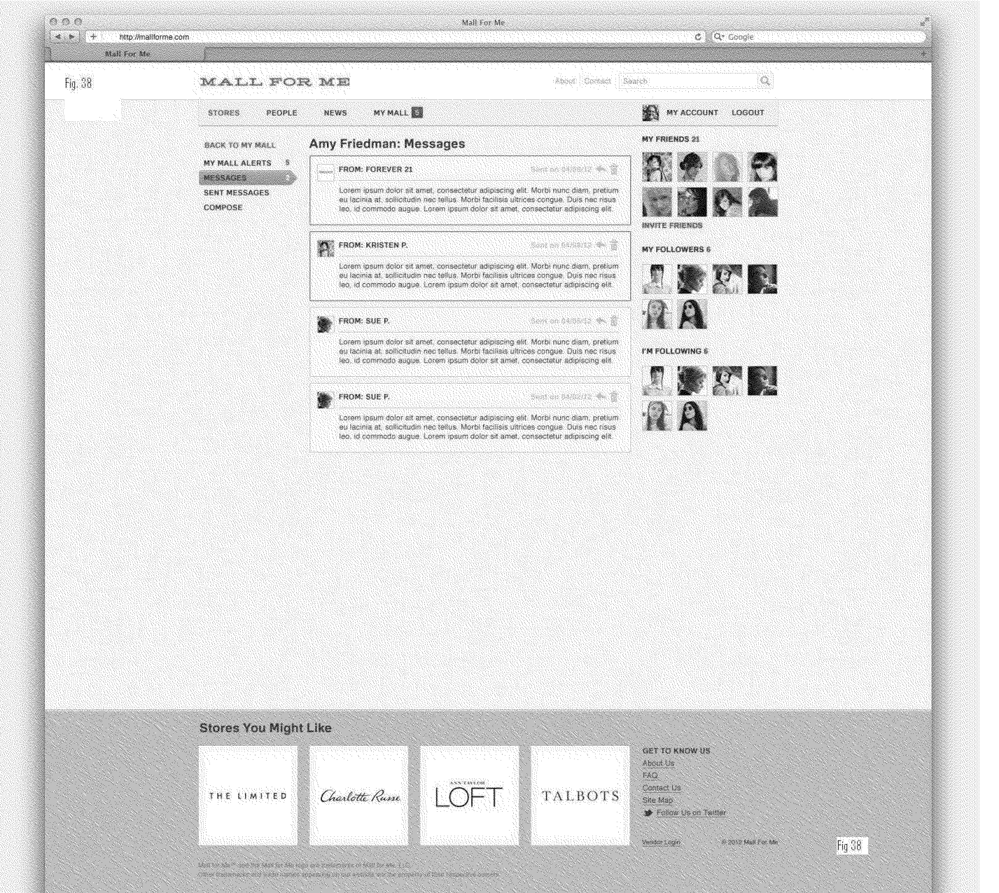

In addition to news feeds and social connections, the host may offer a component that enables communication and messaging focused on shopping within a user's BBSN. Communication may occur within the system and with outside parties. Communication may include various forms, including but not limited to messaging, instant messaging, email, tweets and other social connections. As depicted in exemplary embodiments of the disclosed subject matter, the user may choose to compose and send a message FIG. 36, review, manage and delete sent messages FIG. 37, and review, reply or delete incoming messages FIG. 38 utilizing heuristics and as designed and implemented by those skilled in the art.

The host may use the email or messaging systems as a means of communicating with a user and vendors. In one illustration, a host may choose to make recommendations or suggestions to users through BBSN email or messaging. A BBSN host can create filters for BBSN emails. Through the use of rules and user preferences, a BBSN host can direct emails to specific folders, such as recommended emails and generic email. All emails might be registered with a BBSN host. Vendors might self-register.

A host platform for a BBSN might create alliances with other vendors or service providers, such as, for example, a coupon service, a note or a thank you note card service, news clippings or other preferred networks and links that provide valuable shopping information or services. The host may offer access to or subscription services for shopping information through either a propriety system or through third party services. For example, a host may allow social news feeds, magazine subscription services, blog or content presence, and advertising or marketing vehicles.

### Shopping Module

Next described are the systems and methods of the shopping module within a BBSN. A BBSN allows a user to access a bespoke selection of vendors in order to build a preferred shopping venue and complete shopping actions 664, 680, 681. A user may elect to browse, shop, or access her vendors individually. Alternatively, a user may elect to access her vendors as a market or as a submarket. A user may access her shopping utility and other modules in order to complete shopping actions individually or universally 680. For example, a user may search for an item or compare items across her bespoke vendors 684, create a wish list or purchase from among the return. A user may execute actions within the host platform, or alternatively, as the host allows, on an alternative platform, such as a vendor platform. The user will make bespoke selections that facilitate her use and management of her BBSN 666.

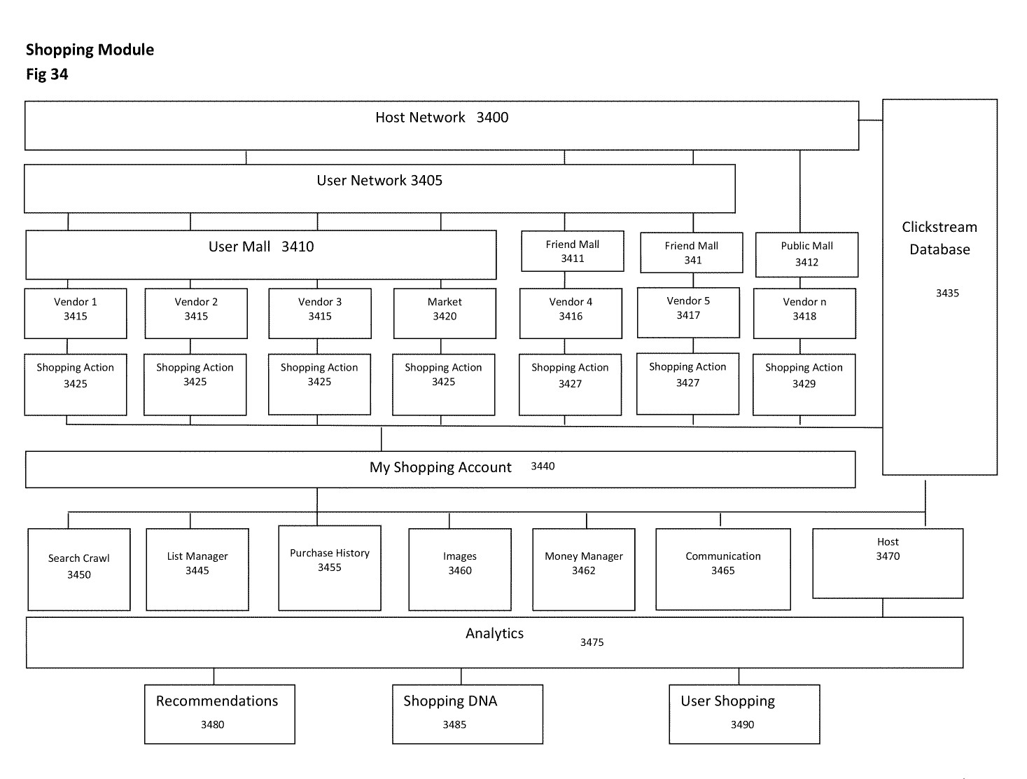

In one embodiment of the disclosed subject matter, FIG. 34 illustrates a user BBSN 3400 in which a user makes certain bespoke shopping elections 3410, which may be executed through the utility or other modules. A user may browse, shop, or select from within her mall 3410, her network 3405, the host network or some combination thereof. In one embodiment, the user may be to shop several vendors 3415 or markets with more than one vendor 3420. A user may engage in various shopping actions, including but not limited to browsing, purchasing, identifying something for a wish list or gift list, and adding images. In some instances a user may conduct shopping actions within the user network of markets 3425, within friends' markets 3427, public markets 3429 or a combination thereof. Actions might be aggregated and executed collectively by utilizing universal shopping features or utilities 680, such as cross vendor purchasing or loyalty programs. The BBSN allows a host to record a user's shopping actions throughout her BBSN in a clickstream database 3435 in accordance with the vendor agreement and user privacy allowances and aggregate a repository of shopping information for the user across vendors and over time. A user's shopping account component 3440 serves to support shopping actions, retain data, and to enhance future shopping actions. The system is iterative, interactive and dynamic. Components that may support shopping actions include among others search or crawl features 3450, list managers 3445, purchase history 3455, images 3460, money manager 3462, and communication 3465. For example, a user may add an item to her wish list 3445 and then later use the wish list to search or crawl for the same or like items within the vendors within her BBSN. She may wish to access the search and crawl component 3450 in order to execute or repeat a search or crawl query at a later date. Alternatively, she may use her purchase history 3455 to find and execute a repeat purchase. Alternatively, she may elect to enable an image component for collections, albums, closet or other features 3460, that enable a user to collect, retain and manage images, videos or other digital records of wish lists, purchases or other category. A user may wish to use a host credit card that allows cross-vendor purchasing and loyalty programs, or to provide sub-accounts or allowances for children. She may also wish to post or send information regarding her purchases through the communication module 3465 to her BBSN or forwarded to third party social networks. The host 3470 can access the user shopping data 668 and analyze such data 3475 in order to improve shopping recommendations 3480, monitor shopping DNA 3485, and offer other user shopping tools, features and functions 3490. A user or host may access a user's data and analytics 668 in order to facilitate shopping.

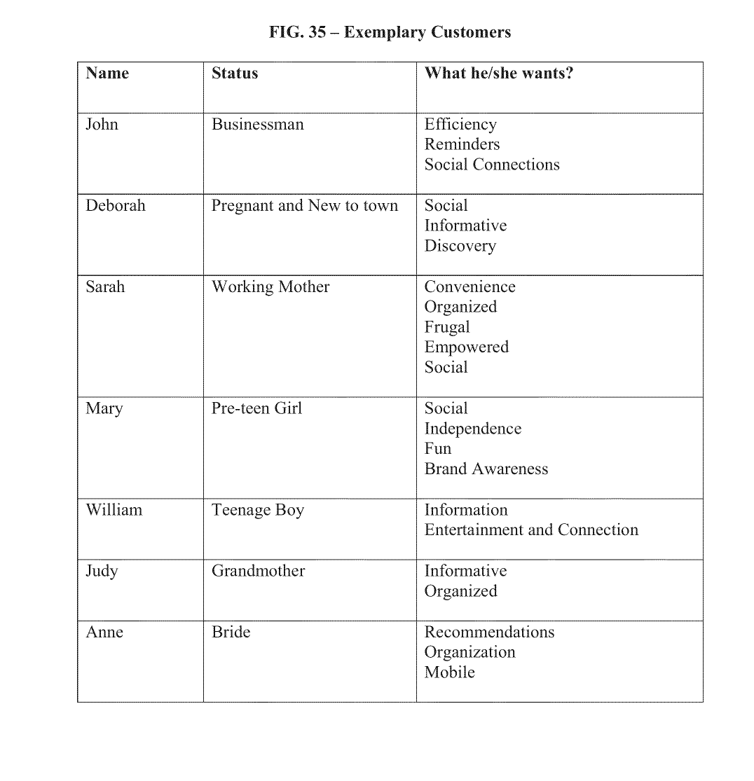

The systems and methods of the shopping module are dynamic and flexible. A construct is a buyer bespoke selection and an offering based on the aggregation of buyer behavior across vendors and over time. In representative embodiments of the disclosed subject matter, hereinbelow is a descriptive collection of exemplary narratives for a variety of users (listed in FIG. 35) showcasing systems and methods. The components within the various systems and modules may or may not be offered in accordance with the business decisions of the host.

John is an exemplary businessman. He uses his BBSN because it is efficient. For example, John can go straight to the stores and brands he likes best without having to recall the web site URL or waste time looking for it. He can buy his staple items quickly and easily through his convenience shop. He does not have to sort through all the (female) noise found in alternative shopping or search environments. John also likes the reminders. John is a busy man; his BBSN keeps track of his purchases and special dates through the shopping module. The social connections are valuable to John. John belongs to a sailing club. He keeps abreast of the best vendors for sailing equipment and travel ideas through the BBSN his sailing club created.

In one exemplary shopping experience, John goes to the BBSN host website and signs in. His BBSN home page has icons of his favorite brands. He has a food court on his BBSN with his favorite restaurants and food-related services. John clicks on the Zagat icon. He has a subscription and wants to book lunch with a top client in Chicago. The restaurant is not Zagat rated. He scrolls through his restaurant market, which has only the vendors he has chosen to include. He quickly locates a favorite restaurant and makes a reservation. John also has a link to Open Table on his BBSN, which he could use as an alternative for making a reservation. John goes to his communication module and checks his shopping messages. Harry & David reminded him that it is his father-in-laws birthday. John clicks on Harry & David and proceeds to reorder his annual gift. The purchase is added to his purchase history through the shopping module on his bespoke shopping network. Next, John sees through his news alerts on his BBSN that Brook Brothers is having a sale on dress shirts. He shops for dress shirts and ends up buying some new weekend pants and socks while he's there. Payment is quick and easy as he accesses the payment component. John browses through his BBSN. His sailing club created a mall that highlights vendors that its members like best. By banding together and identifying themselves as loyal customers, the members have negotiated a discount that is automatically applied every time they buy through their mall. It is easy to share difficult to find items or places to eat near certain ports of call. John discovers a vendor a new member added and ranks four stars. John explores this new vendor and finds items he needs at reduced prices. John flags it for future reference and sends the new member a message asking about the quality of the vendor's products.

Deborah is an exemplary woman who is pregnant and moved to a new town. Deborah uses the social module of her BBSN a lot. She is overwhelmed by trying to find all of the new items she will need. She has heard strong recommendations and strong warnings. She just can't recall all the names and remember which ones are good or not. It's just too much information to absorb, especially when you are new to town. Friends share their mall with her so she can easily see which baby brands and resources are favorites. The BBSN is informative. Deborah can learn about the stores in town without leaving her home. Deborah uses her friend's malls as an efficient and trustworthy means of discovery. Through her friend's malls and recommendations Deborah can learn about items she didn't even know were available.

In one exemplary shopping experience, Deborah's friend at work, Jane emails Deborah a guest pass to her mall. Jane just came back from maternity leave and is full of useful information, but they don't have time to talk or email all the advice. Deborah visits Jane's mall. Jane has her mall organized into markets. Deborah goes to the “Baby” market. Deborah heard that Costco had good prices, but she sees Jane has Diapers.com on her mall and concludes that Diapers.com is better for her needs. She reads on and notes Jane's vendor rankings. As Deborah investigates brands or stores on Jane's mall, Deborah adds the ones she thinks she will use to her mall. Separately, Deborah's real estate agent allows his clients to enter a mall he designed for newcomers. Here she finds all kinds of service personnel. She knows her real estate agent continuously updates the recommendations based on feedback from clients. It's a trusted source, and she can follow-up with questions.

Deborah goes on to visit another friend's mall and then the local Chamber of Commerce mall. She finds useful shops that are close to her home she had not yet discovered because they were on the side street.

Sarah is an exemplary working mother. Sarah doesn't have much time, but she has a lot of shopping responsibilities. Sarah uses her BBSN for convenience. Sarah does not have to drive all around town looking for the items she needs, nor does she need to go through endless searches or endless inventory on other websites. Sarah feels more organized when she shops on her mall. She goes directly to the vendors she needs, and she can browse vendors she likes when she has more time. There is less stuff in the way. Her shopping closet feels organized and clean. Sarah takes advantages of specials and sales now that she receives vendor coupons (e.g., through the news module) where and when she uses them. Sarah grants her daughter limited shopping independence. Sarah can share information with friends with whom she wouldn't otherwise have the time to call or visit. She feels she can stay connected and help mothers who give rides to her children.

In one exemplary shopping experience on her BBSN, Sarah is on the train home from a long day at work. She looks at her mall and browses the BBSN news. Her teenagers want something new and cool for the holidays. She doesn't have time to keep up with latest gadgets. Her BBSN news reports vendor and product news she has flagged as being of interest to her. She learns about a hot new digital gadget. She adds it to her shopping list. Sarah checks her message board. All her shopping emails and shopping news sent via social networks and other mediums are sent directly here. Whenever Sarah purchases from online stores or orders from catalogues, she only gives out her BBSN email account. By utilizing her BBSN news and communication her vendor promotions, shipping details or coupons are not in her office email, or her personal email. Sarah used to just delete all vendor emails in order to focus on the “real” emails that would otherwise get buried in the long list of vendor emails. Emails from friends don't get overlooked as much anymore because there are many fewer emails being sent to her personal account. With vendor email properly placed—on her shopping network—she finds she can now take advantage of the vendor emails. After all, it is good to be reminded that Lands End is having a 20% off sale on uniforms the children need for school. Sarah works hard for her money and hates missing out on offers because she can't find them or deleted them. She likes to see the coupons and sales where and when she is shopping. Sarah sees that Coach is having a sale next week. She particularly likes the fact that all the messages can be aggregated and searched, that the messages can be sorted by sender and that vendor specific messages can be found when she is looking at that particular vendor on her mall. At home Sarah finds her daughter on her mall. Her daughter found two bathing suits and put them in her wish list. Sarah takes a look. She smiles. There are fewer arguments about shopping now. Sarah created a mall for her daughter with Sarah-approved shopping vendors. The bathing suits meet her expectations, so Sarah enters the pass code to approve the purchase. Daughter is happy, and mother is happy. Sarah puts her casserole in the oven and sits down to her mall in order to purchase her groceries for the weekend. She clicks on her Food Shop and then on Peapod. She clicks on her staple list and adds a few more items for this weekend purchases and goes back to cooking dinner. She returns to her mall after dinner in order to check her shopping list. She has time to order the school uniforms. Sarah admired her friend's work dress and wondered where she bought it. Elizabeth sent the link to Sarah's mall and invited Sarah to be a guest in her mall. Intrigued, Sarah visited the mall. No wonder Elizabeth looks so good at work. She has 12 vendors under executive female category. Elizabeth must be taking advantage of the vendor recommendations. She has boutiques across the country listed. Not just the top national sellers. Her wish list closet is full of fantastic clothes. Sarah browses through Elizabeth's mall and ends up buying a few things. Sarah clicks on her wish list and adds a few more items and vendors. Sarah has a collection of vendors for travel. Spring Break is coming up and some of the mothers in her daughter's class were thinking about going someplace warm. Sarah knew this was her chance to contribute to the group and connect with other mothers. She sent them a guest pass to her mall and invited them to view her travel rankings and comments. One of the mothers had taken her up on her offer and invited Sarah to chat on mall about her choices.

Mary is an exemplary pre-teen girl. Mary and her friends share shopping tips on their malls. They chat online or through audio or video while they visit each other's malls. They learn about brands, value and quality together. They are not old enough to be dropped off at the mall, but they can share information through their mall networks. Mary feels like she has some shopping independence on her mall. She can browse freely and learn about sticking to budgets. Mary likes to decorate the mall and add new features. She also likes to share her mall with friends and see their malls. Teenagers are aware of labels—in many ways. Mary can't always afford the brands she likes, but she can announce to the world what she likes on her mall. Mary's mother is single. Mary has had to learn responsibility and how to keep occupied while she is waiting for her mother to get home. She heard about the buyer's bespoke shopping network from her friends at school last month. Mary hears about all kinds of name brands from her friends, but she it not familiar with them because money is tight, and she doesn't get to shop much.

In one exemplary shopping experience, Mary goes to the host platform and creates an account and communicates with her friends. They respond and give her Guest Passes to their malls. Mary checks out her friends' sites and sees what they were talking about at school. When she gets a job she is going to visit these higher-end shops. She can wish and share what she likes even if she can't get it yet. If she puts it on her wish list, then maybe her aunt and uncle will get if for her for her birthday. Besides, it will be helpful to them because they don't have any children, and they don't know what to buy for her. Over the weekend the girls got together. They showed Mary how easy it is to set up a mall. There is a fun questionnaire about your interests and which celebrities you like. You can play with the colors, wallpapers and pin boards (drag your own photos or art work onto your mall). Mary can always change it later. They clicked on Sue's Teen Center to play on the games and check out the tweets from and images of celebrities. They see a favorite celebrity has posted a bangle bracelet in her closet. It's reasonably priced. Mary suggested that each of them get one, like a club. They like to find new cool things, but they also like to wear things that are similar. They post it to their shopping list and forward it to each other through Share with Me, a component within the social module. Mary went home inspired. She set up a mall for her family, with things that she knows her mother likes and uses. She added the bangle bracelet to the wish list. She couldn't set up the account yet, but she figured out how to do it, so she could explain it to her mother. When her mother got home they visited the mall together. It was a fun thing to do together. They set up a mall for her mother with the discounters and stores in town. This way Mary's mother can take advantage of the sales when she has time. She will be reminded about events and be able to keep a shopping list for multiple categories. When she has the time or the money she can pick and choose among vendors without having to go back and forth between sites or sort through endless search options. Mary has plans to add her favorite vendors and games. She wants to play the Games for Me. The scavenger hunt looks fun, and if she passes certain levels, then she gets Tokens she can use (if her mother lets her) in the Teen Center arcade.

William is an exemplary teenage boy. William likes all the information he can find on his BBSN. William can learn about new products. He can research new sports equipment or new video games. William spends a fair amount of time checking out the advertisements on his mall. Some have really cool gaming features or YouTube clips that are fun to share with friends. This way he can connect with friends without really having to talk much. William loves sports, and he is responsible. His father gave him an Allowance for Me on his BBSN. He can use it to buy tokens to play games, but he has to manage his own account. William feels free and independent. Some days he doesn't have time to play video games and other days he just needs to chill after a couple of tests. The parental control time limits go to waste some days and are too short other days. This way he can manage his own time without over-doing screen time. William can also use is allowance to buy things.

In one exemplary shopping experience, William checks out ski equipment through a BBSN because he and his father are going on a ski vacation next month. He found his father's favorite store, but he also checked out the host recommendation. It looks a little more like the clothes and equipment he needs. He flags the brand and items for his father to check out later. William saw on his mall a You Tube clip advertizing the ski equipment that he forwards to his father to help with the sales pitch. William wonders if Charlie saw it. He sends Charlie a copy.

Judy is an exemplary grandmother. Judy uses her BBSN to be better organized. The internet is supposed to help, but realistically it is hard to learn and manage all that it has to offer. She likes that she can go to one familiar place, her BBSN, for all her shopping. She still has to learn about individual vendor websites, but she would have to do that anyway. Her bespoke mall is a familiar mall. The stores are always in the same place, and she knows where and how to find them. Judy doesn't need much, but she has always been a shopper. It's the entertainment factor. She doesn't have the energy she used to have, so shopping online or through mobile devices has made her life easier.

In one exemplary shopping experience, Judy is looking for just the right gift for her grandchildren, but she can't remember everyone's age and doesn't know what kids like these days. Her oldest grandson is usually vague. This year she is going to visit his mall in order to see what he actually likes. Judy looks at all the sport vendors he has on his mall. Judy chooses one and begins shopping. Then she sees he has flagged some ski equipment. She sends him some BBSN Money to his mall so he can start saving up to buy it. Judy also takes a look at his Newsstand to see what he is reading and learning about. She can try to get informed about the latest news before she sees him. Maybe they can have a conversation about something he is interested in, and she might know what he is talking about.

Anne is an exemplary bride. Anne is overwhelmed with all the choices she has to make. She is still working and needs to streamline her time, so she uses extensively the host recommendations on her mall Anne can create a mall with wish lists or bridal registry by vendor Anne is also moving to a new town, so she wants to take note of what is available even before she gets there. Anne loves to shop. She likes the mobile applications on her mall. As she browses, she can add stores to her mall by swiping her mobile device in front of the store scanner. She has her credit card company add a store to her mall each time she buys something from a store. She also has the products recorded in her purchase history for future reference. Anne is getting married, and she wants to look great, feel great and prepare for a new home. There are a lot of things to find. She has planned for her wedding her whole life and yet there are so many new options. She wants her wedding and new home to reflect who she is, so she is willing to spend some time searching and planning.

In one exemplary experience, Anne has discovered some new finds through her mall, which has kiosks and recommendations for event planners. She is a bit overwhelmed with all the choices, so she is glad to have recommendations based on her profile, interests and preferences help narrow the search. The real estate agent shared his New Home Mall with her so she can find services nearby quickly and easily. The vendors who have linked to her site are already sending her welcome to your new home emails. Thank goodness she uses her BBSN Messages because with all the parties and work still to be done, she doesn't want anything to be lost Anne is an organized person. She methodically fills in her profile and Interest and Options forms and then adds or deletes vendors. This will save her time.

### Account Management and Utility Module

Next described are systems and methods within the account management and utility module through which a user might manage, use, and edit her BBSN. A BBSN is a dynamic platform and modules or components therein may be enabled or not. Depending on the business goals of the host, a utility module may be independent or a component within an account module.

After creating a BBSN, a user retains the ability to visit public portions of the host platform and utilize modules and components available to her. For example, once a user has logged in, the view of the host pages might change, allowing the user BBSN to override certain features of the homepage and utilize additional functions and features. FIG. 12 depicts an exemplary screen shot of a logged on user. An embodiment is represented through the change in the social connections section, where the user's account is recognized 1200, and user social network choices are displayed 1230. Actions may also be enabled, as represented by the various abilities displayed when a user hovers over a particular vendor, including as a representative sample, the ability to share, add comment, view deals and the like 1210.

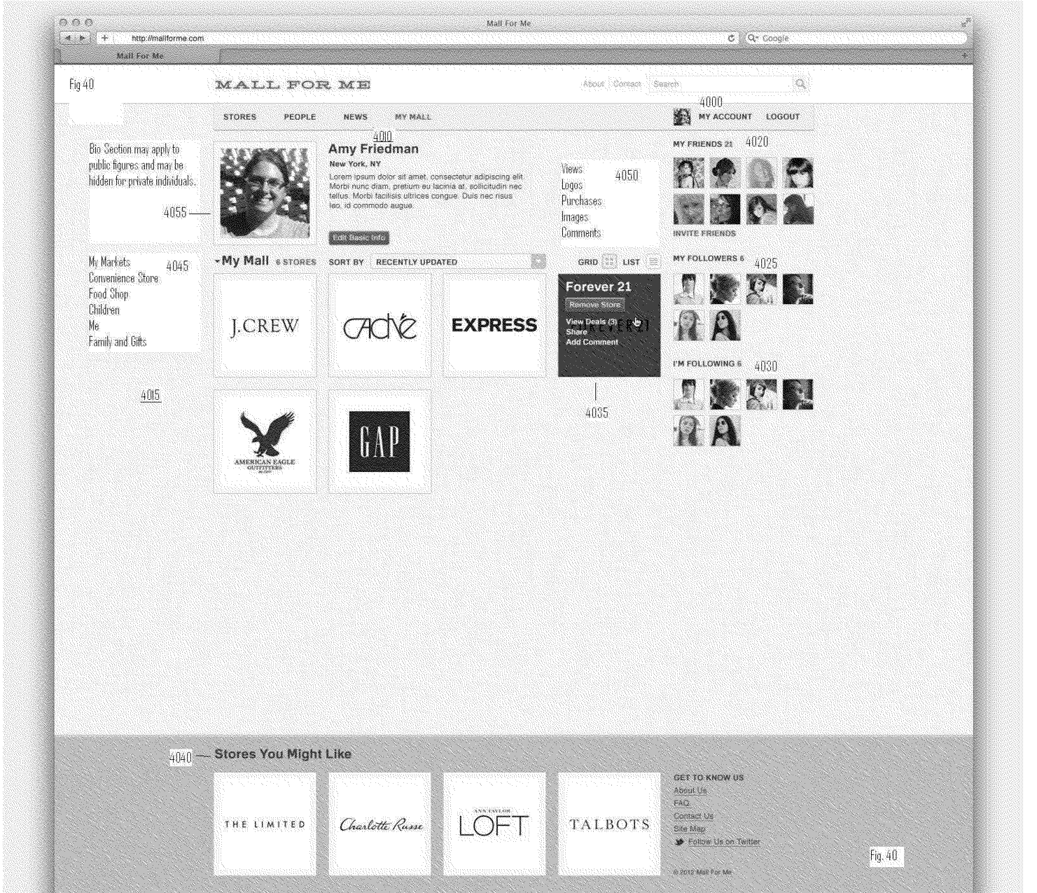

A user might also access her mall or markets. As noted in a simplified screen shot FIG. 40 of the disclosed subject matter, a user 4000 might visit her mall 4010 that contains only the vendors she has chosen 4015 along with her friends 4020, followers 4025 and followees 4030. From her mall she can begin shopping by clicking on a vendor. A user can conduct typical actions within her BBSN 4035, such as view, comment, share, rank, access recommendations and visit other malls within her BBSN. The “stores you might like” 4040 is an embodiment of a recommender system activated for the particular user based on the user's BBSN database. A user can access markets 4045 within her mall through a drop down menu, tab or other design as implemented by those skilled in the art. A user might select a market to view those vendors within that market and drag and drop vendors in one market into another. A user may also choose to change the view of her mall 4050 in order to display a window shop (vendor images as opposed to logo), purchases, wish list images, comments or other portions of her database as enabled by the host by selecting various views. A user may choose to hide certain elements, such as her bio 4055, or restrict access to certain portions or views of her mall.

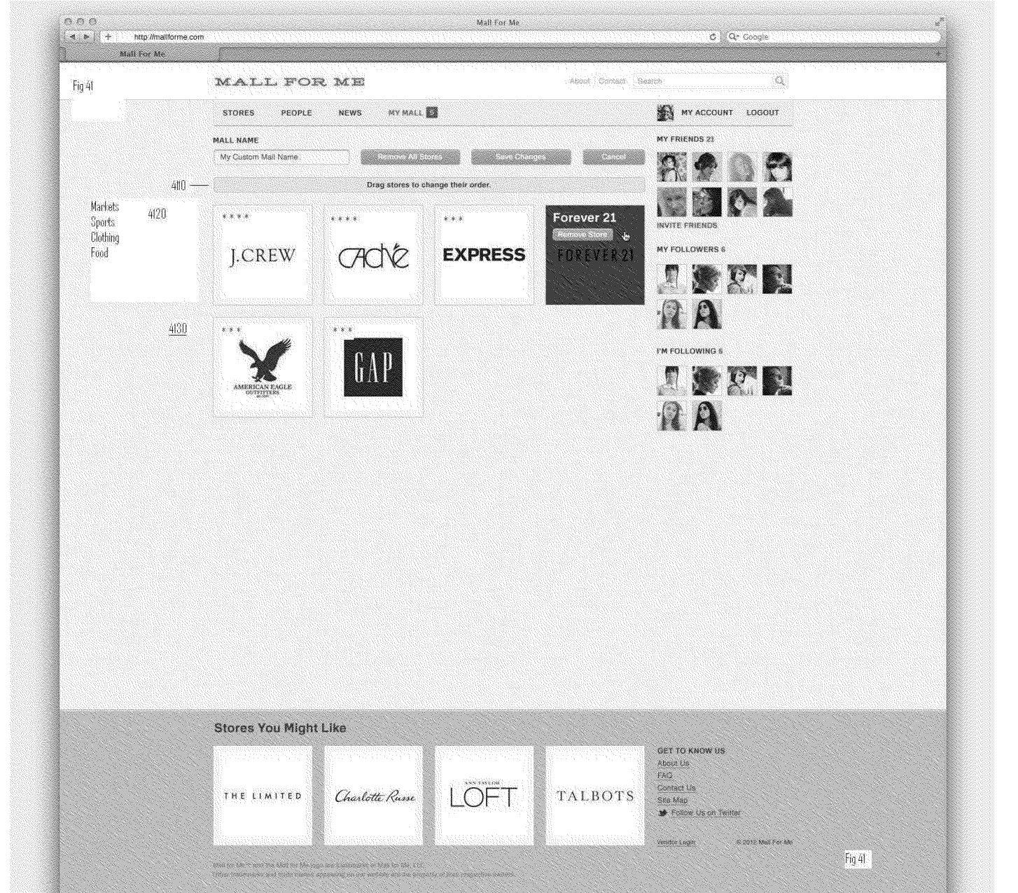

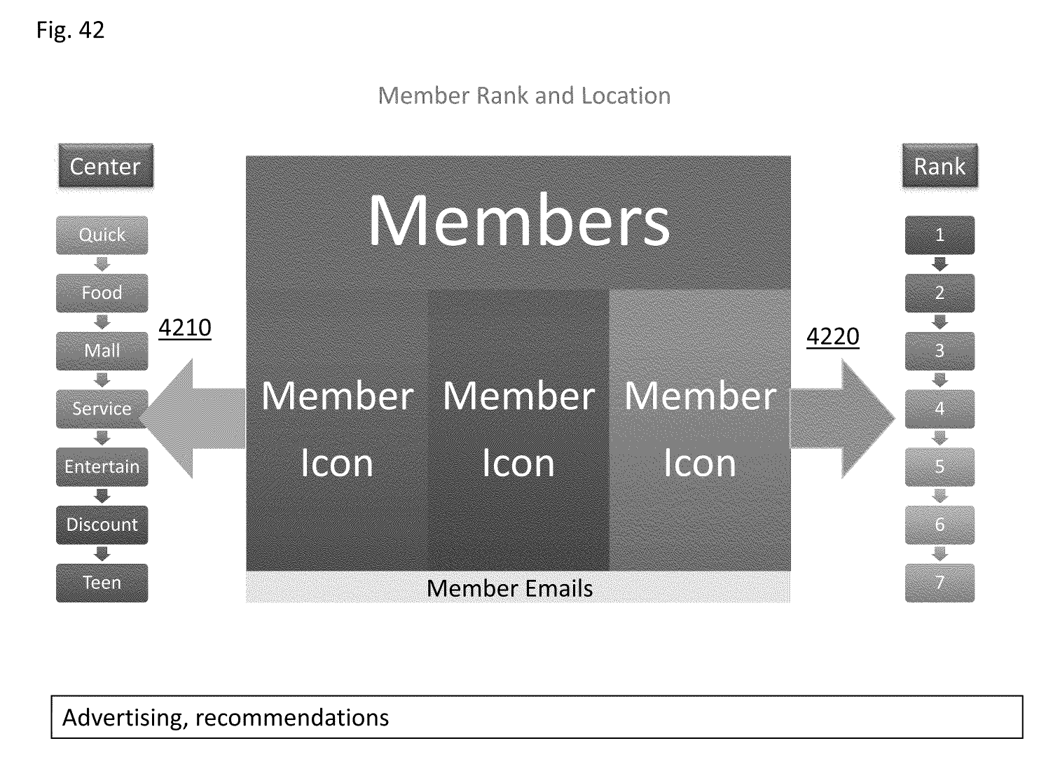

A user might choose to add, remove, rank or move vendors at any point in time. In one exemplary embodiment, a user can drag logos in order to move 4110 or organize vendors 4120 4210, as shown in FIG. 41, as a representative embodiment on a computer and FIG. 42 as a representation embodiment on a tablet or other device. A user may also have options to rank 4130 4220, comment, and label or otherwise manage her vendor list, as determined by those skilled in the art. Highly ranked vendors might be displayed more prominently, first or on the top. Lowest ranked vendors might be found at the bottom through pagination or scrolling, depending on the template and user device. Such actions might also be available in the embodiment shown in FIG. 40 in alternative models of the disclosed subject matter.

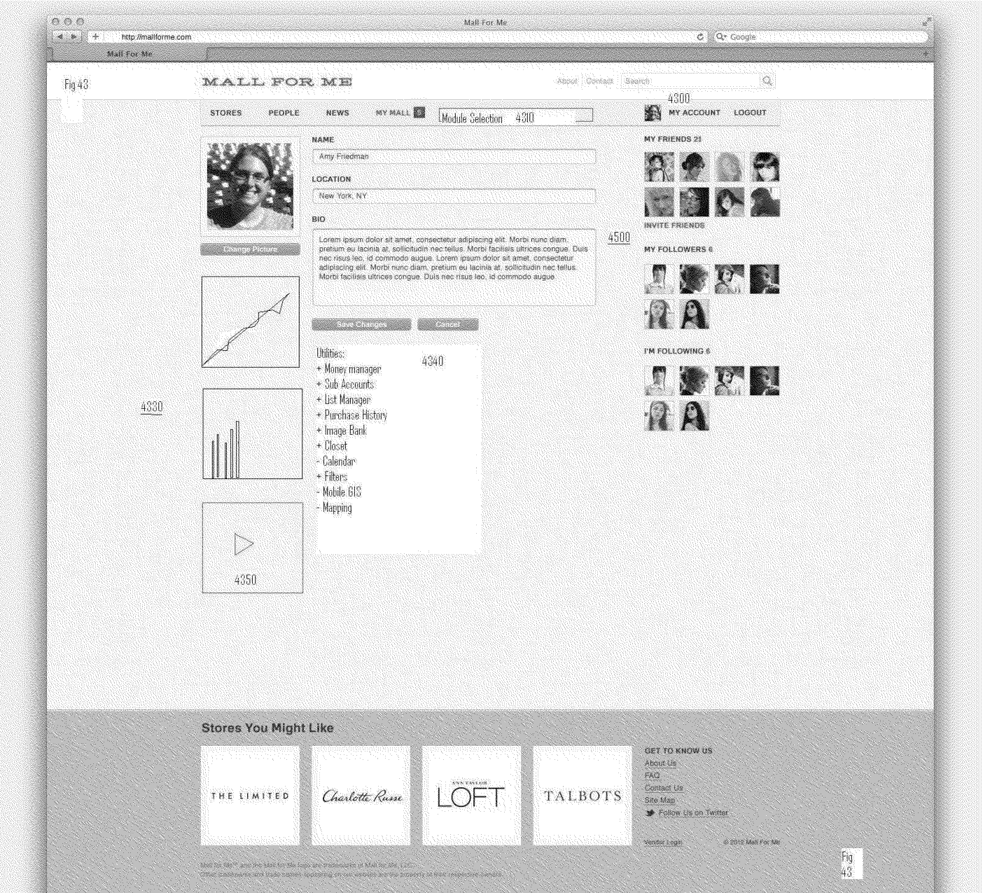

Some users may have an account dashboard. FIG. 43 depicts a screen shot of an exemplary model of an account dashboard. The dashboard may include access to various modules or interactive components within the BBSN. In accordance with the module selected, the user 4300 will open modules or components therein 4310. A user will be able to view or act in accordance with the systems and methods of the particular module. For example the Account Module would show profile information 4320 (name, address, relevant biography), account information (type, terms of service), privacy and sub-account elections, helpful hints, guidelines and other matters. The Social Module view might present social connections (friend, followers, guest passes) and an ability to manage such connections. The Analytics Module view would display data and analytics 4330 relevant to the user and present forms or options for adding to or managing relevant data. The Utility Module view might present various components from which the user would select applicable components 4340 and then drill down for specific views. Alternatively, a host may provide a limited number of pages for account view and management. The home page of the Account Dashboard may have a bespoke view of components within each module. A user might rearrange her dashboard as she would on a computer, such as icons on her desktop or apps on her mobile device. As applicable, the dashboard may include dynamic wizards, videos 4350 and selected options, features, settings and tools in accordance with the business goals of the host and desires of the user. In addition to the dashboard, the user may drill down for alternate views or more detailed information and options. Certain features may or may not be available or desirable depending on the user device.

In one embodiment of the disclosed subject matter, a user can set up sub-accounts. Each account can have different vendors, guests, options and settings. The user might create an account for each family member, with pass codes for purchasing or limitations by vendor or amount that restrict purchases until she gives her approval. She might have her teenager do the shopping even before the teenager can drive. Her family members might see her lists, favorite brands or products and shop in the network she created; she might track activity by account.

The host may provide single or multi-layer privacy options. A single layer may simply allow a choice among public, private or semi-private access. By way of example, multi-layer or segmented options may allow friends to see a user's network of vendors, but prohibit the friend from seeing the user's purchase history.

By way of illustrating and without limiting, a host may provide various services in accordance with its business goals. Services might include universal shopping tools, features or services including but not limited to shopping lists, wish lists, money management options, such as a credit card, purchase points, allowance, tokens and purchase history, free shipping programs, shopping history, comparison shopping, recommender systems, concierge services, personal shopper services, subscriptions and other shopping related services. A host may also allow a user to make elections to join a rewards program, enroll in host payment programs, register for affiliations and loyalty programs, and enter contests. Users can select options that are relevant to her shopping network. The user may also bring into his or her network. For example, the user may already be a member of a free shipping consortium or online payment service and elect to use such compatible services.

In exemplary embodiments of the disclosed subject matter a BBSN can contain several list utilities, including shopping list, wish list, hold list, gift list, vendor list and custom lists. The list manager tool offers a drop down list of lists. A user can organize lists by vendor, person or task. By selecting one of the lists, a user can open a file, such as a text box, note, word doc, ppt slide, note card or similar art for generating lists. The user can note or copy and paste selected information, including names, hyperlinks, pictures, etc. A shopping list utility might be used as a general or comprehensive shopping list. A wish list might be a place for a user to keep track of her favorite items or a list of items she might want for a special occasion. A gift list might include a list of friends and relatives with items a user is considering for a gift as well as reminders and means of tracking progress. A vendor list might include a list of items one needs and wants from a particular vendor. Several specific vendor lists might be active at one time. Custom lists might be named by the user and used according to her needs and organization.

In exemplary embodiments of the disclosed subject matter BBSN tools can include reminders in the form of lists, emails, contact lists and calendars, including holiday reminders and personal reminders. Reminders can be viewed, for example, within the My Reminders toolbox. Alternatively, a user can select an option to have an email reminder sent to her BBSN Email with a particular list attached. In exemplary embodiments of the disclosed subject matter a user can make a shopping appointment by inputting the date into her BBSN Calendar. She can use this for annual holiday or birthday gift reminders, for example, or for one-off reminders, such as a reminder to bring a hostess gift or send thank you flowers.

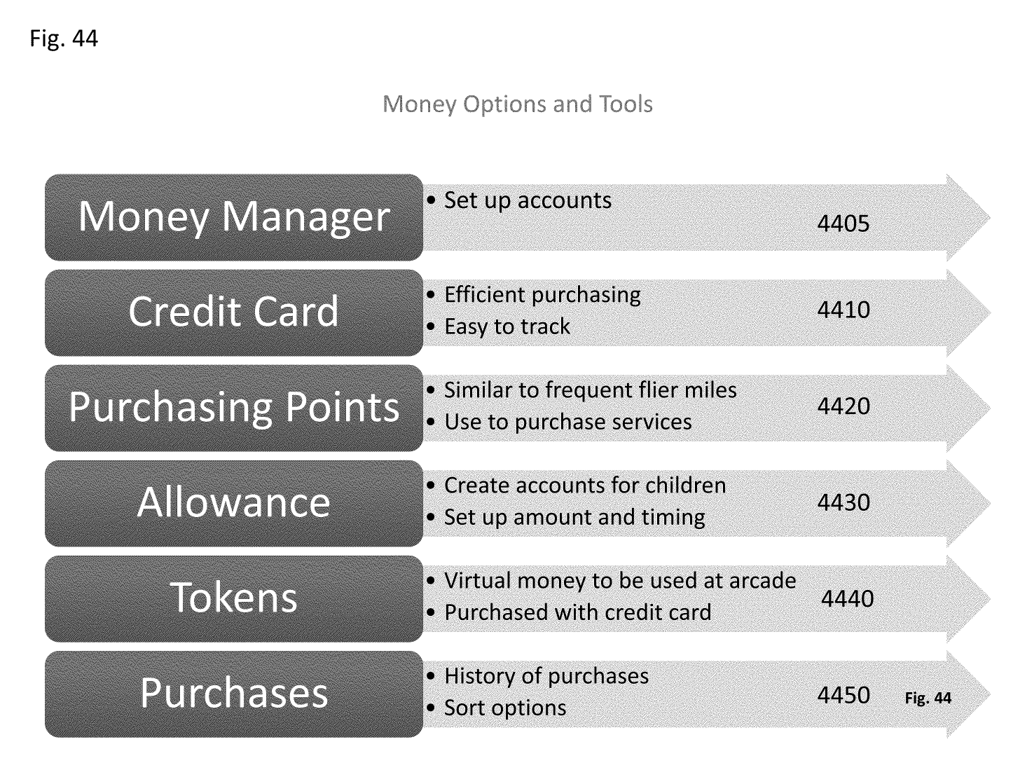

In one embodiment of the disclosed subject matter, FIG. 44 depicts a simplified version of a screen shot of an exemplary illustration of a transaction-related or purchasing component. By clicking on an option a user will be directed how to enable the option and sub-options. In exemplary embodiments of the disclosed subject matter, options have default settings and users can opt out. By way of example, a credit card option 4410 might enable the user to purchase products within or among multiple vendor sites, track purchasing, save billing and shipping information for use across vendors and earn purchasing points 4420 with either the credit card or payment provider service or the host. A user might earn points for each purchase or for each time she shares a product or vendor that results in a purchase, and the points might work or be redeemable in a fashion similar to frequent flier miles or other loyalty programs. In one embodiment, a parent might be able to create allowances 4430 for her children. An allowance might be a fixed predetermined amount, or one that refills in certain intervals, as allowed by the parent and in accordance with the host business purposes. Tokens 4440 might be distributed by the host under a certain reward system that works with the business goals of the host or perhaps available for purchase. Tokens might be available for games. In one embodiment of the disclosed subject matter, the host might enable a user's ability to track her purchase history 4450 or shopping cart on her BBSN. A user can look up purchases as she does bank account activity or credit card purchases. In exemplary embodiments of the disclosed subject matter purchases can be sorted, downloaded and saved, again like other bank or financial institutions. Purchases might be sorted by vendor or across vendors.

In accordance with its business goals, a host might offer the ability to track purchasing history. As an aggregated receipt of purchases online, the data could be sorted and queried. Payments might be made through a universal purchase and shipping process. As an image based system, purchase history might not only include item and cost, but also sizing and images. One might also be able to search across other venues to see other places where the product is sold or mentioned. Similarly, one might be able to search for desired products across vendors and brands for numerous reasons, including finding items that are a good fit or complement to the purchased items. Special occasion gifts and lists could be tracked and repurchased or noted for future purchases. A user might retain images of the purchased item that can be organized and viewed or stored in a database or “closet”.

In an exemplary model, a user can elect to use or import a notes tool. As a tool, the user might be able to open a notes page throughout her shopping network. For example, if she includes an airline as one of her vendors on her Travel Center, she may want to make a note of her frequent flier number. Alternatively, a user may want to retain images of products and make notes in respect of such product or image.

A host may automatically filter recommendations and database queries. For example, if a user has already selected a vendor to be in her BBSN, then the host may filter out such vendor from any query or recommendation presented to the user. Similarly, if the user has positively rejected a vendor or a category, then the host will remove the vendor or category as the case may be from data presented to the user. A system of filters can be sequential or independent of one another. Generally, the host queries the database and returns a subset of data points. The host inputs the subset into the first filter. Data point by data point, the system checks the data point against the test. If the data point passes the test, the data point is presented to the next test. If the data point fails, then the data point is dropped from the subset.

Filters may be used in various modules or components. The host could use the filter process for vendor, product, service, stylist, blog or other shopping related recommendations 683. Filters can be multi-dimensional, sequential or independent, inclusive or mutually exclusive. Filters can be applied universally or within modules or components. Filters can be automatic or executed at will. Filters can be created by both the user and host. Filter options might include word banks as described herein. Before or after a user creates a bespoke mall, the host may offer universal, select, continuous, overriding or other filters. Filters can be based on various types of tests. The tests may be exact matches, similar, true or false, inclusive or exclusive, positive or negative, or other common tests.

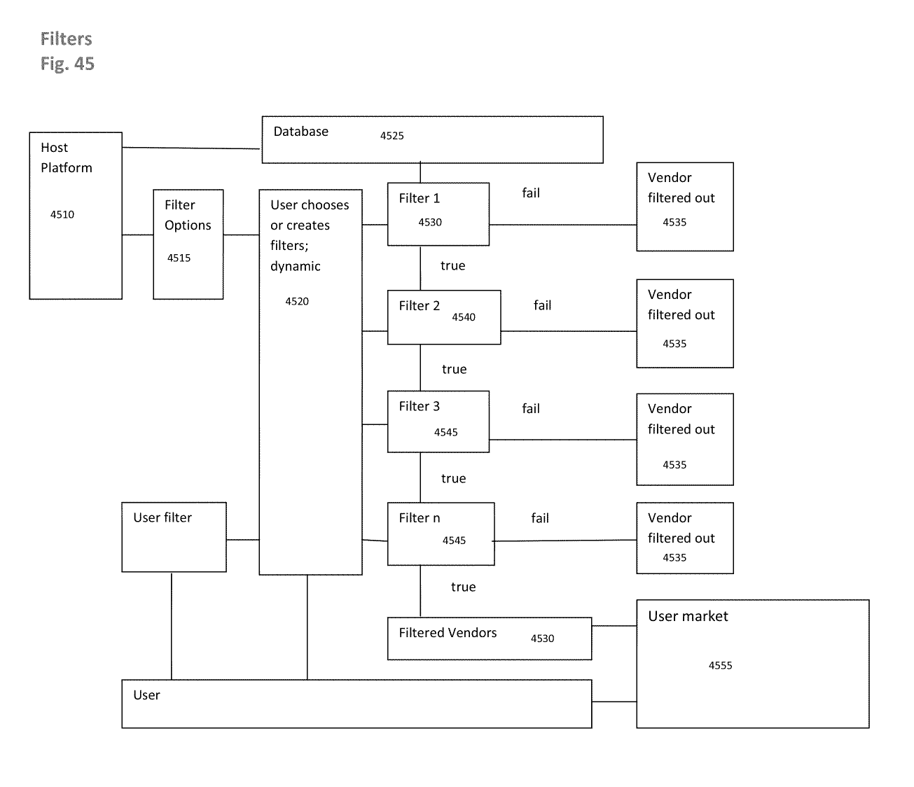

FIG. 45 illustrates a block diagram showing an exemplary model of a filtering process. For purposes of illustration, a host 4510 provides filtering options 4515. A user makes either positive or negative selections 4520. The host queries the relevant database 4525 and submits the returned data to the first filter 4530. If the data presented fails the filter, then the data point (for example, a vendor) would be filtered out 4535, and the remaining data would be presented for the next filter 4540. The process would continue through a series of filters 4545 as is commonly done by those skilled in the art of data management. Filtered data (in this case vendors) 4550 would be presented to the user in a form and function meeting the needs of the particular query 4555.

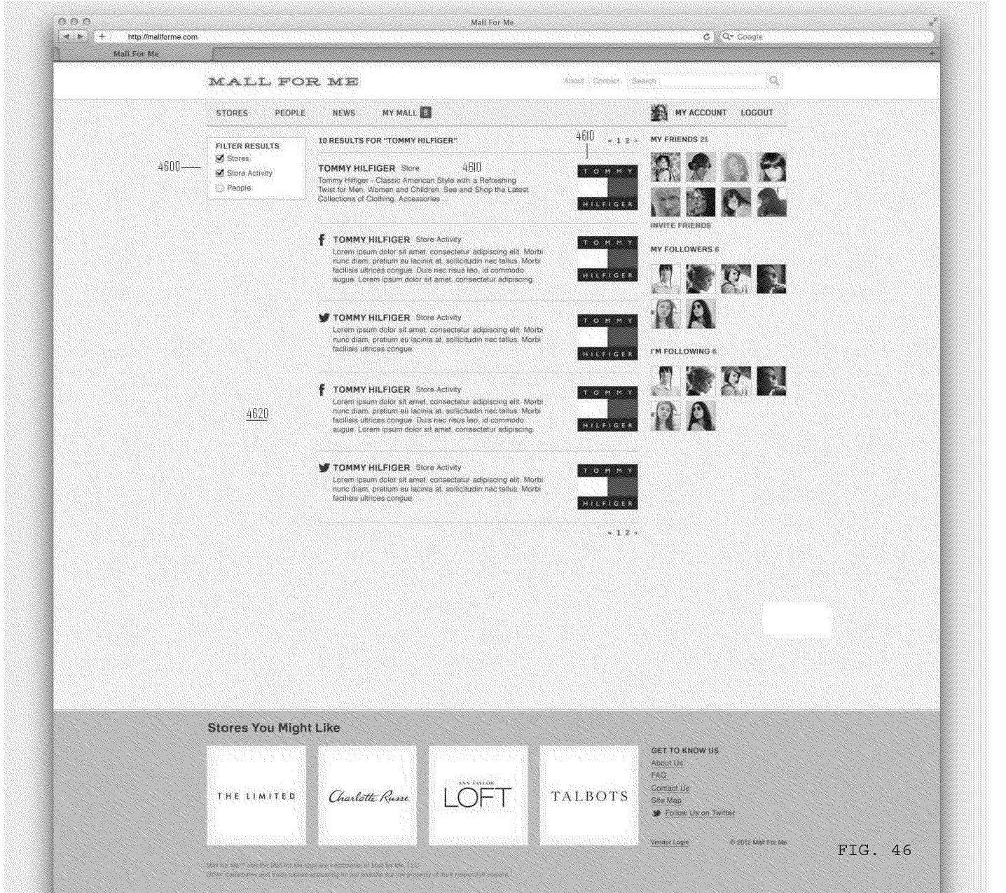

FIG. 46 is a screen shot of an exemplary model of a news filter. The user has selected a filter for stores and store activity 4600 for Tommy Hilfiger 4610, so the user news and alerts are filtered accordingly, and only the relevant alerts are returned 4620.

The host might offer fee-based services. In one embodiment, a fee-based service might be a personal shopper. A personal shopper might perform duties such as finding specific articles of clothing or gifts. Alternatively, a personal shopper on a BBSN may find vendors of interest to the shopper. A vendor within a buyer bespoke shopping network might have a dedicated or contracted personal shopper. Personal shoppers might also be available through the network. The user can select from a myriad of options and tools. The open network of BBSN might allow a user to utilize outside vendor services or a convenient BBSN toolbar. For example, a user might choose to add a gift card vendor or utilize BBSN gift cards. A host might forge alliances with certain vendors to provide personal shopping tools on BBSN toolbar.

The image bank may allow a user to show a personal shopper what she has in her closet and then request that the personal shopper find complementary items. A user might want to segment her image bank by category of items or by whether it is on a wish list or already purchased. She may use the image bank to share items she likes with her friends in an organized fashion. The image bank may have sorting options similar to those found on her mall. She may be able to make notes or comments on her images and share or send them to her friends. Search or crawl engines may allow a user to find similar items within her BBSN through image recognition software. Retrieval of images in a refined scope of a BBSN rather than a universal or global search of the internet as a whole speeds up retrieval and delivers preferred or relevant matches.

In exemplary embodiments of the disclosed subject matter the host platform can also be used as homepage or as an online organizer for the user. For example, users can create an Organizer Section that allows them to utilize the host platform for linking to non-vendor websites. One might check the news for the weather and specials from a favorite outdoor sporting goods retailer before a long weekend or vacation. A user might want to review all specials across favorite vendors only for back to school specials. Another might want to check a calendar for upcoming birthdays, view related specials and shop at a family member's bespoke shopping mall. For example, one might to create a Children's Center including educational websites and school websites. The organizer option allows a user who uses the host website to stay on the site while using non-vendor options. The service may be fee-based or complimentary, based on the user's status at host. For example, a user who spends more than a certain threshold may qualify for free organizer use. Another user may use host Purchasing Points for credit on her Organizer in accordance with one embodiment of the disclosed subject matter.

One feature of the disclosed subject matter is the user's option and power to make determinations about inclusions or exclusions from the vendor tools, database, filters, features, services and elections to include or exclude for his or her buyer bespoke shopping network. If a user chooses or elects to include a function or element, then it may be included in the user's bespoke market. Similarly, a user may choose or elect to include or exclude a vendor from her bespoke market. Inclusion might be in the form of a link to the vendor website or application or alternatively, retrievable.

### Analytics Module

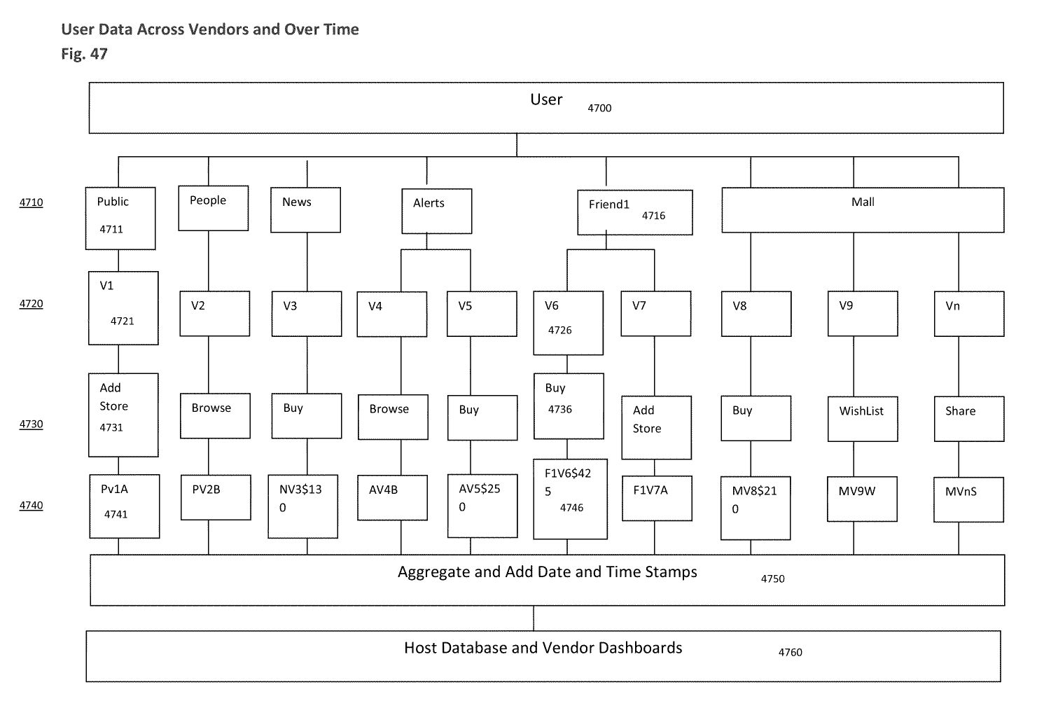

An analytics module allows a host to collect and analyze data originated or generated by the user, given user permission. Data may be collected through user input, user response, or user actions. Clickstream data, GIS, and other common forms of data and data collection will contribute to the database and enhance analysis, thereby improving the user experience. Data can be collected across vendors and over time. Depth and breadth of the databases, recommendations and utilities can be improved or enhanced based on direct or indirect user feedback. FIG. 47 is a block diagram illustrating an exemplary embodiment of data collection regarding a single user, across vendors and over time. A user 4700 visits various sections 4710 of her BBSN, including the public malls, the public people and their malls, public news, personal alerts, friends' malls and her own mall. As a result, the user finds multiple venues for reaching vendors 4720. The user takes actions 4730 including purchasing, browsing, adding stores, sharing and adding products to wish list. As the user takes various actions, a clickstream database collects information about where the user went, how she got there, and the action taken and converts it to a series code 4740. The data is collected in real time, data and time stamps are added, and the session is recorded along with the component series of actions taken 4750. For example, in one series, the user goes to a public mall 4711, visits a vendor 4721 and adds the vendor to her mall 4731. The host records the venue (public “P”), the vendor (V1), and the action (add store “A”). In another series, the user visits a friend's mall (F), makes a purchase ($) for $425 (425). The series and session codes are stored in the host database and the relevant actions are added to the relevant vendor analytics 4760.

The exemplary code is written to house identifiable who (user), what (action), where (vendor), when (time), and how (venue) across vendors and over time. The code is organized and can be searched by component. For example, a host can query users to find out which friends are converting visits to purchases and then identify them as influencers. One could also see if the friend tends to be a big influencer for certain vendors.

In another example, user rankings of vendors may be one of the indicators of the likelihood of customer acquisition or the depth of customer loyalty. With such information, vendors may discover new, loyal and/or interested customers. Vendors who send premium catalogues to their best customers might find it valuable to know which users rank them as a premium vendor or which a user puts them in their home market as opposed to their fashion market. In exemplary embodiments of the disclosed subject matter the host can use these rankings and data points as indicators of a user's preferences, thereby enhancing vendor or product or service recommendations and more closely aligning a recommendation with a user.

In exemplary embodiments of the disclosed subject matter, basic information can include, for example: (i) actions, including but not limited to hits, frequency, duration, purchases, browse no buy, browse and buy, browse duration for each, vendors browsed, frequency of browsing at particular vendors, and any point of feedback from the user to the host, (ii) choices, including but not limited to vendor selection, vendor rejection, ranking of vendors, reinstated vendors, upgraded vendors, downgraded vendors, searched vendors, guests, tool choice, node choice, comments, number of vendors, and vendor category; (iii) types of hits, including but not limited to ads, bulletin boards, vendors, news, tools, products, images, or anything else presented on the site or app, (iv) timing, including but not limited to the time of day, week, frequency, peaks (like automated telephone tracking), duration of visits; (v) location, including but not limited to where a user is when he shops; (vi) other information including but not limited to guests or friends, number of accounts, change of primary data, searches, and use of tools by tool.

In exemplary embodiments of the disclosed subject matter BBSN data can be intelligently analyzed. For example, it can be used to track the effectiveness of advertising or view the influence of friends. One can track business progress, compare businesses and rank them within their industry. A host may provide vendors with various types and levels of data packages and analysis. Data might be collected on a custom basis. Reverse inquiry might supply additional expansion options.

Thus, in exemplary embodiments of the disclosed subject matter primary and secondary data can be collected, across vendors and over time, and analyzed to generate a Shopper DNA (“SDNA”) 685. A Shopper DNA identifies and describes in a uniform code a user's shopping traits. Mapping and sequencing allow the development of a shopper's genome. A BBSN host uses the data mine to make recommendations, facilitate targeted advertising and enable custom research for businesses, associations or industries.

In exemplary embodiments of the disclosed subject matter Shopper DNA is a BBSN code used to house data about users or individual shoppers. Every shopper can have a unique or exemplary shopping DNA. Shopper DNA reflects an individual's primary data and secondary data. In addition to profile information, a BBSN platform creates an opportunity to collect online shopping habits of individuals across vendors, within industries or categories and over time.

Exemplary traits might include: gender, age, location, purchasing power, hunter-style shopping, gatherer-style shopping, pro-active shopper, reactive shopper, list shopper, brand loyal, brand aware, interests, dedicated to preferences, true to lifestyle, multi-lifestyle, product quality, luxury shopper, value shopper, timing, explorer shopping habits, trend setter, influencer, trend follower, self-shopper, family-shopper, friend-shopper, active shopper, inactive shopper, purchases popular items, prefers innovative or unique items, morning shopper, evening shopper, weekend shopper, organizer, coupon shopper, responsive to advertisements, mobile shopper and many others. The traits might be labeled and categorized in a numeric or other code such that SDNA traits can be flagged and measured and compared.

Shopper DNA can be searchable, defined and flexible. Shopper DNA can be tracked over time. Shopper DNA can be stacked over time (annually or monthly, etc) in order to give a three-D perspective on attributes, change and growth, for example. A BBSN host can access the codes and the related derivative products and information. The code format changes with technology but the concept remains the same.

In exemplary embodiments of the disclosed subject matter data might be discovered and weighted over time. Initially, an individual's answers to questions at both the primary and secondary level might serve as the baseline SDNA fact set. A BBSN host might make recommendations based on matching and prioritizing fact sets. Then the host might track browse time, actions and purchasing to enhance the understanding of an individual's shopping DNA and generate a personal genome. The genome might be used for recommendations and for advertising and marketing purposes.

In exemplary embodiments of the disclosed subject matter SDNA could be identified and tracked by code or representation. The code used might depend on the data being tracked. Bar codes, numeric codes, binary codes, etc are examples of how it can be done and are not limitations on how it is done. Items or methods can be combined in accordance with those skilled in the art.

In exemplary embodiments of the disclosed subject matter DNA could be identified and tracked by bar codes. Bar codes can use solid or dotted lines, with dashes varying length and frequency. Height and thickness can vary. For example, male can be solid while female can be dotted. A birthday can be based on length of solid or dotted line. The height and width of a bar can indicate sizing. The length and frequency or dashes can indicate the frequency and duration or amount of a particular action, purchasing, etc. For choices, dots, dashes, or blanks might indicate positive, negative or indifference.

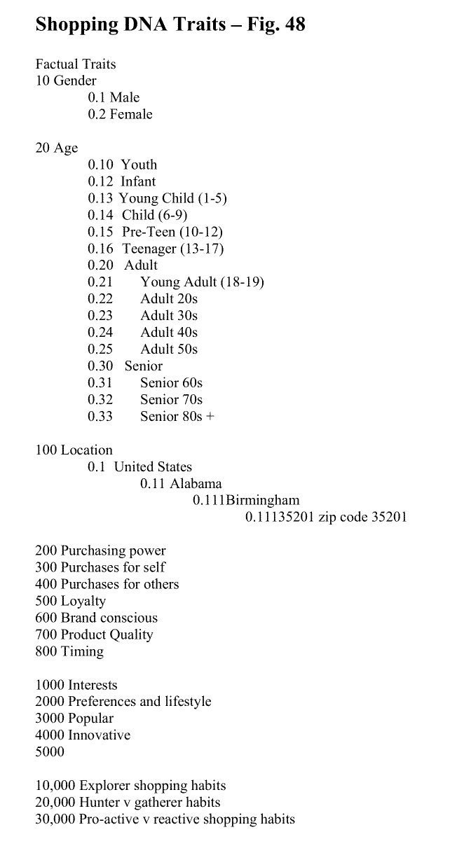

In an alternative format, numeric codes might be used to identify Shopper DNA. Numeric codes can indicate absolute levels, percentages or choices. In an exemplary embodiment of the disclosed subject matter, as depicted in FIG. 48, an individual's gender might be indicated by a 1 for male, 2 for female, blank for unknown, 3 for other. Age and number of dependants are indicated by a number. Marital status based on reference code (for example, 1 for single, 2 for married, 3 for divorced, etc.). Absolute or slopes or percentages can be input in specific string. A code might be able to discern subtle differences and distinction. For example, an individual might seek popular items for the home, but be a trend setter for clothing. The code might track intensity of brand loyalty by increasing the numeric value based on a ratio of purchases of any particular brand within the related industry.

SDNA might be constructed in layers or parts. In an exemplary model, a SDNA might include universal shopping characteristics for a shopper as well as particular shopping characteristics. Universal characteristics might include gender, purchasing power, lifestyle and other traits that would run with the user regardless of the medium. An example of particular characteristics might be how the user behaves on the host platform. Traits might be further characterized into permanent, semi-permanent and dynamic traits. Permanent information might include gender and birthday while semi-permanent might include height, address, marital status, level of schooling, home owner, renter, eye color, number of children, sports interests. Some traits might be fleeting during youth and more permanent as the user ages. Dynamic data points might be updated periodically or in real time. Certain data might reflect habits or choices. Some data might be ascertained through mapping and sequencing.

In exemplary embodiments of the disclosed subject matter a BBSN platform has the ability to discover derivative information based on tracking, sequencing and data analysis. Predictive patterns can emerge. A change in primary or secondary data can lead to a change in purchasing patterns. For example, an increase in the number of dependants, a change of address, or an additional account might all indicate a new level of data mining and predictive purchasing power. An individual is inclined to share information with a BBSN host in order to make her shopping more convenient. After life changing events a user might welcome recommendations, direct mail, communications and catalogues to her BBSN. Analytical data is not limited to individuals. Vendors, associations or industries can derive information using the unique BBSN platform. For example, a vendor might want to discover if it is losing hits while the industry is gaining hits.

Extending the systems and methods of the SDNA and with the aid of regression analysis, a BBSN host can discover a shopping genome or predictive patterns for users by synthesizing Shopping DNA along with a user's BBSN choices, selections and habits. Analyzing Shopping DNA across individuals, with the aid of regression analysis etc, allows a BBSN host to discover predictive patterns within or across certain groups of individuals or within or across certain vendors or entire industries. The more information a user shares and the more specific the information, the more closely aligned recommendations for vendors can be with her choosing. Ranking vendors is a form of providing information. Vendors may offer special coupons, promotions and rewards based on rankings. Filters are based on personal interest and not mass-market interests. A vendor can display purls (personal URLs) or dynamic pages to fit the user.

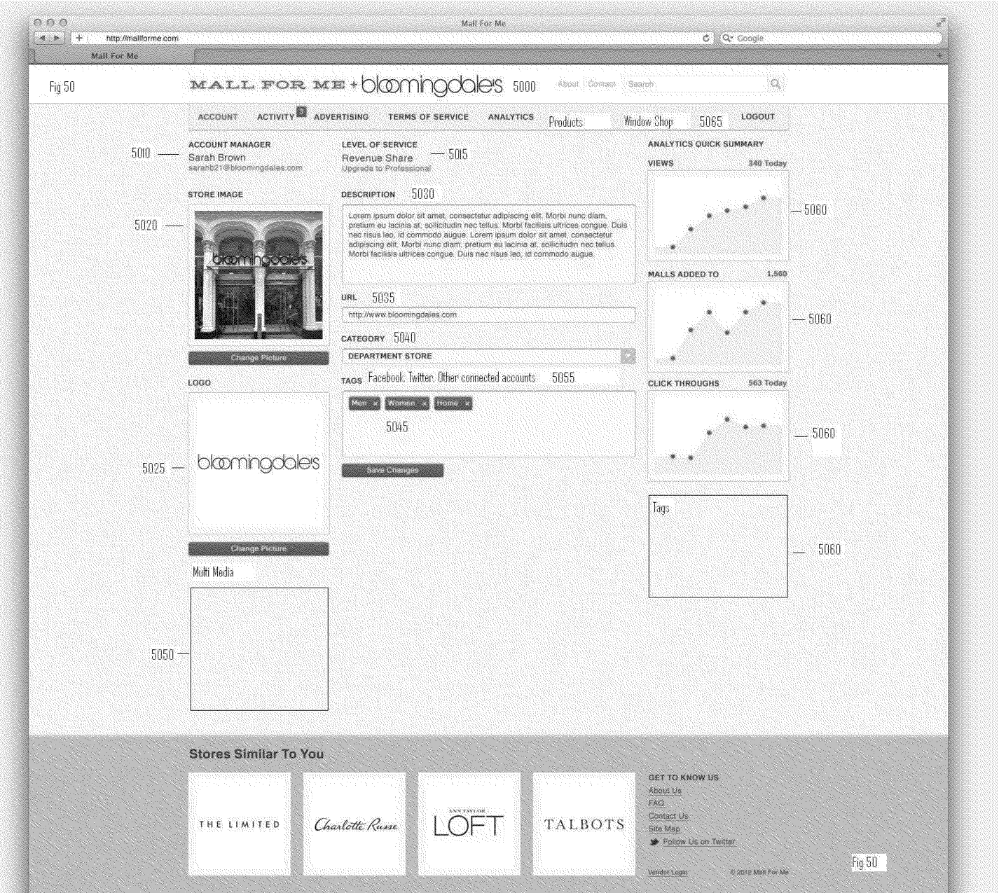

Tagging on a BBSN, whether basic, web analytics or complex tags, allows the host to analyze users across vendors and over time. A BBSN can use defined tag names and offer the ability to create custom tags. As a host discovers a custom tag is being used consistently across vendors, then the BBSN host can add the custom tag to the defined tag database. FIG. 50 depicts a simplified screen shot of a vendor dashboard along with select tags 5045.

In exemplary embodiments of the disclosed subject matter a BBSN host can make recommendations and suggestions based on data from individual users and vendors. Information gathered from a user-centered data axis or a BBSN can be used to generate user-specific recommendations. Recommendations might be based on a user's BBSN data set, including vendor selection, filters, preferences, SDNA and requests. Depending on the business goals of the host, recommendations might include suggestions for similar or related sellers, merchants, markets, subscriptions, experts, shopping information, etc. In exemplary embodiments of the disclosed subject matter a BBSN host might utilize a relevant portion of its database for each recommendation or suggestion. The host might then further narrow the field of possible vendors by using user filters. For example, if a user declares in BBSN host data forms that she is not interested in fast food, then the host can filter those vendors out. Filters can also be used, for example, to prevent the host from recommending vendors the user already has in her BBSN. Filters can be used, for example, for geographic based selections or similar purposes.

The SDNA 685 or genome 686 can be used to make recommendations 683 to users. Recommendations from a BBSN host platform are closely aligned with a user because it is grounded in the user's preferences. Significantly, a user will identify which vendors she prefers in her online shopping network. She may also rank vendors, minimize or reject vendors. Interests may be overlapped along with purchasing habits. Again the key is the combination of data collection and purchasing at a user's shopping hub.

Vendors can be categorized in the same fashion as users. The data points align users and vendors. An interest in golf would map to golf shops. Men's tailored clothing preferences would map to Brooks Brothers, Paul Stuart and others. Mapping vendors could be based on vendor-defined competitors, industry publications, associations, search descriptions or key words, host vendor experts, a host thesaurus or other means in keeping with the business goals of the host. Filters can be applied to ensure, recommendations are in keeping with positive and negative user filters. BBSN recommendations allow a unique combination of cross-interests.

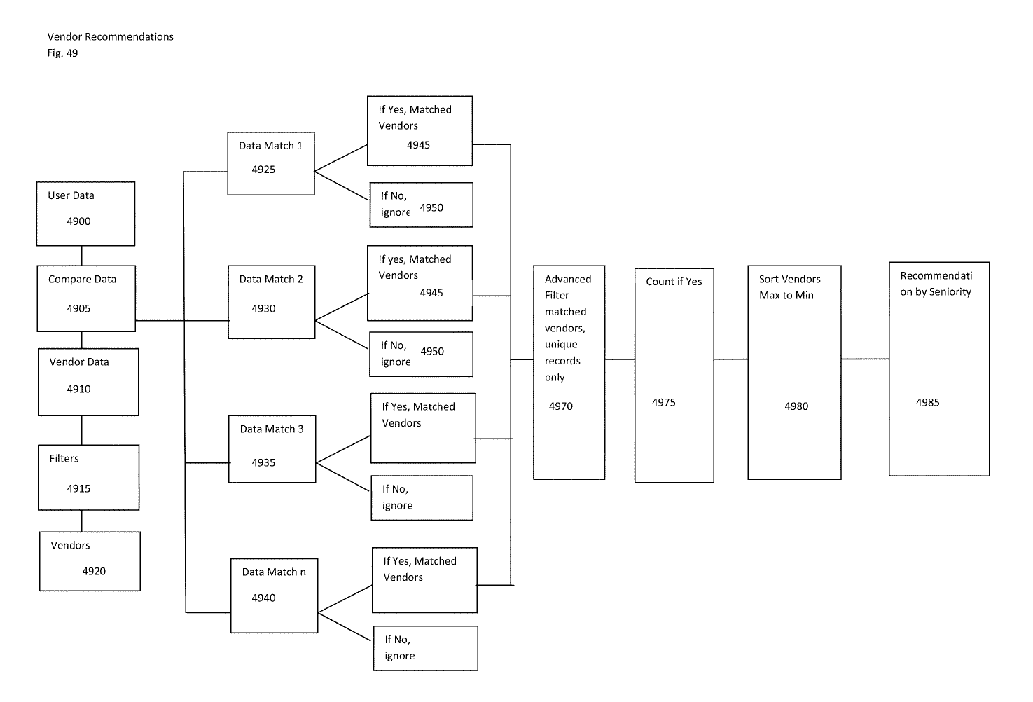

In an embodiment of the disclosed subject matter, a host will employ an algorithm, using BBSN tags and other data points, to make vendor recommendations based on user data. FIG. 49 is a block diagram illustrating a simplified embodiment of a recommendations system under the disclosed subject matter. A host database might contain data about vendors 4920 and users 4900. A host may apply filters 4915 to the vendor database to narrow the scope of possibilities 4910. For example, if a user is shopping in her home market, then the database would be filtered for vendors relating to that field. The host might then compare the data between the vendor and user 4905. The host system might start with a primary user data point and compare it across all vendor data points or look for individual matches 4925, 4930, 4935 and 4940. If there is a match, then the data point, in this case a vendor, would advance to a matched bucket 4945, with unmatched vendors being dropped or ignored 4950. Matched vendors might be passed through a filter for unique records only 4970. A counting option 4975 might rank vendors by the number of times it met a match requirement. The host might rank the vendors according to number or matches 4980 or according to another hierarchy or filter and then make vendor recommendations 4985 to the user based on a personalized comparison of data across user and filtered vendors.

Recommendations might be delivered in different forms, depending on the location of the user within a BBSN. Recommendations may appear in alternate formats and may be sorted or presented individually, in groups or in total. Recommendations may be used for advertisements, messaging, news or communications.

Vendors might pay for customized analysis, such as standard calculations with different word searches (hit ratio, frequency, duration, cross-sell etc) or standard work searches with different calculations. Vendors might make requests based on how they like to target their customers. A vendor might sponsor a questionnaire for teenagers and then choose to advertise. Associations might sponsor data tracking or request a custom report.

### Vendor Module

Next described herein are the systems and methods of the vendor module. A vendor user will create a vendor account 670. The host may require certain account data including but not limited to formal business name, business address, axis of businesses, URL, payment method, categories, tags, industry, logos, brands, store locations, products, images, services, interface and other relevant data. The vendor and host will agree to terms of service, payment structure and other relevant business matters. If approved by the host, the vendor will have access to a vendor module.

The vendor module includes components specific to the vendor along with systems and methods incorporated within other modules that are integral to a buyers bespoke shopping module 644. References hereinbefore to systems and methods that include vendor data, activities, services or otherwise are hereby incorporated into the vendor module. By way of example and without limitation, the vendor may utilize the communications module to communicate with users. Data derived from the clickstream database or analytics module may be shared with vendors in various formats. In an exemplary embodiment of the disclosed subject matter, a vendor module will include a vendor account 670, vendor dashboard (as more fully described herein) 671, vendor analytics 673, and consumer intelligence 672. In addition, a vendor module will directly and indirectly be integrated with other modules and output therefrom 675, including but not limited to a communication module, news module, comparison shopping 681, news 679, recommendations 683, advertising and marketing 689, vendor-buyer products and services 688 social shopping 678 and others as more fully described herein. In exemplary embodiments of the disclosed subject matter a host might enable special features for businesses, associations, direct to vendor, integrated businesses, and other entities that may need or want more sophisticated features and platforms. Additional fees may apply.

In an exemplary embodiment of the disclosed subject matter, FIG. 50 depicts a screen shot of a vendor dashboard 5000 with representative data, including but not limited to account managers 5010, account level 5015, images 5020, logo 5025, descriptions 5030, URL 5035, categorization 5040, tags 5045, key words, videos, multi-media 5050, social or news connections 5055, links, contact information, store information, location information, mapping services, terms of service, and other account related information. A vendor dashboard might include basic account information about the vendor as well as feedback from the host, including but not limited data, analytics 5060 and other services. A host may provide more detailed information through navigation options 5065, including but not limited to activity, advertising, detailed analytics, product feeds, window shops and others.

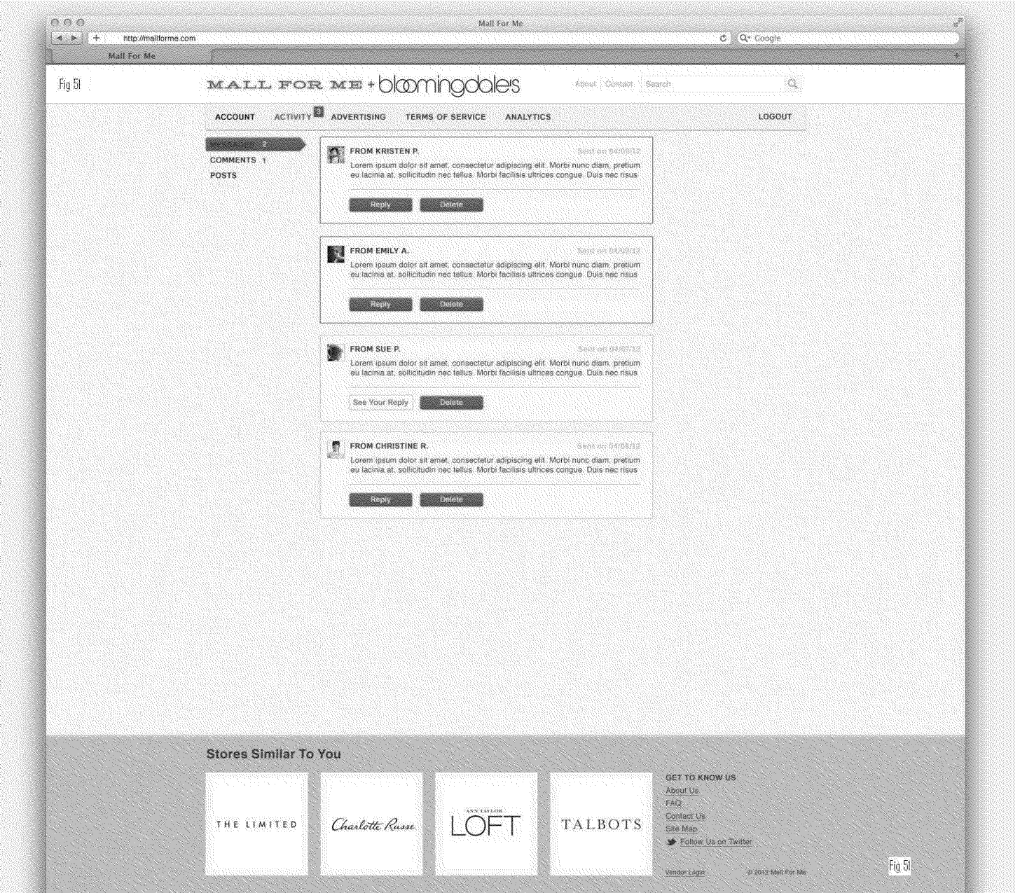

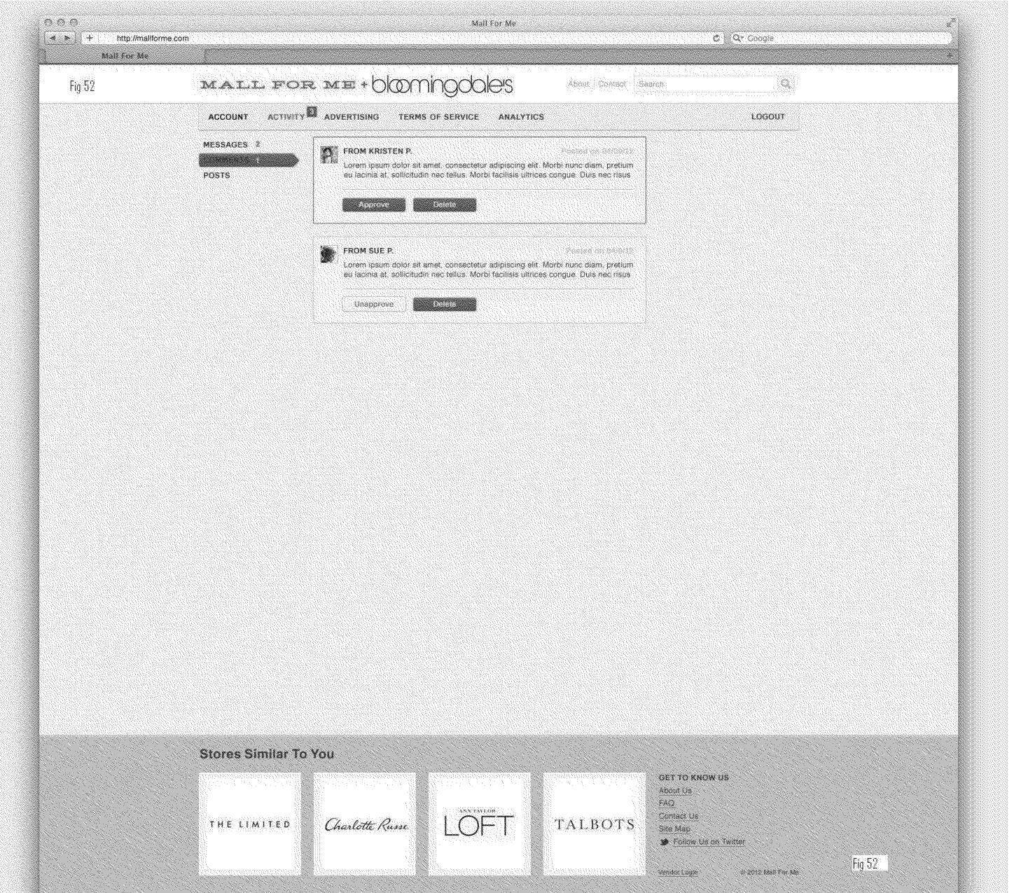

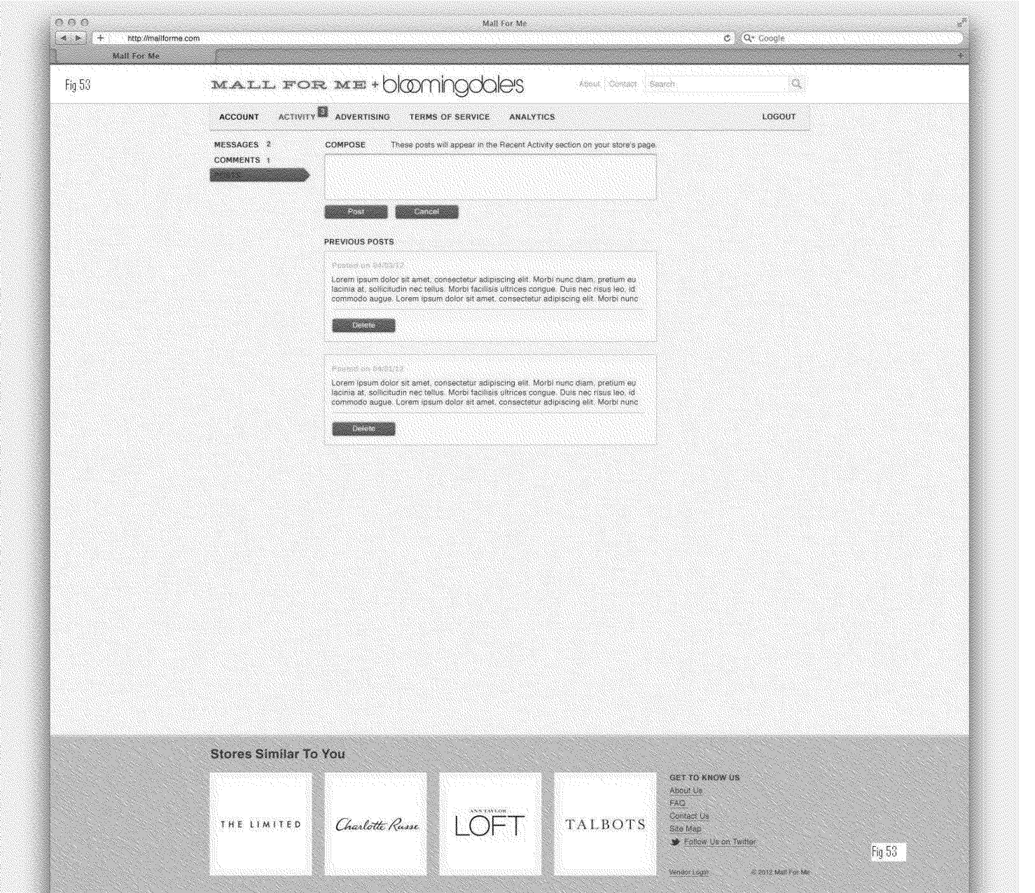

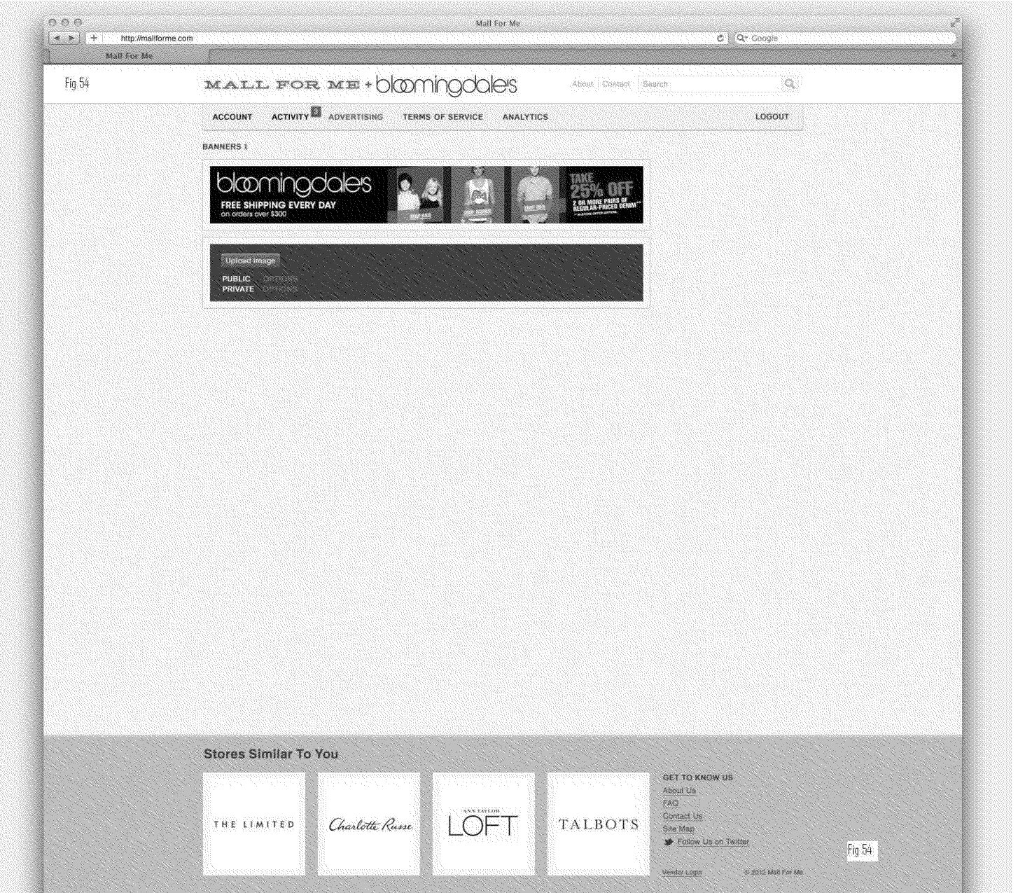

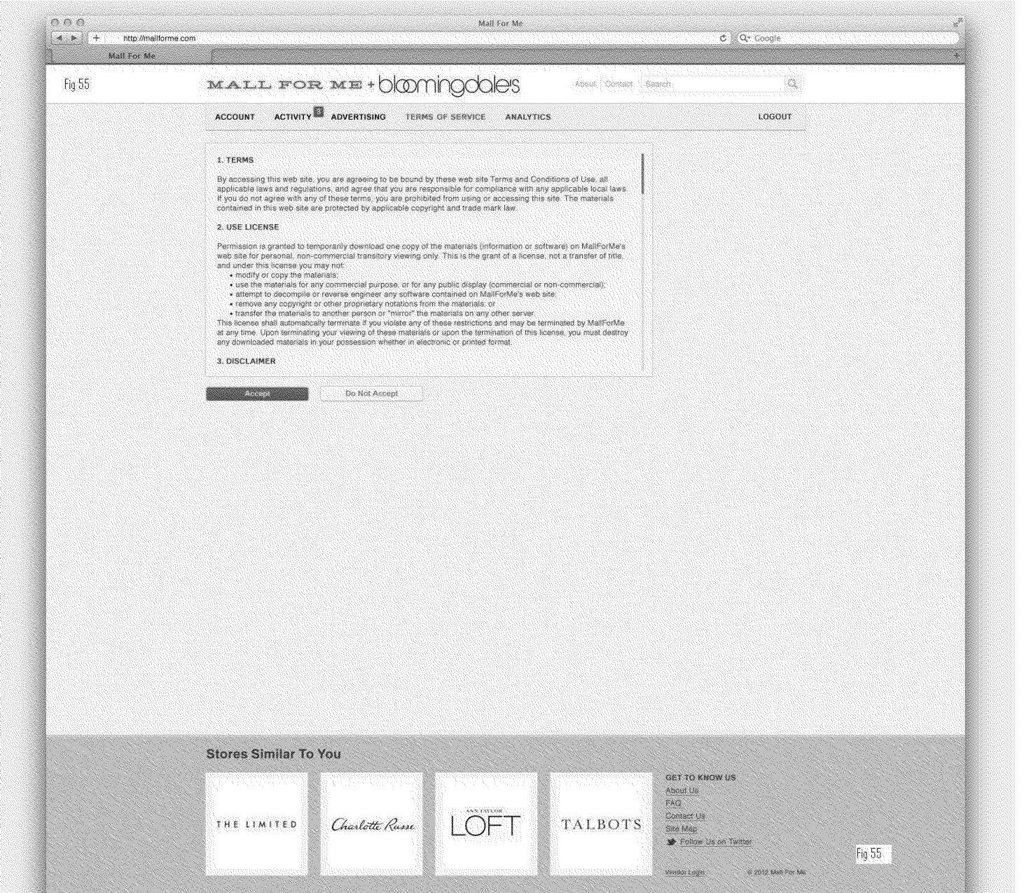

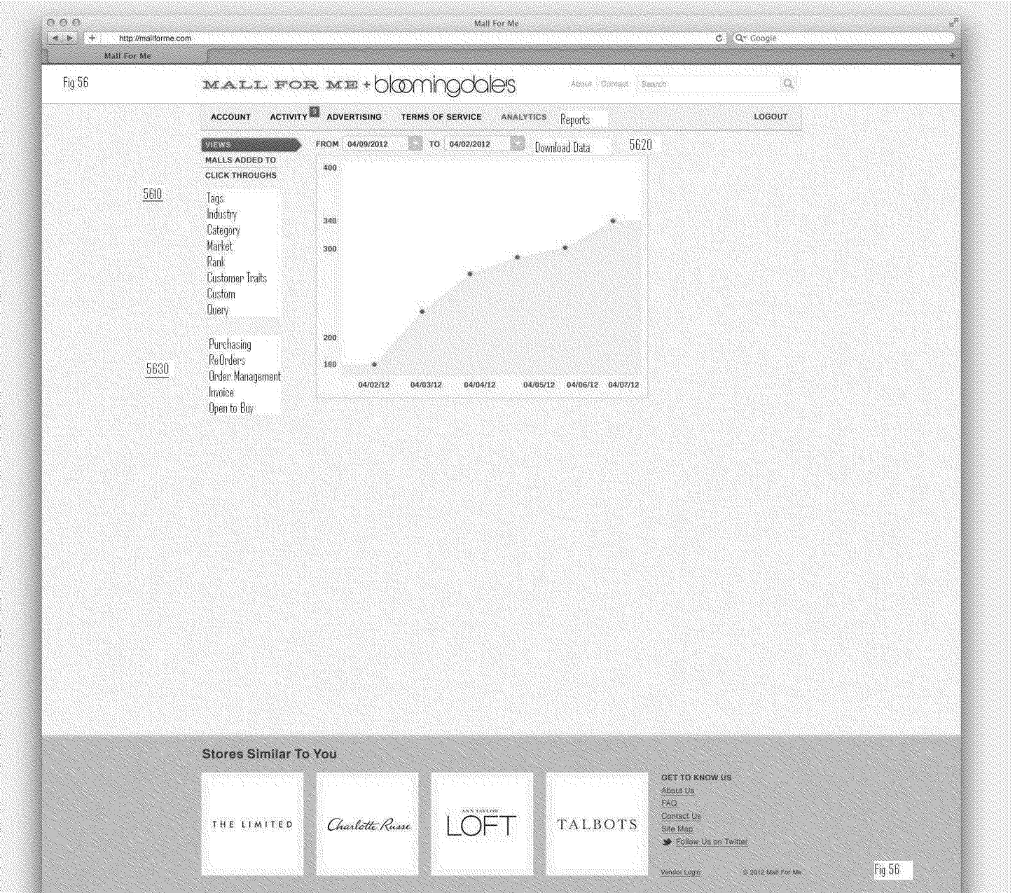

A vendor might be able to view activity or messages from users or the host a shown in an exemplary screen shot in FIG. 51; review comments as shown in an exemplary screen shot in FIG. 52; create posts or communication as shown in an exemplary screen shot in FIG. 53; import advertising as shown in exemplary screen shot FIG. 54; read, select, and accept or reject terms of service as shown in exemplary screen shot FIG. 55; and review, manage, choose, download data or analytics as shown in exemplary screen shot FIG. 56. Vendors might be able to retrieve various types of data 5610 over various periods of time 5620. Consumer intelligence 672 and analytics 673 might include but not be limited to number of views, users that have added the vendor to a personal mall rank, types of customers, customer traits, location of customers, method of purchase, advocates, advertising views, and click-through to the vendor. For vendors, group buyers or commercial users, alternative analytics may be available. For example, a user might be able to view purchasing, re-orders, order management, invoices, open-to-buy and other commercial uses. Data might be captured and reported by vendor and compared with competitors or the industry 687. Vendors might have the ability to communicate directly with customers through the host 688, as approved by all stakeholders and in keeping with privacy concerns.

In exemplary embodiments of the disclosed subject matter, BBSN data can offer and support new and improved methods of advertising, marketing or content delivery, whether in the form of print, animated slides, video, audio, mobile or other passive, active or interactive medium. For example, BBSN data can help vendors find targeted purchasers and their friends. Vendors can thus filter the mass market of consumers to a direct marketing field. Vendors can gather data across users, markets and industries. A buyer's market allows for the production of buyer-centered tools, features, services, data and analytics. A host can assemble and repackage products and services based on customer intelligence. In exemplary embodiments of the disclosed subject matter, a host may provide a user with a network of networks, a bespoke mall, social shopping, news hub, universal shopping utilities, comparison shopping and recommendations. As a user creates an account and uses such products and services, a host can obtain or derive additional data and analytics for vendor products and services. In exemplary embodiments of the disclosed subject matter, a host can produce SDNA 685, a shopping genome 686, analytics 673 687, communication 688, Buyer profiles 682, market analysis, identification and profiles 687, target audiences, mapping and sequencing 684 and provide vendor recommendations, targeted advertising 689, and others. A vendor can access host products and services through a vendor dashboard or module.

The above-presented description, including screen shots, pseudo-code, variables, elements and/or algorithmic steps, figures, images and illustrations is intended by way of example only and is not intended to limit the disclosed subject matter in any way. It is particularly noted that the persons skilled in the art can readily combine the various technical aspects of the various exemplary embodiments described as well as their constituent elements and sub-systems to implement features and processes contemplated to be within the scope of the disclosed subject matter but not literally or explicitly described.

What is claimed is:

1. A computer system supporting an online personal market for a user, comprising:
a user account module configured to allow the user to register and create a user account;
a vendor selection module configured to allow the user to add and remove one or more vendors to the online personal market;
a social module configured to allow the user to establish social interaction and networking with other users;
a shopping module configured to allow the user to shop one or more products or services from the one or more vendors;
an account management and utility module configured to allow the user to manage the online personal market;
an analytics module configured to collect and analyze actions of the user; and
a vendor module configured to allow the one or more vendors to create one or more vendor accounts and access the online personal market.

2. The computer system of claim 1, further comprising:
a blueprint module configured to provide one or more templates to the user for creating the online personal market.

3. The computer system of claim 1, further comprising:
a news and communication module configured to provide news and communications to the user.

4. The computer system of claim 1, wherein the user account module is further configured to allow the user to create one or more sub-accounts.

5. The computer system of claim 1, wherein the vendor selection module is further configured to recommend at least a first vendor for the user to add to the online personal market.

6. The computer system of claim 1, wherein the vendor selection module is further configured to present to the user at least a second vendor from another online personal market of at least one of the other users.

7. The computer system of claim 1, wherein the social module is further configured to allow the user to share access to the online personal market with the other users.

8. The computer system of claim 3, wherein the news and communication module is further configured to provide a first filter that filters the news and communications directed to the user.

9. The computer system of claim 1, wherein the account management and utility module is further configured to allow the user to rank the one or more vendors in the online personal market.

10. The computer system of claim 5, wherein the account management and utility module is further configured to provide a second filter that filters vendor recommendations directed to the user.

11. The computer system of claim 1, wherein the analytics module is further configured to generate a unique shopper DNA (SDNA) for the user.

12. The computer system of claim 1, wherein the vendor module is further configured to provide at least one vendor dashboard for the one or more vendors.

13. A computer-based method for supporting an online personal market for a user, comprising:
registering the user and creating an online user account for the user;
adding and removing one or more vendors to the online personal market;
providing access to online social interaction and networking between other users and the user;
providing online shopping access for the user to shop one or more products or services from the one or more vendors;
providing the user an online ability to manage the online personal market;
collecting and analyzing online actions of the user associated with the online personal market; and
creating one or more vendor accounts for the one or more vendors and allowing the one or more vendors to access the online personal market.

14. The computer-based method of claim 13, further comprising: providing one or more templates to the user for creating the online personal market.

15. The computer-based method of claim 13, further comprising: providing news and communications to the user through the online personal market.

16. The computer-based method of claim 13, further comprising: creating one or more sub-accounts for the user.

17. The computer-based method of claim 13, further comprising: recommending through the online personal market at least a first vendor for the user to add to the online personal market.

18. The computer-based method of claim 13, further comprising: presenting to the user at least a second vendor from another online personal market of at least one of the other users.

19. The computer-based method of claim 13, further comprising: sharing access to the online personal market of the user with the other users.

20. The computer-based method of claim 13, further comprising: filtering the news and communications directed to the user.

21. The computer-based method of claim 13, further comprising: providing an interface to the user to allow the user to rank the one or more vendors in the online personal market.

22. The computer-based method of claim 17, further comprising: filtering vendor recommendations directed to the user in the online personal market.

23. The computer-based method of claim 13, further comprising: generating a unique shopper DNA (SDNA) for the user.

24. The computer-based method of claim 13, further comprising: providing at least one vendor dashboard for the one or more vendors.

25. A non-transitory computer readable medium having executable instructions operable to, when executed by a computer, cause the computer to:
register a user and create an online user account for the user in an online personal market;
add and remove one or more vendors to the online personal market;
provide access to online social interaction and networking between other users and the user;
provide online shopping access for the user to shop one or more products or services from the one or more vendors;
provide the user an online ability to manage the online personal market;
collect and analyze online actions of the user associated with the online personal market; and
create one or more vendor accounts for the one or more vendors and allow the one or more vendors to access the online personal market.
